(19) United States
(12) Patent Application Publication
(10) Pub. No.: US 2026/0106969 A1
(43) Pub. Date: Apr. 16, 2026

(54) CODING METHOD, DECODING METHOD, BITSTREAM, CODER, DECODER AND STORAGE MEDIUM

(71) Applicant: Guangdong OPPO Mobile Telecommunications Corp., Ltd., Dongguan (CN)

(72) Inventors: Junyan HUO, Dongguan (CN); Yanzhuo MA, Dungguan (CN); Fuzheng YANG, Dongguan (CN); Xue HAO, Dongguan (CN); Ming LI, Dongguan (CN)

(73) Assignee: Guangdong OPPO Mobile Telecommunications Corp., Ltd., Dongguan (CN)

(21) Appl. No.: 19/421,974

(22) Filed: Dec. 16, 2025

Related U.S. Application Data
(63) Continuation of application No. PCT/CN2023/105717, filed on Jul. 4, 2023.

(51) Int. Cl. H04N 19/105; H04N 19/159; H04N 19/176; H04N 19/513

(52) U.S. Cl. CPC H04N 19/105; H04N 19/159; H04N 19/176; H04N 19/521

(57) ABSTRACT

Provided are a coding method, a decoding method, a bitstream, a coder, a decoder and a storage medium. The method includes: determining a first BV parameter of a current block; on the basis of the first BV parameter, determining a first color-component reference sample and a second color-component reference sample which correspond to the current block, and based on the first color-component reference sample and the second color-component reference sample, establishing a mapping relationship between a first color component and a second color component; and based on the mapping relationship and a sample value of the first color component of the current block, determining a predicted value of the second color component of the current block. In this way, the accuracy of chroma prediction can be improved, the bit rate is reduced, and the codec efficiency can also be improved.

### CROSS-REFERENCE TO RELATED APPLICATION

This application is a continuation application of International Patent Application No. PCT/CN2023/105717 filed on Jul. 4, 2023, the entire content of which is incorporated herein by reference.

### TECHNICAL FIELD

The present disclosure relates to the technical field of video codec, and particularly relates to coding and decoding methods, a bitstream, a coder, a decoder, and a storage medium.

### BACKGROUND

With people's increased demands for video display quality, new video application types such as high-definition video and ultra-high-definition video have emerged. The Joint Video Exploration Team (JVET) of the international standards organizations ISO/IEC and ITU-T has developed the video coding standard H.266/Versatile Video Coding (VVC). Among them, Intra block copy (IBC) is a block-level coding mode provided by VVC for video sequences of screen content types.

In the related art, for the Direct Mode (DM), if the IBC mode is used for a luma block, the setting of the chroma prediction mode in this scenario is unreasonable, resulting in inaccurate chroma prediction of the current block and degraded coding efficiency.

### SUMMARY

The present disclosure provides a coding and decoding method, a bitstream, a coder, a decoder, and a storage medium, which can improve the accuracy of chroma prediction, reduce the bit rate, and further improve the codec efficiency.

The technical solution of the present disclosure can be realized as follows:

According to a first aspect, an embodiment of the present disclosure provides a decoding method which is applied to a decoder and includes:
determining a first block vector (BV) parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
based on the mapping relationship and a sample value of the first color component of the current block, determining a predicted value of the second color component of the current block.

In a second aspect, an embodiment of the present disclosure provides a coding method, which is applied to a coder and includes:
determining a first BV parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
based on the mapping relationship and a sample value of the first color component of the current block, determining a predicted value of the second color component of the current block.

According to a third aspect, an embodiment of the present disclosure provides a bitstream which is generated through bit coding according to information to be coded. The information to be coded includes at least one of the following:
a value of first syntax element identification information, a value of second syntax element identification information, or mapping relationship index values. The first syntax element identification information is used to indicate whether a second color component of a current block uses a target prediction mode, and the second syntax element identification information is used to indicate whether the second color component of the current block is allowed to use the target prediction mode.

According to a fourth aspect, an embodiment of the present disclosure provides a coder which includes a first determination unit, a first establishment unit, and a first prediction unit.

The first determination unit is configured to determine a first BV parameter of a current block.

The first establishment unit is configured to determine a first color-component reference sample and a second color-component reference sample corresponding to the current block based on the first BV parameter, and establish a mapping relationship between a first color component and a second color component based on the first color-component reference sample and the second color-component reference sample.

The first prediction unit is configured to determine a predicted value of the second color component of the current block based on the mapping relationship and a sample value of the first color component of the current block.

According to a fifth aspect, an embodiment of the present disclosure provides a coder which includes a first memory and a first processor.

The first memory is configured to store a computer program executable on the first processor.

The first processor is configured to perform the method of the second aspect when running the computer program.

According to a sixth aspect, an embodiment of the present disclosure provides a decoder which includes a second determination unit, a second establishment unit, and a second prediction unit.

The second determination unit is configured to determine a first BV parameter of a current block.

The second establishment unit is configured to determine a first color-component reference sample and a second color-component reference sample corresponding to the current block based on the first BV parameter, and establish a mapping relationship between a first color component and a second color component based on the first color-component reference sample and the second color-component reference sample.

The second prediction unit is configured to determine a predicted value of the second color component of the current block based on the mapping relationship and a sample value of the first color component of the current block.

According to a seventh aspect, an embodiment of the present disclosure provides a decoder which includes a second memory and a second processor.

The second memory is configured to store a computer program executable on the second processor.

The second processor is configured to perform the method based on the first aspect when running the computer program.

According to an eighth aspect, an embodiment of the present disclosure provides a computer-readable storage medium having stored a computer program thereon that, when executed, implements the method based on the first aspect or implements the method based on the second aspect.

The embodiments of the present disclosure provide coding and decoding methods, a bitstream, a coder, a decoder, and a storage medium. Regardless of on a coding or decoding end, a first BV parameter of a current block is first determined, a first color-component reference sample and a second color-component reference sample corresponding to the current block is then determined based on the first BV parameter, and a mapping relationship between a first color component and a second color component is established based on the first color-component reference sample and the second color-component reference sample; and then, based on the mapping relationship and a sample value of the first color component of the current block, a predicted value of the second color component of the current block is determined. In this way, when a luma block corresponding to the current block is predicted based on a BV, a first BV parameter to which a chroma component is applied may be determined based on the BV parameter of the luma block, and a mapping relationship between the luma component and the chroma component may be established according to a luma component reference sample and a chroma component reference sample at the first BV parameter, and then the chroma component may be predicted using the mapping relationship. That is, the coding and decoding methods proposed in the embodiments of the present disclosure improve the singularity of chroma prediction, make full use of relevant information of co-located luma blocks, and can improve the accuracy of chroma prediction. Furthermore, according to the established mapping relationship, pixel-level prediction can be effectively carried out, thus further reducing the bit rate, improving the codec efficiency, and then improving the codec performance.

### BRIEF DESCRIPTION OF THE DRAWINGS

FIG. 1 is a schematic flow diagram of obtaining a reconstructed sample based on IBC mode;

FIG. 2 is a schematic diagram of a position distribution of neighbor blocks according to an embodiment of the present disclosure;

FIG. 3 is a first schematic diagram of a positional relationship between a luma block and a chroma block according to an embodiment of the present disclosure;

FIG. 4A is a schematic block diagram of a composition of a coder according to an embodiment of the present disclosure;

FIG. 4B is a schematic block diagram of a composition of a decoder according to an embodiment of the present disclosure;

FIG. 5 is a schematic diagram of a network architecture of a codec system according to an embodiment of the present disclosure;

FIG. 6 is a schematic flow diagram of a decoding method according to an embodiment of the present disclosure;

FIG. 7 is a second schematic diagram of a positional relationship between a luma block and a chroma block according to an embodiment of the present disclosure;

FIG. 8 is a third schematic diagram of a positional relationship between a luma block and a chroma block according to an embodiment of the present disclosure;

FIG. 9 is a fourth schematic diagram of a positional relationship between a luma block and a chroma block according to an embodiment of the present disclosure;

FIG. 10 is a schematic structural diagram of whether an offset position covers a current block according to an embodiment of the present disclosure;

FIG. 11 is a schematic structural diagram of whether an offset position exceeds a preset available region according to an embodiment of the present disclosure;

FIG. 12 is a schematic structural diagram for determining an best chroma BV parameter according to an embodiment of the present disclosure;

FIG. 13 is a schematic diagram of positions of a current chroma block and a corresponding co-located luma region according to an embodiment of the present disclosure;

FIG. 14 is a schematic diagram of a co-located luma region and a corresponding offset position thereof according to an embodiment of the present disclosure;

FIG. 15 is a schematic diagram of a type of a template provided by an embodiment of the present disclosure;

FIG. 16 is a schematic diagram of motion compensation of a template according to an embodiment of the present disclosure;

FIG. 17 is a schematic diagram of positions of a co-located luma region and a reference luma region according to an embodiment of the present disclosure;

FIG. 18 is a schematic diagram of downsampling according to an embodiment of the present disclosure;

FIG. 19 is a fifth schematic diagram of a positional relationship between a luma block and a chroma block according to an embodiment of the present disclosure;

FIG. 20 is a schematic flow diagram of a coding method according to an embodiment of the present disclosure;

FIG. 21 is a detailed flow diagram of a coding method according to an embodiment of the present disclosure;

FIG. 22 is a second detailed flow diagram of a coding method according to an embodiment of the present disclosure;

FIG. 23 is a schematic diagram of a BV-based chroma prediction flow according to an embodiment of the present disclosure;

FIG. 24 is a schematic diagram of a composition structure of a coder according to an embodiment of the present disclosure;

FIG. 25 is a schematic diagram of a specific hardware structure of a coder according to an embodiment of the present disclosure;

FIG. 26 is a schematic diagram of a composition structure of a decoder according to an embodiment of the present disclosure;

FIG. 27 is a schematic diagram of a specific hardware structure of a decoder according to an embodiment of the present disclosure; and

FIG. 28 is a schematic diagram of a composition structure of a codec system according to an embodiment of the present disclosure.

### DETAILED DESCRIPTION

In order to provide a more detailed understanding of the features and technical contents of the embodiments of the present disclosure, the implementation of the embodiments of the present disclosure will be described in detail below with reference to the accompanying drawings, which are for reference and illustration only, and are not intended to limit the embodiments of the present disclosure.

Unless otherwise defined, all technical and scientific terms used herein have the same meaning as commonly understood by those skilled in the art. The terminology used herein is for the purpose of describing embodiments of the present disclosure only and is not intended to limit the present disclosure.

In the following description, “some embodiments” describes a subset of all possible embodiments, but it is understood that “some embodiments” may be the same subset or different subsets of all possible embodiments, and may be combined with each other without conflict. It should also be pointed out that the terms “first\second\third” used in the embodiments of the present disclosure are only used to distinguish similar objects, and do not represent a specific ordering for the objects, and it is understood that “first\second\third” can be interchanged with a specific order or a priority order where allowed, so that the embodiments of the present disclosure described herein can be implemented in an order other than that illustrated or described herein.

Before further describing the embodiments of the present disclosure in detail, the terms used in the embodiments of the present disclosure will be described first and are applicable to the following explanations:
Coding Block (CB);
Intra block copy (IBC);
Screen Content Coding (SCC)
Block Matching (BM);
Coding Unit (CU);
Block vector (BV);
Motion Vector (MV);
Direct Block Vector (DBV);
Block Vector Guided palette (BVG-PLT);
IBC Advanced Motion Vector Prediction (AMVP);
Cross-Component Linear Model prediction (CCLM);
MERGE Mode;
PLANAR Mode;
H.266/Versatile Video Coding (VVC);
VVC Test Model (VTM).

It can be understood that in a video picture, a first color component, a second color component and a third color component are generally employed to characterize a coding block. The three color components are respectively a luma component, a blue chroma component, and a red chroma component. Specifically, the luma component is usually represented by the symbol Y, the blue chroma component is usually represented by the symbol Cb or U, and the red chroma component is usually represented by the symbol Cr or V. In this way, a video picture may be represented in the YCbCr format or in the YUV format.

It is also appreciated that IBC is an extended tool in VVC for coding video sequences of screen content types, which significantly improves the efficiency of coding screen content sequences. Specifically, IBC is a block-level coding mode. Similar to the inter-frame technology, a coding end performs motion search, specifically finding the best BV, which may also be called a motion vector, for each coding block through block matching. A BV is a vector pointing from a current block to a reference block. Different from the inter-prediction technology, the best BV of IBC is obtained by searching the reconstructed region of the picture where the current coding block is located (i.e. the current coding picture), while the inter motion vector is obtained by searching neighboring reference pictures of the current coding picture in the time domain.

In H.266/VVC, a specific process of obtaining a reconstructed pixel of a current block in the IBC mode may include: deriving a BV, deriving a prediction sample using the BV, deriving a residual sample, and deriving a reconstructed sample using the prediction sample and the residual sample.

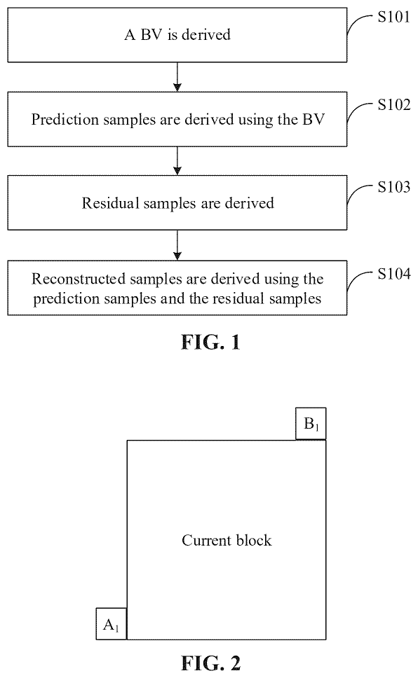

In a specific implementation, as shown in FIG. 1, a flow of obtaining a reconstructed sample in the IBC mode may include following actions:

In S101: a BV is derived.

For a luma component, the input includes: a luma position (xCb, yCb) representing the upper left sample of the current block relative to the upper left luma sample of the current picture; a variable cbWidth, representing the width of the current block in the luma sample; and a variable cbHeight, representing the height of the current block in the luma sample. The output includes a block vector Luma (bvL). The current block including luma samples may also be called a “luma block”.

Here, the IBC mode may be classified into two categories: IBC MERGE mode and IBC AMVP mode. When deriving bvL, it is required to establish an IBC BV candidate list (bvCandList). The following will introduce the establishment process of an IBC MERGE list in detail. The establishment process of an IBC AMVP list is similar to that of the IBC MERGE list, but the maximum number of candidates is different for the two lists.

Step 1 includes: when IsGt4by4 is TRUE (the variable IsGt4by4 is set to TRUE when the width multiplied by the height of a luma block is greater than 16), the decoding-specification specified procedure of deriving spatial BV candidates from the neighboring coding units is called using the position (xCb, yCb) of the luma block, the width cbWidth and the height cbHeight of the luma block as inputs, and the outputs are availability flags such as available FlagA₁ and available FlagB₁, as well as bvA₁ and bvB₁. The relative positions between the neighbor blocks where A₁ and B₁ are located and the current block are shown in FIG. 2.

Step 2 includes: when IsGt4by4 is TRUE, the pseudo code for the construction of the bvCandList is as follows:

```
i = 0
if( availableFlagA₁ )
  bvCandList [i++] = bvA₁
if( availableFlagB₁ )
  bvCandList [i++] = bvB₁
```

Step 3 includes: the derivation process of the variable numCurrCand (which is the number of candidates that have been obtained) is as follows:

If IsGt4by4 is equal to TRUE, numCurrCand is set equal to the number of candidates in bvCandList; otherwise numCurrCand is set to 0.

Step 4 includes: when numCurrCand is smaller than MaxNumIbcMergeCand (which is the maximum number of candidates in the MERGE mode) and NumHmvpIbcCand (which is the maximum number of candidates of the historical best BV (Hmvp) in the IBC mode) is larger than 0, bvCandList and numCurrCand are used as inputs, and corrected bvCandList and numCurrCand are used as outputs to invoke the history based derivation process of IBC BV candidates as specified in the decoding specification.

Step 5 includes: when numCurrCand is less than MaxNumIbcMergeCand, the following applies until numCurrCand is equal to MaxNumIbcMergeCand:
bvCandList [numCurrCand] [0] is set equal to 0 (horizontal component of BV);
bvCandList [numCurrCand] [1] is set equal to 0 (vertical component of BV);
numCurrCand increases by 1.

In this way, the bvCandList is established, and a candidate bvIdx is derived in the following manner, and general_merge_flag indicates whether it is in the IBC MERGE mode.

bvIdx=general_merge_flag[xCb][yCb] ?
merge_idx[xCb][yCb]:mvp_10_flag[xCb][yCb]

In this way, a specific bvL can be obtained based on the BVIdx and the bvCandList:

$$\begin{matrix}bvL [ 0 ] = bvCandList [ bvIdx ] [ 0 ] ; \\ bvL [ 1 ] = bvCandList [ bvIdx ] [ 1 ] .\end{matrix}$$

For the IBC AMVP mode, a specific bvL can be obtained as a predicted bvL based on the bvIdx and the bvCandList, and a real bvL is required to add a Block Vector Difference (BVD). The specific process is as follows:

Step 1 includes: the horizontal and vertical components of the BVD are obtained. MvdL0 is a forward motion vector difference, the horizontal component of the BVD is represented by bvd [0], and the vertical component of the BVD is represented by bvd [1], as follows:

$$\begin{matrix}bvd [ 0 ] = MvdL 0 [ xCb ] [ yCb ] [ 0 ] ; \\ bvd [ 1 ] = MvdL 0 [ xCb ] [ yCb ] [ 1 ] .\end{matrix}$$

Step 2 includes: a rounding operation is performed on the obtained predicted bvL. The right shift parameter AmvrShift is used for rounding, and the left shift parameter AmvrShift is used to improve the resolution. The details are as follows:

$$\begin{matrix}Offset = ( AmvrShift == 0 ) ? 0 : ( ( 1 ≪ ( AmvrShift - 1 ) ) - 1 ) ; \\ bvL [ 0 ] = Sign ( bvL [ 0 ] ) * ( ( ( Abs ( bvL [ 0 ] ) + offset ) ≫ AmvrShift ) ≪ AmvrShift ) ; \\ bvL [ 1 ] = Sign ( bvL [ 1 ] ) * ( ( ( Abs ( bvL [ 1 ] ) + offset ) ≫ AmvrShift ) ≪ AmvrShift ) .\end{matrix}$$

Step 3 includes: For the real bvL, its range needs to be controlled between −2¹⁷ and 2¹⁷−1. The specific derivation process is as follows:

$$\begin{matrix}u [ 0 ] = ( bvL [ 0 ] + bvd [ 0 ] + {2}^{18} ) {\%2}^{18} ; \\ bvL [ 0 ] = ( u [ 0 ] >= {2}^{17} ) ? ( u [ 0 ] - {2}^{18} ) : u [ 0 ] ; \\ u [ 1 ] = ( bvL [ 1 ] + bvd [ 1 ] + {2}^{18} ) {\%2}^{18} ; \\ bvL [ 1 ] = ( u [ 1 ] >= {2}^{17} ) ? ( u [ 1 ] - {2}^{18} ) : u [ 1 ] .\end{matrix}$$

For the chroma component, if it is a double tree partition, IBC is not performed for the chroma component; and if it is a single tree partition, the BV of the chroma component needs to be derived.

The input includes: bvL ( 1/16 pixel precision). The output includes: Block Vector Chroma (bvC) ( 1/32 pixel precision). The specific derivation process is as follows:

$$\begin{matrix}bvC [ 0 ] = ( ( bvL [ 0 ] ≫ ( 3 + SubWidthC ) ) * 32 ) ; \\ bvC [ 1 ] = ( ( bvL [ 1 ] ≫ ( 3 + SubHeightC ) ) * 32 ) .\end{matrix}$$

S102 includes: prediction samples are derived using the BV.

Here, the input includes: a luma position (xCb, yCb), representing the upper-left-corner sample of the current block relative to the upper-left-corner luma sample of the current picture; a variable cbWidth, representing the width of the current block in the luma sample; a variable cbHeight, representing the height of the current block in the luma sample; a BV; a variable cIdx that represents the color component index of the current block. The output includes: an array of prediction samples predSamples.

For prediction samples, the specific derivation process is as follows:

When cIdx is equal to 0, which represents a luma component, for x=xCb . . . xCb+cbWidth−1 and y=yCb . . . yCb+cbHeight−1:

$$\begin{matrix}xVb = ( x + ( bv [ 0 ] ≫ 4 ) ) \& ( IbcBufWidthY - 1 ) ; \\ yVb = ( y + ( bv [ 1 ] ≫ 4 ) ) \& ( CtbSizeY - 1 ) ; \\ predSamples [ x ] [ y ] = ibcVirBuf [ 0 ] [ xVb ] [ yVb ] .\end{matrix}$$

Here, IbcBufWidthY is the width of the luma pixels of the reconstruction Buffer stored in the IBC, CtbSizeY is the size of a Coding Tree Unit (CTU), and ibcVirBuf is the reconstruction pixel stored in the IBC.

When cIdx is not equal to 0, which represents a chroma component, for x=xCb/SubWidthC . . . xCb/SubWidthC+cbWidth/SubWidthC−1 and y=yCb/SubHeightC . . . yCb/SubHeightC+cbHeight/SubHeightC−1:

$$\begin{matrix}xVb = ( x + ( bv [ 0 ] ≫ 5 ) ) \& ( IbcBufWidthC - 1 ) ; \\ yVb = ( y + ( bv [ 1 ] ≫ 5 ) ) \& ( ( CtbSizeY / subHeightC ) - 1 ) ; \\ predSamples [ x ] [ y ] = ibcVirBuf [ cIdx ] [ xVb ] [ yVb ] .\end{matrix}$$

The variables SubWidthC and SubHeightC depend on the color sampling format specified by sps_chroma_format_idc, and the specific correspondence relationship is shown in Table 1.

TABLE 1

| | Color sampling | | |
|---|---|---|---|
| sps_chroma_format_idc | format | SubWidthC | SubHeightC |
| 0 | Monochrome | 1 | 1 |
| 1 | 4:2:0 | 2 | 2 |
| 2 | 4:2:2 | 2 | 3 |
| 3 | 4:4:4 | 1 | 1 |

S103 includes: residual samples are derived.

A residual decoding procedure specified by the decoding specification may be invoked for residual samples.

S104 includes: reconstructed samples are derived using the prediction samples and the residual samples.

For reconstructed samples (i.e. reconstructed pixel values), a picture reconstruction process for a specified color component as specified by the decoding specification may be invoked.

In another specific implementation, for the derivation process of the chroma prediction mode in H.266/VVC, the input includes: a luma position (xCb, yCb) representing the upper-left-corner sample of the current block relative to the upper-left-corner luma sample of the current picture; a variable cbWidth, representing the width of the current block in the luma sample; a variable cbHeight, representing the height of the current block in the luma sample; a variable treeType, representing whether to use single-tree partitioning or double-tree partitioning. The output includes a chroma intra prediction mode (IntraPredModeC [xCb] [yCb]) and a MIP chroma direct mode flag (MipChromaDirect Flag [xCb] [yCb]).

If treeType is equal to SINGLE_TREE, that is, in the case of single tree partition, sps_chroma_format_idc is equal to 3, i.e., YUV444 format (4:4:4 format), intra_chroma_pred_mode is equal to 4, and IntraMipFlag [xCb] [yCb] is equal to 1, that is, the prediction mode corresponding to the co-located luma center block is MIP mode, then:
(1) MipChromaDirectFlag [xCb] [yCb] is set equal to 1, that is, the MIP mode in which the chroma uses luma.
(2) IntraPredModeC [xCb] [yCb] is set equal to IntraPredModeY [xCb] [yCb].

Otherwise:
(1) MipChromaDirectFlag [xCb] [yCb] is set equal to 0.
(2) The corresponding lumaIntraPredMode is derived as follows:

If IntraMipFlag [xCb+cbWidth/2] [yCb+cbHeight/2] is equal to 1, then lumaIntraPredMode is set equal to INTRA_PLANAR.

Otherwise, if CuPredMode [0] [xCb+cbWidth/2] [yCb+cbHeight/2] is equal to MODE_IBC or MODE_PLT, then lumaIntraPredMode is set equal to INTRA_DC.

Note: IntraTmp mode is newly introduced to ECM, and if CuPredMode [0] [xCb+cbWidth/2] [yCb+cbHeight/2] is equal to MODE_INTRA and is IntraTmp mode, then lumaIntraPredMode is set equal to INTRA_PLANAR.

Otherwise, lumaIntraPredMode is set equal to IntraPredModeY [xCb+cbWidth/2] [yCb+cbHeight/2].
(3) The chroma intra prediction mode (IntraPredModeC [xCb] [yCb]) is derived as follows:

When cu_act_enabled flag [xCb] [yCb] is equal to 1, the IntraPredModeC [xCb] [yCb] is set equal to lumaIntraPredMode.

Otherwise:

If BdpcmFlag [xCb] [yCb] [1] is equal to 1, then IntraPredModeC [xCb] [yCb] is set equal to BdpcmDir [xCb] [yCb] [1]?INTRA_ANGULAR50: INTRA_ANGULAR18

Otherwise, cu_act_enabled_flag [xCb] [yCb] is equal to 0 and BdpcmFlag [xCb] [yCb] [1] is equal to 0, and IntraPredModeC [xCb] [yCb] uses cclm_mode_flag, cclm_mode_idx, intra_chroma_pred_mode, and lumaIntraPredMode specified in Table 2.

TABLE 2

| | | | lumaIntraPredMode | | | | |
|---|---|---|---|---|---|---|---|
| cclm_mode_flag | cclm_mode_idx | intra_chroma_pred_mode | 0 | 50 | 18 | 1 | X (0 <= X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

When sps_chroma_format_idc is equal to 2, the intra-chroma prediction mode Y may be derived using the intra-chroma prediction mode X in Table 2. Table 3 shows a detailed mapping specification from the mode X to the mode Y. The intra-chroma prediction mode X is then set to be equal to the intra-chroma prediction mode Y

TABLE 3

| | | | | | | | | | | | | | | | | | |
|---|---|---|---|---|---|---|---|---|---|---|---|---|---|---|---|---|---|
| mode X | 0 | 1 | 2 | 3 | 4 | 5 | 6 | 7 | 8 | 9 | 10 | 11 | 12 | 13 | 14 | 15 | 16 |
| mode Y | 0 | 1 | 61 | 62 | 63 | 64 | 65 | 66 | 2 | 3 | 5 | 6 | 8 | 10 | 12 | 13 | 14 |
| mode X | 18 | 19 | 20 | 21 | 22 | 23 | 24 | 25 | 26 | 27 | 28 | 29 | 30 | 31 | 32 | 33 | 34 |
| mode Y | 18 | 20 | 22 | 23 | 24 | 26 | 28 | 30 | 31 | 33 | 34 | 35 | 36 | 37 | 38 | 39 | 40 |
| mode X | 36 | 37 | 38 | 39 | 40 | 41 | 42 | 43 | 44 | 45 | 46 | 47 | 48 | 49 | 50 | 51 | 52 |
| mode Y | 41 | 42 | 43 | 43 | 44 | 44 | 45 | 45 | 46 | 47 | 48 | 48 | 49 | 49 | 50 | 51 | 51 |
| mode X | 54 | 55 | 56 | 57 | 58 | 59 | 60 | 61 | 62 | 63 | 64 | 65 | 66 | | | | |
| mode Y | 52 | 53 | 54 | 55 | 55 | 56 | 56 | 57 | 57 | 58 | 59 | 59 | 60 | | | | |

In yet another specific implementation, for the DM mode, the DM mode refers to directly using luma prediction mode information of a corresponding position.

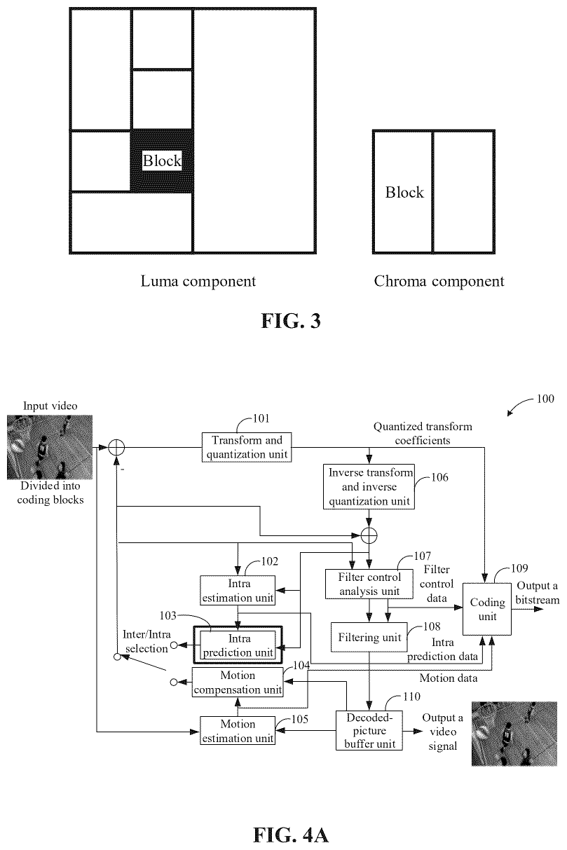

When the I-frame uses dual-tree partitioning, the luma component and the chroma component are allowed to use independent block partitioning structures, such as the Dual Tree mode in H.266/VVC. In this case, the luma component at the position corresponding to the chroma coding block may include a plurality of luma coding blocks. As shown in FIG. 3, in H.266/VVC, when the value of intra_chroma_pred_mode is equal to 4, it indicates that the current chroma block uses the DM mode for decoding.

According to an intra-prediction mode of a luma block at the center of a luma region corresponding to the same position of a chroma block, an intra-prediction mode of the chroma block is determined. The determination method may be to directly use the intra-prediction mode of the luma block or a further derived intra-prediction mode.

In actual implementation, the intra prediction mode of a chroma block may be determined based on the intra prediction mode of a luma block which includes a reference point that is the center-position coordinates of a luma region corresponding to the same position of the chroma block. The determination method may be to directly use the intra prediction mode of the luma block or an intra prediction mode obtained by further derivation.

In addition, in the embodiments of the present disclosure, the block as mentioned may be a CU, or a sub-block, or a transform block, or the like, which is not specifically limited.

The position of a coding block taken by the DM mode is described as follows.

The position of the current chroma block is obtained, that is, the position of the upper-left-corner chroma sample of the current chroma block relative to the upper-left-corner chroma sample of the current picture, chromaPos=(x, y); and chromaPos is scaled according to the color sampling format shown in Table 4 to obtain the co-located luma region position lumaPos=(xCb, yCb) corresponding to the current chroma block.

TABLE 4

| sps_chroma_format_idc | Color sampling format | xCb | yCb |
|---|---|---|---|
| 0 | Monochrome | — | — |
| 1 | 4:2:0 | x << 1 | y << 1 |
| 2 | 4:2:2 | x << 1 | y |
| 3 | 4:4:4 | x | y |

A luma position (xCb, yCb) represents a position of an upper-left-corner luma sample of a luma region corresponding to a current chroma block relative to an upper-left-corner luma sample of a current picture; a variable cbWidth represents the width of the current block in the luma sample; and a variable cbHeight represents the height of the current block in the luma sample.

The positional relationship between the current chroma block and the corresponding luma region is shown in FIG. 3. The center luma pixel position of the luma region corresponding to the current chroma CU is described as follows. Here, xCenter represents a horizontal coordinate position, yCenter represents a vertical coordinate position, and a coding block including the pixel position is a block at the center position of the luma block corresponding to the chroma block.

$$\begin{matrix}xCenter = xCb + cbWidth ≫ 1 ; \\ yCenter = yCb + cbHeight ≫ 1.\end{matrix}$$

In yet another specific implementation, for the decoding process for chroma prediction in H.266/VVC, the syntax elements related to the decoding are shown in Table 5. In addition, for the value of the syntax element intra_chroma_pred_mode, the corresponding binarized string (Bin string) is shown in Table 6. For different syntax elements (for example, cclm_mode_flag, cclm_mode_idx, intra_chroma_pred_mode, etc.), the coding method adopted by each coded bit is shown in Table 7.

TABLE 5

| | |
|---|---|
| if( !cu_act_enabled_flag ) { | |
| if(cbWidth / SubWidthC <= MaxTsSize&&cbHeight / SubHeightC <= MaxTs Size | |
| && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

TABLE 6

| Value of intra_chroma_pred_mode | Bin string |
|---|---|
| 0 | 100 |
| 1 | 101 |
| 2 | 110 |
| 3 | 111 |
| 4 | 0 |

TABLE 7

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

Here, binIdx represents the number of bits, wherein binIdx=0 represents the 0th bit, binIdx=1 represents the first bit. In addition, bypass represents a bypass mode, and na represents no action.

In the related art, under the dual-tree partition: in the DM mode, if a luma block corresponds to the IBC mode, then the obtained chroma prediction mode is the DC mode, and in this case, loss in coding efficiency is caused. For example, for chroma prediction, a fixed DC mode is used for prediction, which not only causes the prediction pixels to have the same value, but also cannot express the chroma texture feature content of the current block. Moreover, in chroma prediction, the information of the co-located luma block of the IBC mode is not used, and there is no block copy prediction algorithm similar to IBC, so that a video sequence similar to screen content cannot be effectively compressed. In short, in the present chroma prediction process, due to the incomplete chroma prediction mode, the chroma prediction of a current block is inaccurate, thus resulting in reduction in the coding efficiency.

Based on this, an embodiment of the present disclosure provides a codec method which includes: determining a first BV parameter of a current block; determining a first color-component reference sample and a second color-component reference sample corresponding to the current block based on the first BV parameter; establishing a mapping relationship between a first color component and a second color component based on the first color-component reference sample and the second color-component reference sample; and determining a predicted value of the second color component of the current block based on the mapping relationship and a sample value of the first color component of the current block.

In this way, if a co-located luma block corresponding to the current block is predicted based on a BV, a first BV parameter to which a chroma component is applied may be determined based on a BV parameter of the luma block, and a mapping relationship between a luma component and a chroma component may be established based on the luma component reference sample and the chroma component reference sample at the first BV parameter, and then prediction of the chroma component may be performed using the mapping relationship. That is, the codec method proposed in the embodiments of the present disclosure improves the singularity of chroma prediction, makes full use of relevant information of a co-located luma block, and can improve the accuracy of chroma prediction. Moreover, according to the established mapping relationship, pixel-level prediction can be effectively carried out, thus further reducing the bit rate, improving the codec efficiency, and improving the codec performance.

Hereinafter, embodiments of the present disclosure will be described in detail with reference to the accompanying drawings.

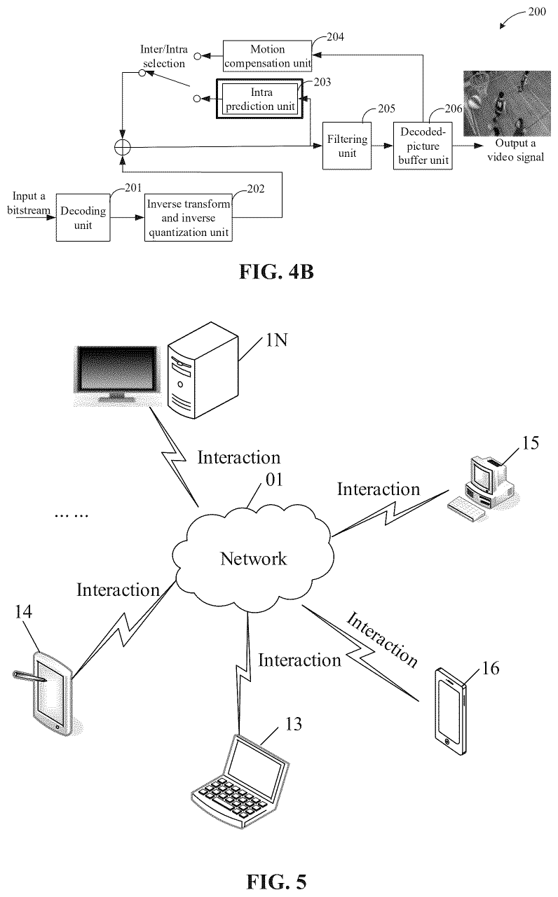

FIG. 4A illustrates a schematic block diagram of a composition of a coder provided by an embodiment of the present disclosure. As shown in FIG. 4A, a coder (specifically, a “video coder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, a decoded-picture buffer unit 110, and the like. The filtering unit 108 may implement de-block filtering and Sample Adaptive Offset (SAO) filtering. The coding unit 109 may implement header information coding and Context-based Adaptive Binary Arithmetic Coding (CABAC). For an input original video signal, a video coding block may be obtained through Coding Tree Unit (CTU) partitioning, and then the video coding block may be transformed by the transform and quantization unit 101 by transforming residual pixel information obtained after intra-frame or inter-frame prediction, including transforming the residual information from the pixel domain to the transform domain, and quantizing the obtained transform coefficient to further reduce the bit rate. The intra estimation unit 102 and the intra prediction unit 103 are configured to perform intra prediction on the video coding block, specifically, the intra estimation unit 102 and the intra prediction unit 103 are configured to determine an intra prediction mode to be used to code the video coding block. The motion compensation unit 104 and the motion estimation unit 105 are configured to perform inter prediction coding of the received video coding block with respect to one or more blocks in one or more reference frames to provide temporal prediction information. The motion estimation performed by the motion estimation unit 105 is a process of generating a motion vector that can estimate the motion of the video coding block, and then motion compensation may be performed by the motion compensation unit 104 based on the motion vector determined by the motion estimation unit 105. After determining the intra prediction mode, the intra prediction unit 103 is further configured to supply selected intra prediction data to the coding unit 109, and the motion estimation unit 105 is configured to transmit motion vector data determined via calculation to the coding unit 109. The inverse transform and inverse quantization unit 106 is configured to reconstruct the video coding block and reconstruct a residual block in the pixel domain. The blocking artifacts may be removed from the reconstructed residual block by the filter control analysis unit 107 and the filtering unit 108, and then the reconstructed residual block may be added to a predictive block in the frame of the decoded-picture buffer unit 110 to generate a reconstructed video coding block. The coding unit 109 is configured to code various coding parameters and quantized transform coefficients. In the CABAC-based coding algorithm, the context content may be based on neighbor coding blocks, and may be used to code information indicating the determined intra prediction mode and output a bitstream of the video signal. The decoded-picture buffer unit 110 is configured to store the reconstructed video coding block for prediction reference. As the video picture coding progresses, new reconstructed video coding blocks may be continuously generated, and these reconstructed video coding blocks may be stored in the decoded-picture buffer unit 110.

FIG. 4B illustrates a schematic block diagram of a composition of a decoder provided by an embodiment of the present disclosure. As shown in FIG. 4B, the decoder (specifically, a “video decoder”) 200 includes a decoding unit 201, an inverse transform and inverse quantization unit 202, an intra prediction unit 203, a motion compensation unit 204, a filtering unit 205, a decoded-picture buffer unit 206, and the like. The decoding unit 201 may implement header information decoding and CABAC decoding, and the filtering unit 205 may implement block removal filtering and SAO filtering. After an input video signal is subjected to the coding process of FIG. 4A, a bitstream of the video signal is output. The bitstream input in the decoder 200 first passes through the decoding unit 201 for obtaining transform coefficients after the decoding. The transform coefficients are processed by the inverse transform and inverse quantization unit 202 to generate a residual block in the pixel domain, The intra prediction unit 203 may be configured to generate prediction data for a current video decoding block based on the determined intra prediction mode and data from a previously decoded block of a current frame or picture. The motion compensation unit 204 is configured to determine prediction information for a video decoding block by parsing the motion vector and other associated syntax elements, and use the prediction information to generate a predictive block of the video decoding block which is being decoded. A decoded video block may be formed by summing the residual block from the inverse transform and inverse quantization unit 202 with the corresponding predictive block generated by the intra prediction unit 203 or the motion compensation unit 204. The decoded video signal passes through the filtering unit 205 to remove the blocking artifacts, which can improve the video quality. The decoded video block is then stored in the decoded-picture buffer unit 206 which stores reference pictures not only for subsequent intra prediction or motion compensation, but also for the output of the video signal, i.e. the recovered original video signal is obtained.

Further, an embodiment of the present disclosure provides a network architecture of a codec system including a coder and a decoder. FIG. 5 shows a schematic diagram of a network architecture of a codec system provided by an embodiment of the present disclosure. As shown in FIG. 5, the network architecture includes one or more electronic devices 13-IN and a communication network 01. The electronic devices 13-IN may perform video interaction through the communication network 01. The electronic devices in actual implementations may be various types of devices having video coding and decoding functions, for example, the electronic devices may include a smartphone, a tablet computer, a personal computer, a personal digital assistant, a navigator, a digital phone, a video phone, a television, a sensing device, a server, and the like, which are not limited in the embodiments of the present disclosure. Here, the decoder or coder described in the embodiments of the present disclosure may be the above-described electronic devices.

Note that the method in the embodiments of the present disclosure is mainly applied to the intra prediction unit 103 as shown in FIG. 4A and the intra prediction unit 203 as shown in FIG. 4B. That is, the embodiments of the present disclosure may be applied to a coder or a decoder, or may be applied to both the coder and the decoder, which is not limited in the embodiments of the present disclosure.

It should also be noted that, when the method is applied to the intra prediction unit 103, the “current block” specifically refers to a coding block currently to be subjected to intra prediction; and when the method is applied to the intra prediction unit 203, the “current block” specifically refers to a decoding block currently to be subjected to intra prediction.

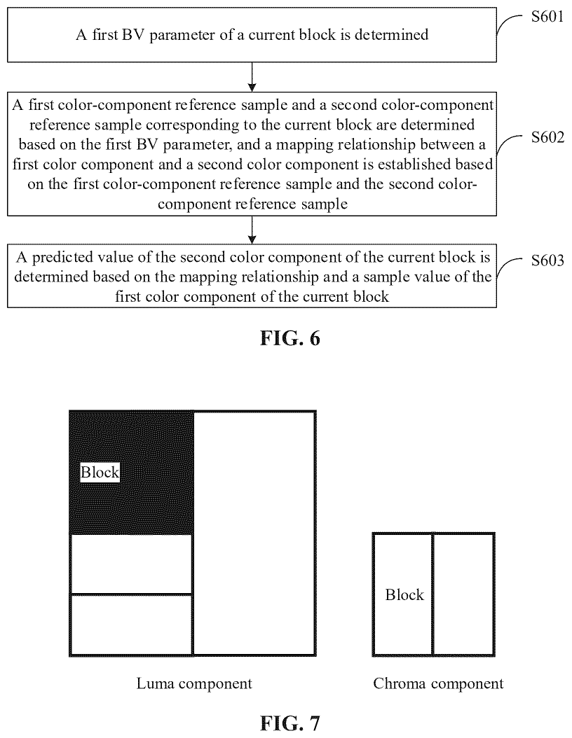

In the embodiments of the present disclosure, FIG. 6 shows a schematic flow diagram of a decoding method provided by the embodiments of the present disclosure. As shown in FIG. 6, the method may include following actions.

S601 includes: a first BV parameter of a current block is determined.

It should be noted that the decoding method in the embodiments of the present disclosure is applied to a decoder. In addition, the decoding method may specifically refer to an intra prediction method, and more specifically, a BV-based chroma prediction method. Here, a video picture may be divided into a plurality of decoding blocks, and each decoding block may include a first color component, a second color component, and a third color component, and the current block in the embodiments of the present disclosure refers to a decoding block currently to be subjected to chroma prediction in the video picture.

Here, if the current block is subjected to prediction of the first color component and the first color component is a luma component, then the current block may also be called a luma block; alternatively, if the current block is subjected to prediction of the second color component and the second color component is a chroma component, then the current block may also be called a chroma block.

It should also be noted that, in the dural-tree partitioning, for the DM mode, when the prediction mode of a co-located luma block satisfies a first condition, the first BV parameter applied to chroma may be derived based on the BV parameter of the co-located luma block in the embodiments of the present disclosure, thereby improving the coding efficiency.

In some embodiments, the action of determining a first BV parameter of a current block may include: determining a first color component block of the current block; determining a second BV parameter of the first color component block when a prediction mode of the first color component block satisfies a first condition; and determining the first BV parameter of the current block based on the second BV parameter of the first color component block.

It can be understood that in the embodiments of the present disclosure, the action of determining the first color component block of the current block may include: determining a first color component region at the same position as the current block; and determining the first color component block of the current block from the plurality of blocks divided from the first color component region.

Note that, in the embodiments of the present disclosure, if the first color component is a luma component, then the first color component region may also be called a “co-located luma region”. For example, if the current block is a chroma block, then the co-located luma region may be the co-located luma region corresponding to the current block. The first color component region at the same position as the current block may be divided into blocks, for example, by using a binary tree structure, a triple tree structure, a quadtree structure, or the like. A plurality of blocks can be obtained, and each block may be regarded as a CU, a sub-block, a transform block, or the like. The first color component block of the current block may be then determined from the plurality of blocks.

Exemplarily, FIG. 3 is taken as an example, in which a region filled with diagonal lines represents a co-located luma region corresponding to a chroma component. The co-located luma region may be divided into a plurality of blocks. The block at the center position may be selected from the blocks as the corresponding luma block of the current block, for example, the block filled with black in FIG. 3 is the corresponding luma block (i.e., the first color component block) of the current block.

Further, in some embodiments, the action of determining the first color component block of the current block from the plurality of blocks divided from the first color component region may include: selecting a target block from the plurality of blocks divided from the first color component region, and using the target block as the first color component block of the current block.

The target block may be a block at any position. In a specific embodiment, a block in the center of the first color component region may be selected as a target block. Alternatively, a block in the upper-left corner of the first color component region may be selected as a target block. Alternatively, a block in the lower-right corner of the first color component region may be selected as the target block.

Further, in some embodiments, the action of determining the first color component block of the current block may include: determining position information of the current block; scaling the position information of the current block according to a preset sampling format to obtain the position information of a co-located region corresponding to the current block; determining target position information based on the position information of the co-located region, and using the target block including the target position information as the first color component block of the current block.

Further, in some embodiments, the action of determining the target position information based on the position information of the co-located region may include: calculating a central position based on the position information of the co-located region, and using information of the obtained central position as the target position information; alternatively, performing an upper-left-corner position calculation based on the position information of the co-located region, and using the obtained upper-left position information as the target position information; alternatively, performing a lower-right-corner position calculation on the basis of the position information of the co-located region, and using the obtained lower-left position information as the target position information.

In the embodiments of the present disclosure, the preset sampling format may be a chroma sampling format (or a color sampling format). Exemplarily, the mapping relationship between the position (x, y) of the current block and the position (xCb, yCb) of the co-located region is shown in Table 4.

In a possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 3) corresponding to the current block is cbWidth and the height thereof is cbHeight, then the block at the center position (which is the block at the center of the luma region) is a luma block including the center position information (xCb+cbWidth>>1, yCb+cbHeight>>1), where the block is filled with black in FIG. 3.

In another possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 7) corresponding to the current block is cbWidth, and the height thereof is cbHeight, then the block at the upper-left corner (i.e., the block at the upper-left corner of the luma region) is a luma block including the position coordinates (xCb, yCb), where the block is filled with black in FIG. 7.

In another possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

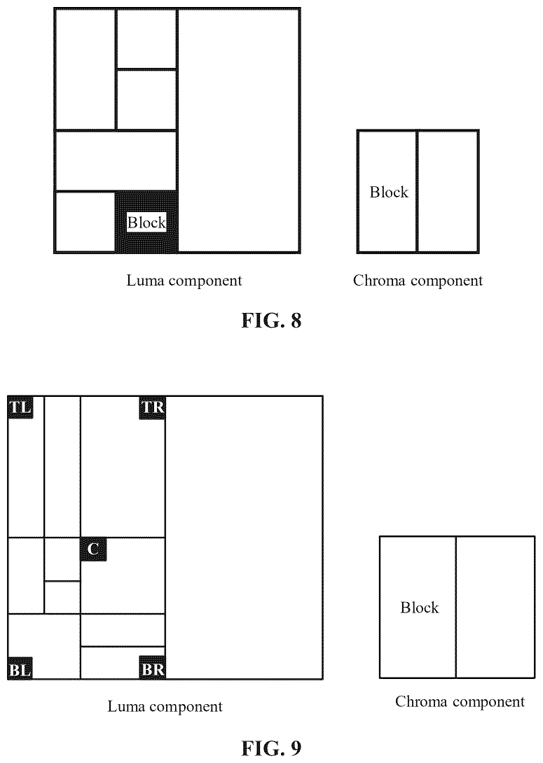

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 8) corresponding to the current block is cbWidth and the height thereof is cbHeight, then the block in the lower-right corner (i.e., the block at the lower-right corner of the luma region) is a luma block including the position coordinates (xCb+cbWidth−1, yCb+cbHeight−1), where the block is filled with black in FIG. 8.

That is, in the embodiments of the present disclosure, the target block as the first color component block may be a block at any position among the plurality of blocks illustrated in FIG. 3, for example, a block in the center of the co-located luma region (a block filled with black) as shown in FIG. 3, a block in the upper-left corner of the co-located luma region (a block filled with black) as shown in FIG. 7, a block in the lower-right corner of the co-located luma region (a block filled with black) as shown in FIG. 8, even a block in the upper-right corner of the co-located luma region, a block in the lower-left corner of the co-located luma region, or even a block in the center of the upper-left region, etc., which is not limited here.

Further, in some embodiments, the action of determining the first color component block of the current block from the plurality of blocks divided from the first color component region may include: determining at least one candidate block at a preset position from the plurality of blocks divided from the first color component region; and determining the first color component block of the current block based on the at least one candidate block.

In a specific embodiment, the action of determining the first color component block of the current block based on the at least one candidate block may include: using the at least one candidate block as the first color component block of the current block.

In another specific embodiment, the action of determining the first color component block of the current block based on the at least one candidate block may include: determining a target candidate block satisfying a preset determination condition from the at least one candidate block, and using the target candidate block as the first color component block of the current block.

Note that, in the embodiments of the present disclosure, determining whether or not a candidate block satisfies the preset determination condition may include: acquiring at least one candidate block in turn according to a preset order and performing a mode determination, and determining a first candidate block as the first color component block of the current block if the prediction mode of the determined first candidate block satisfies the first condition.

Further, in the embodiments of the present disclosure, determining whether the candidate block satisfies the preset determination condition may include: determining a first BV parameter of a first candidate block when the prediction mode of the determined first candidate block satisfies the first condition; determining whether the first BV parameter of the first candidate block satisfies an available condition; when the first BV parameter of the first candidate block satisfies the available condition, using the first candidate block as the first color component block of the current block; when the first BV parameter of the first candidate block does not satisfy the available condition, continuing the mode determination for the next candidate block until a target candidate block of which the prediction mode satisfies the first condition and the corresponding first BV parameter satisfies the available condition is determined, and using the target candidate block as the first color component block of the current block.

In the embodiments of the present disclosure, the first color component block may be determined by performing the mode determination for at least one candidate block at a preset position. For example, as shown in FIG. 9, CUs at five luma pixel positions are included here, specifically: C, TL, TR, BL, and BR. However, the embodiments of the present disclosure are not limited to the five positions, and there may be a plurality of different positions. Furthermore, the present disclosure is not limited to the five positions shown in FIG. 9, and no limits are set here.

In another possible implementation, the blocks including five luma pixel positions shown in FIG. 9 is taken as an example. The blocks may be sequentially acquired in a preset order until the obtained block is determined to perform prediction coding in a mode with BV information, that is, the block at the first luma pixel position is found to perform prediction coding in a mode with BV information, and the preset order for the sequential acquisition includes, but is not limited to, the following order: C->TL->TR->BL->BR.

For the detailed position derivation of C, TL, TR, BL, and BR, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to position of the luma pixel at the upper-left corner of the picture (that is, the position of the luma pixel TL) is (xCb, yCb), and the width of the co-located luma region (that is, the entire oblique-filled region of the luma component in FIG. 9) corresponding to the current chroma coding block is cbWidth and the height thereof is cbHeight.

The coordinates of the position of the luma pixel C are (xCb+cbWidth/2, yCb+cbHeight/2).

The coordinates of the position of the luma pixel TL are (xCb, yCb);

The coordinates of the position of the luma pixel TR are (xCb+cbWidth−1, yCb);

The coordinates of the position of the luma pixel BL are (xCb, yCb+cbHeight−1);

The coordinates of the position of the luma pixel BR are (xCb+cbWidth−1, yCb+cbHeight−1).

For the current block, firstly it is needed to determine the corresponding first color component block. For example, when the first color component is a luma component, it is needed to determine the corresponding luma block of the current block.

It is also understood that in the embodiments of the present disclosure, the method may further include: determining whether the current block uses a target prediction mode when the first color component block performs prediction based on a BV; and in response to the current block using the target prediction mode, determining that the prediction mode of the first color component block satisfies the first condition.

Note that, in the embodiments of the present disclosure, the target prediction mode is a BV guided prediction mode, which may be represented as a BVG-PLT mode or a BVG-LUT mode.

It should also be noted that, in the embodiments of the present disclosure, if the corresponding luma block of the current block performs decoding using a mode having BV information and the target prediction mode is applied to the current block, it may be determined that the prediction mode of the corresponding luma block satisfies the first condition, and in this case, the BV of the corresponding luma block may be acquired, and the first BV parameter of the current block may be determined based on the BV of the corresponding luma block. The mode using BV information includes, but is not limited to, an IBC mode or an IntraTMP mode.

It should also be noted that in the embodiments of the present disclosure, the number of first color component blocks may be any number, that is, the first color component block of the current block is not limited to one block here, and may be composed of a plurality of blocks. Accordingly, when determining whether or not to perform prediction based on a BV, such determination is required to be performed for each first color component block, and only the first color component block which performs prediction based on a BV can be used to subsequently determine the first BV parameter of the current block.

Further, in the embodiments of the present disclosure, if the first color component block does not perform prediction based on a BV, that is, the first color component block is not processed in a mode with BV information, first syntax element identification information may be not analyzed. The first syntax element identification information is used to indicate whether the second color component of the current block uses the target prediction mode.

In a specific implementation, when the first BV parameter of the current block is determined based on a second BV parameter of the first color component block, the second BV parameter of the first color component block may be directly used as the first BV parameter of the current block.

In another specific implementation, when the first BV parameter of the current block is determined based on the second BV parameter of the first color component block, a BV parameter candidate list of the second color component of the current block may be constructed based on the second BV parameter. Based on the BV parameter candidate list, the first BV parameter of the current block is determined.

That is, in the embodiments of the present disclosure, the second BV parameter of the first color component block may be directly used as the first BV parameter of the current block, or the second BV parameter may be used to construct a BV parameter candidate list of the second color component, and then the first BV parameter of the current block may be determined based on the BV parameter candidate list.

In some embodiments, the action of constructing a BV parameter candidate list of the second color component of the current block based on the second BV parameter may include: adjusting the second BV parameter to determine a candidate BV parameter of the second color component of the current block; and adding the candidate BV parameter to the BV parameter candidate list.

That is, in the embodiments of the present disclosure, the second BV parameter of the first color component block may be directly used as the first BV parameter of the current block; alternatively, the second BV parameter of the first color component block may be adjusted to determine a candidate BV parameter of the second color component, and then the candidate BV parameter may be used as the first BV parameter of the current block; alternatively, a BV parameter candidate list of the second color component may be constructed based on the candidate BV parameter, and then the first BV parameter of the current block may be determined based on the BV parameter candidate list.

Assuming that the current block is a chroma block and the first color component block is a luma block, then the first BV parameter may be a BV of the chroma block, that is, a BVC, and the second BV parameter may be a BV of a luma block, that is, a BVL.

It can be understood that, in the embodiments of the present disclosure, assuming that the second BV parameter is luma BV=(BVLhor, BVLver) and the first BV parameter is chroma BV=(BVChor, BVCver), then a BVC candidate list including one or more candidate BV parameters may be constructed by adjusting BVL or BVC.

Further, in some embodiments, the action of adjusting the second BV parameter to determine a candidate BV parameter of the second color component of the current block may include: determining a preset sampling format of the current block; and scaling the second BV parameter according to the preset sampling format to determine the candidate BV parameter of the second color component of the current block.

Note that, in the embodiments of the present disclosure, the above adjustment may include performing scaling according to a preset sampling format. The preset sampling format may be a mapping relationship between a luma BV parameter and a scaled chroma BV parameter as shown in Table 8.

TABLE 8

| | Color sampling | | |
|---|---|---|---|
| sps_chroma_format_idc | format | BVCₕₒᵣ | BVCᵥₑᵣ |
| 0 | Monochrome | — | — |
| 1 | 4:2:0 | BVLₕₒᵣ >> 1 | BVLᵥₑᵣ >> 1 |
| 2 | 4:2:2 | BVLₕₒᵣ >> 1 | BVLᵥₑᵣ |
| 3 | 4:4:4 | BVLₕₒᵣ | BVLᵥₑᵣ |

Here, the syntax element sps_chroma_format_idc is used to indicate the type of a color sampling format, and the color sampling format here is a chroma sampling format. Here, the types of color sampling formats are different, and the corresponding scaling operations are also different.

For example, when the value of sps_chroma_format_idc is 0, it is determined that the color sampling format is monochrome, that is, there is no chroma BV parameter (BVCₕₒᵣ,BVCₕₒᵣ); when the value of sps_chroma_format_idc is 1, the color sampling format is determined to be 4:2:0, and in this case, the mapping relationship between a luma BV parameter chroma BV parameter is: BVCₕₒᵣ=BVLₕₒᵣ>>1, BVCₕₒᵣ=BVLᵥₑᵣ>>1; when the and a value of sps_chroma_format_idc is 2, the color sampling format is determined to be 4:2:2, and in this case, the mapping relationship between a luma BV parameter and a chroma BV parameter is: BVCₕₒᵣ=BVLₕₒᵣ>>1, BVCₕₒᵣ=BVLᵥₑᵣ; when the value of sps_chroma_format_idc is 3, it means that the color sampling format is 4:4:4, and in this case, the mapping relationship between a luma BV parameter and a chroma BV parameter is: BVCₕₒᵣ=BVLₕₒᵣ, BVCₕₒᵣ=BVLᵥₑᵣ.

Thus, based on Table 8, scaling may be performed according to the color sampling format, and the scaled BVC as a candidate BV parameter may be added to the BVC candidate list (i.e., the BV parameter candidate list).

Further, in some embodiments, the action of adjusting the second BV parameter to determine a candidate BV parameter of the second color component of the current block may include: determining a preset sampling format of the current block; scaling the second BV parameter according to the preset sampling format to determine a first initial BV parameter of the second color component of the current block; performing an offset calculation on the first initial BV parameter based on one or more offset values to determine the candidate BV parameter of the second color component of the current block.

Further, in some embodiments, the action of adjusting the second BV parameter to determine a candidate BV parameter of the second color component of the current block may include: performing an offset calculation on the second BV parameter based on one or more offset values to determine one or more second initial BV parameters; determining a preset sampling format of the current block, and scaling one or more second initial BV parameters according to the preset sampling format to determine the candidate BV parameter of the second color component of the current block.

It should be noted that, in the embodiments of the present disclosure, the one or more offset values described above may be any number of arbitrary numerical values, such as −1, +1, −2, +2, −3, +3, etc., and are not limited herein.

That is, in the embodiments of the present disclosure, after the BV of the corresponding luma block is acquired, the BV may be denoted as BVL, the chroma BV acquired by the BVL may be denoted as BVC, and then the BVC candidates including one or more candidates may be constructed by adjusting the BVL or the BVC. That is, based on Table 8, scaling may be performed according to the color sampling format, and the scaled BVL or BVC as the candidate BV parameter may be added to the BVC candidate list.

For example, in the embodiments of the present disclosure, the BVL may be adjusted to form four cases to further adjust the BVC. When BVL is an odd number, four cases are taken: BVL=(BVLhor, BVLver), BVL=(BVLhor+1, BVLver), BVL=(BVLhor, BVLver+1), and BVL=(BVLhor+1, BVLver+1). When BVL is even, BVL=(BVLhor, BVLver) is taken. Then, based on Table 8, BVL may be scaled according to the color sampling format to obtain a BVC, so that when the BVL is odd, four types of BVC candidate BV parameters may be formed, and these candidate BV parameters may be added to the BVC candidate list.

For example, in the embodiments of the present disclosure, the BVL may be be adjusted to form four cases to further adjust the BVC. When the BVL is an odd number, four cases are taken: BVL=(BVLhor, BVLver), BVL=(BVLhor+1, BVLver), BVL=(BVLhor, BVLver+1), and BVL=(BVLhor+1, BVLver+1). When BVL is even, four cases are taken: BVL=(BVLhor, BVLver), BVL=(BVLhor−1, BVLver), BVL=(BVLhor, BVLver−1), and BVL=(BVLhor−1, BVLver−1). Then, based on Table 8, the BVL may be scaled according to the color sampling format to obtain the BVC, so that when the BVL is odd or even, four BVC candidates may be formed, and these candidates may be added to the BVC candidate list.

For example, in the embodiments of the present disclosure, the operations in the odd and even situations may be unified by calculation as follows: directly taking four cases of BVL=(BVLhor−1, BVLver−1), BVL=(BVLhor+1, BVLver−1), BVL=(BVLho−1r, BVLver+1), and BVL=(BVLhor+1, BVLver+1).

For example, in the embodiments of the present disclosure, the BVL may be adjusted to form a variety of situations to further realize adjustment of the BVC. When BVL is odd, BVL=(BVLhor, BVLver), BVL=(BVLhor+1, BVLver), BVL=(BVLhor, BVLver+1), BVL=(BVLhor+1, BVLver+1), BVL=(BVLhor+3, BVLver), BVL=(BVLhor+3, BVLver+3), BVL=(BVLhor−2, BVLver), BVL=(BVLhor, BVLver−2) and other cases are taken, and a list is constructed for these candidates in order. When BVL is even, BVL=(BVLhor, BVLver), BVL=(BVLhor−1, BVLver), BVL=(BVLhor, BVLver−1), BVL=(BVLhor−1, BVLver−1), BVL=(BVLhor−3, BVLver), BVL=(BVLhor, BVLver−3), BVL=(BVLhor+2, BVLver), BVL=(BVLhor, BVLver+2) and similar cases are taken. Then, using Table 8, the BVL may be scaled according to the color sampling format to obtain the BVC, so that when the BVL is odd or even, a plurality of BVC candidates may be formed, and these candidates may be added to the BVC candidate list.

Exemplarily, in the embodiments of the present disclosure, the operations in situations of odd and even may be unified by calculation as follows: directly taking BVL=(BVLhor−1, BVLver−1), BVL=(BVLhor+1, BVLver−1), BVL=(BVLhor−1, BVLver+1), BVL=(BVLhor+1, BVLver+1), BVL=(BVLhor+3, BVLver−1), BVL=(BVLhor−1, BVLver+3), BVL=(BVLhor−3, BVLver−1), BVL=(BVLhor−1, BVLver−3), etc.

Exemplarily, in the embodiments of the present disclosure, the obtained BVC may be adjusted to obtain nine types of candidates, namely, setting BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor−1, BVCver+1), BVC=(BVChor+1, BVCver−1), BVC=(BVChor+1, BVCver−1) to form nine types of BVC candidates which are then added to the BVC candidate list.

Exemplarily, in the embodiments of the present disclosure, the obtained BVC may be adjusted to obtain multiple types of candidates, that is, setting BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), BVC=(BVChor+1, BVCver−1), BVC=(BVChor−2, BVCver), BVC=(BVChor, BVCver−2), BVC=(BVChor−2, BVCver−2), BVC=(BVChor+2, BVCver), BVC=(BVChor, BVCver+2), BVC=(BVChor+2, BVCver+2), BVC=(BVChor−2, BVCver+2), BVC=(BVChor+2, BVCver−2) etc., to form multiple types of BVC candidates, and adding the BVC candidates to the BVC candidate list.

It should be noted that, in the embodiments of the present disclosure, in the case where the BVL is an odd or even number, since the BVL is a two-dimensional vector, the case means that a component of the BVL is an odd or even number. Here, “+1”, “−1”, “+2”, “−2”, “+3′”, and “−3” all refer to the integer pixel precision.

Further, in some embodiments, when determining the BV parameter candidate list of the second color component of the current block based on the second BV parameter of the first color component block, a best BV parameter may be determined based on the second BV parameter. The best BV parameter may be scaled according to the preset sampling format to determine the candidate BV parameter of the second color component. The BV parameter candidate list may be determined based on the candidate BV parameter.

For example, in the embodiments of the present disclosure, in the IBC mode under single-tree inter-prediction and single-tree partition, a luma BV is denoted as BVL, the best BVL (i.e., best BV parameter) is determined by RDO, and then the best BV parameter is scaled according to a preset sampling format to obtain a chroma BV, denoted as BVC. Here, the processing of scaling the best BV parameter may be performed using the above table 8, or the best BV parameter may be adjusted in combination with any one of the above adjustment or scaling methods to obtain a corresponding candidate BV parameter, thereby completing the construction of the BV parameter candidate list.

Further, in some embodiments, when determining the BV parameter candidate list of the second color component of the current block based on the second BV parameter of the first color component block, the best BV parameter corresponding to the first color component block may be determined, and then the BV parameter candidate list of the second color component of the current block may be determined based on the best BV parameter.

For example, in the embodiments of the present disclosure, the best BV parameter corresponding to the luma block may be found through the template and denoted as BVL; then, the BV parameter candidate list may be constructed based on the best BV parameter by using a construction method combined with any one of the above lists.

It is also understood that in the embodiments of the present disclosure, when determining the first BV parameter of the current block based on the BV parameter candidate list, it is also required to determine whether the candidate BV parameter is available, that is, it is required to select one or more available candidate BV parameters from the BV parameter candidate list. Thus, in some embodiments, the action of determining the first BV parameter of the current block based on the BV parameter candidate list may include:
determining whether one or more candidate BV parameters satisfying the first available condition exist in the BV parameter candidate list; and in response to there being one or more candidate BV parameters satisfying the first available condition in the BV parameter candidate list, determining the first BV parameter of the current block based on the one or more candidate BV parameters.

Specifically, in the embodiments of the present disclosure, only when the candidate BV parameter satisfies the first available condition, the candidate BV parameter may be determined as the first BV parameter of the current block.

In some embodiments, the case of one or more candidate BV parameters satisfying the first available condition includes but is not limited to:
an offset position indicated based on the one or more candidate BV parameters does not exceed a picture boundary;
an offset position indicated based on the one or more candidate BV parameters does not exceed a slice boundary;
an offset position indicated based on the one or more candidate BV parameters does not cover the current block;
an offset position indicated based on the one or more candidate BV parameters does not exceed a preset available region; and
an offset position indicated based on the one or more candidate BV parameters has been reconstructed.

Note that, in the embodiments of the present disclosure, assuming the position of the current block is (xCb, yCb), for each candidate BV parameter BVC=(BVChor, BVCver), the corresponding offset position (xCb+BVChor, yCb+BVCver) is found. Here, the offset position not exceeding the picture boundary may be described using data such as coordinate position information and size parameters of the current block, for example, xCb+width+BVChor<=xCb or yCb+height+BVCver<=yCb.

It should also be noted that in the embodiments of the present disclosure, whether or not the slice boundary is exceeded is also taken into account for the first available condition. For example, the offset position indicated based on the one or more candidate BV parameters does not exceed the slice boundary, or the offset position indicated based on the one or more candidate BV parameters does not exceed the tile boundary.

It should be understood that in the embodiments of the present disclosure, only when all of the above-described conditions are satisfied, it can be determined that the candidate BV parameter satisfies the first available condition, that is, the candidate BV parameter is available. In a specific embodiment, taking one of the candidate BV parameters as an example, the candidate BV parameter satisfies the first available condition, including at least: the offset position indicated based on the candidate BV parameter does not exceed the picture boundary; and the offset position indicated based on the candidate BV parameter does not exceed the slice boundary; and the offset position indicated based on the candidate BV parameter does not cover the current block; and the offset position indicated based on the candidate BV parameter does not exceed the preset available region; and the offset position indicated from the candidate BV parameter has been reconstructed.

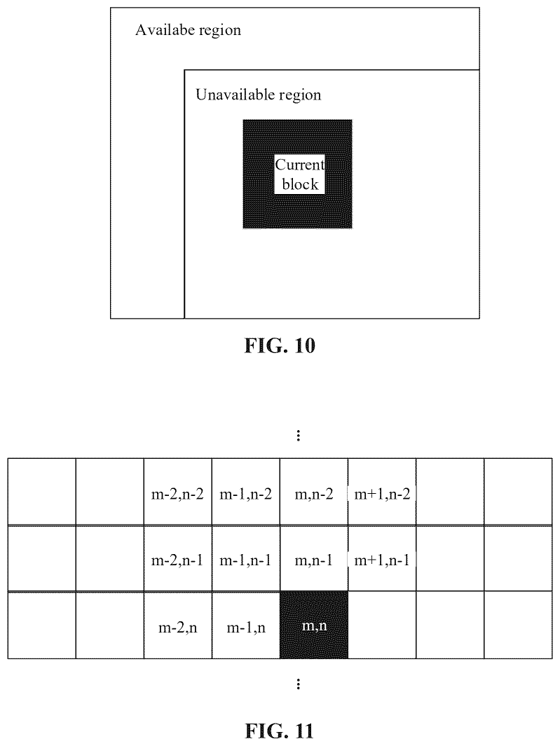

Exemplarily, FIG. 10 shows a schematic structural diagram of whether an offset position covers a current block according to an embodiment of the present disclosure. As shown in FIG. 10, a block filled with black represents the current block, a region filled with diagonal lines represents an available region, and an unfilled region represents an unavailable region. For the current block, if an offset position indicated by the candidate BV parameter is in an unavailable region, then the case of the offset position covering the current block may occur.

Exemplarily, FIG. 11 shows a schematic structural diagram of whether an offset position exceeds a preset available region according to an embodiment of the present disclosure. As shown in FIG. 11, the block filled with black represents a current block, the region filled with diagonal lines represents an available region, and the reference blocks in the available region have all been reconstructed. In the embodiments of the present disclosure, considering the storage capacity of the Buffer, in general, these reference blocks adjacent to the current block (m, n), which specifically are: a reference block (m−2, n−2), a reference block (m−1, n−2), a reference block (m, n−2), a reference block (m+1, n−2), a reference block (m−2, n−1), a reference block (m−1, n−1), a reference block (m, n−1), a reference block (m+1, n−1), a reference block (m−2, n), a reference block (m−1, n) and the like, may be used as a preset available region.

Further, in some embodiments, when constructing the BV parameter candidate list, the method may further include: adjusting at least one candidate BV parameter in the BV parameter candidate list until at least one candidate BV parameter satisfies the first available condition, in response to all candidate BVs in the BV parameter candidate list not satisfying the first available condition.

In embodiments of the present disclosure, in response to all candidate BVs in the BV parameter candidate list not satisfying the first available condition, a predicted value of the second color component of the current block may be determined according to other modes. The other modes include at least one of: a PLANAR mode, a DM mode, a DC mode, a CCLM mode, or a skip mode.

In the embodiments of the present disclosure, the candidate BV parameter of the second color component may be determined based on the second BV parameter of the first color component block. If the candidate BV parameter satisfies the first available condition, correction processing may be performed on the candidate BV parameter, and the BV parameter candidate list may be determined based on the corrected candidate BV parameter. Accordingly, if the candidate BV parameter does not satisfy the first available condition, adjustment processing may be performed on the candidate BV parameter until the adjusted candidate BV parameter satisfies the first available condition.

Note that, in the embodiments of the present disclosure, when the candidate BV parameter is corrected, the offset position of the current block may be determined based on the candidate BV parameter and the position information of the current block. Then, search processing may be performed based on the offset position of the current block, to determine the corrected candidate BV parameter.

It should also be understood that in the embodiments of the present disclosure, after the second BV parameter of the first color component block is scaled according to the preset sampling format, the obtained candidate BV parameter needs to be further corrected. Before the correction processing, it is further required to determine whether the candidate BV parameter satisfies the first available condition. When the candidate BV parameter satisfies the first available condition, the correction processing is performed on the candidate BV parameter of the current block, thereby determining the corrected parameter as the first BV parameter of the current block. Alternatively, when the candidate BV parameter does not satisfy the first available condition, the adjustment processing is performed on the candidate BV parameter until the adjusted BV parameter satisfies the first available condition, and then the adjusted BV parameter is corrected, so that the corrected parameter is determined as the first BV parameter of the current block.

That is, in the embodiments of the present disclosure, the chroma BV may be corrected, and the corrected BVC may be added to the BVC candidate list. Only the corrected BVC may be included in the BVC candidate list.

Exemplarily, after obtaining the chroma BV scaled according to the preset sampling format, the scaled chroma BV is further corrected. Before correction, it is required to determine whether the BV is available; the BV is correct if available; otherwise, if not available, the BV is adjusted to be available and is then corrected. The corrected BVC is added to the BVC candidate list.

When determining whether it is available, the position (xCb, yCb) of the current block may be obtained, the BVC=(BVChor, BVCver) may be obtained, the corresponding offset position (xCb+BVChor, yCb+BVCver) may be found, and the following conditions (i.e., the first available condition) may be judged, and if all of them are true, the BVC is determined to be available:
whether the obtained offset position does not exceed the picture boundary;
whether the obtained offset position does not cover the current block, see FIG. 10 for details;
whether the obtained offset position does not exceed the preset available region, see FIG. 11 for details; and
whether the obtained offset position has been reconstructed.

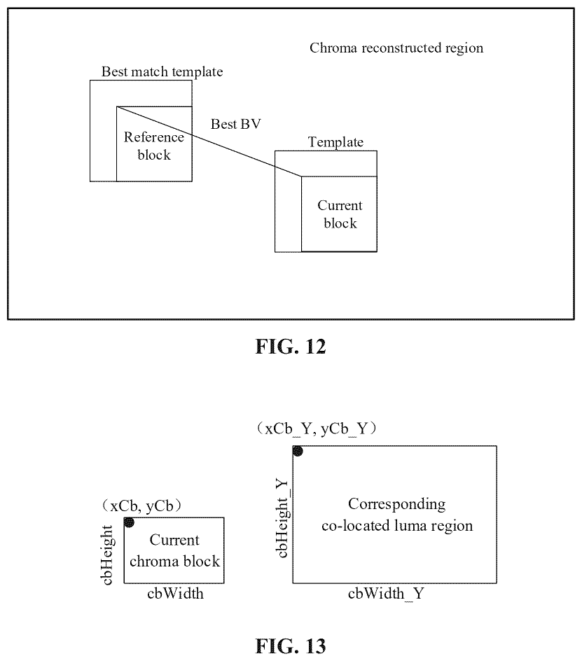

For example, in the embodiments of the present disclosure, template search may be used for correction, that is, after obtaining the corrected chroma BV parameter, the offset position is found by using the position of the current block and the corrected chroma BV parameter, and then a template matching method is used to perform fine search in the vicinity of the offset position to obtain the best chroma BV parameter, and the reference block at the best offset position obtained after the fine search is copied, that is, the chroma prediction block of the current block is obtained. As shown in FIG. 12, the region filled with diagonal lines represents the chroma reconstructed region. For the current block, the best matching template and the corresponding best BV may be found by template matching, and the reference block of the current block may be determined based on the best BV (that is, IntraTMP BV), and then the chroma predicted value of the current block can be determined.

Since whether the BV is available or not has been determined before correction, it is possible to directly determine the second BV parameter without determining whether the BV is available or not (i.e., whether the first availability condition is met).

Further, in the embodiments of the present disclosure, before constructing the BV parameter candidate list, the second BV parameter of the first color component block may be corrected, and the BV parameter candidate list may be determined based on the corrected first BV parameter. For example, the BVL is corrected, and then the BVC candidate list is constructed using any of the above-described list construction schemes.

Exemplarily, in the embodiments of the present disclosure, the co-located luma region corresponding to the current block may be acquired first. Here, as shown in FIG. 13 which is a schematic diagram of positions of a current chroma block and a corresponding co-located luma region, the position chromaPos=(xCb, yCb) of the current block is obtained, and the chromaPos is scaled according to the color sampling format based on the above table 4 to obtain lumaPos=(xCb_Y, yCb_Y) which is the position of the co-located luma region corresponding to the current block. The size parameter chromaSize=(cbWidth, cbHeight) of the current block is obtained, and the chromaSize is scaled based on the color sampling format based on the mapping relationship as shown in Table 9 to obtain lumaSize=(cbWidth_Y, cbHeight_Y) which is the size of the co-located luma region corresponding to the current block.

TABLE 9

| sps_chroma_{—} | Color sampling | | |
|---|---|---|---|
| format_idc | format | cbWidth_Y | cbHeight_Y |
| 0 | Monochrome | — | — |
| 1 | 4:2:0 | cbWidth << 1 | cbHeight << 1 |
| 2 | 4:2:2 | cbWidth << 1 | cbHeight |
| 3 | 4:4:4 | cbWidth | cbHeight |

For example, the BVL may be further corrected, and before the correction, it is first to determine whether the BVL is available (i.e., whether the second availability condition is satisfied); if available, the BVL is corrected; otherwise, if not available, the BVL is adjusted to be available and then is corrected.

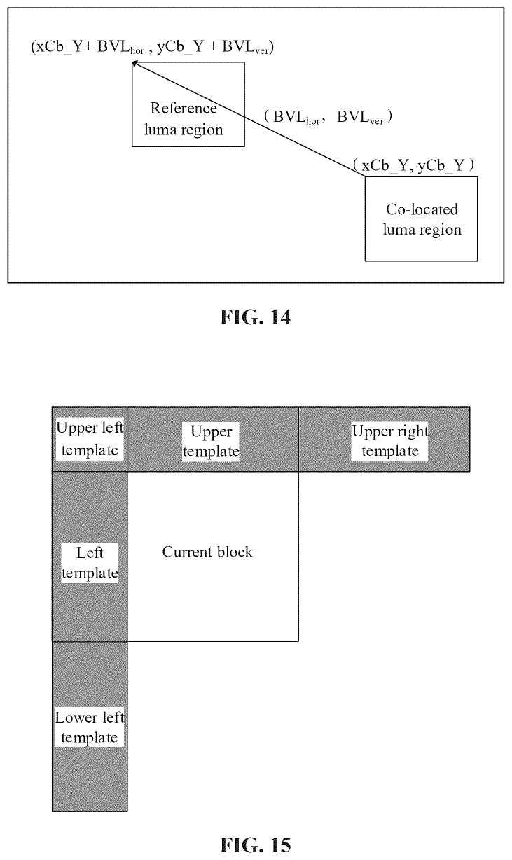

In some embodiments, when determining whether the BVL is available, the position (xCb_Y, yCb_Y) of the co-located luma region is obtained, BVL=(BVLhor, BVLver) is obtained, and the corresponding offset position (xCb_Y+BVLhor, yCb_Y+BVLver) is found, as shown in FIG. 14. The BVL (i.e., the first BV parameter) is available if the following conditions, including but not limited to the followings, are all satisfied:
the offset position indicated based on the first BV parameter does not exceed a picture boundary;
the offset position indicated based on the first BV parameter does not exceed a slice boundary;
the offset position indicated based on the first BV parameter does not exceed a preset available region, as shown in FIG. 11; and
the offset position indicated based on the first BV parameter has been reconstructed.

Further, in the embodiments of the present disclosure, when the correction processing is performed, the offset position of the first color component block may be determined based on the second BV parameter of the first color component block and the position information of the first color component block; and search processing may be performed based on the offset position of the first color component block to determine a corrected second BV parameter.

Exemplarily, the correction processing includes, but is not limited to, the following manners: performing correction by searching the co-located luma region corresponding to the current block, that is, after obtaining the BVL, finding an offset position based on the position of the co-located luma region and the obtained BVL, and performing a fine search in the vicinity of the offset position based on the co-located luma region to finally obtain the best BVL, the range of the fine search needing to meet a limited available region (as shown in FIG. 11).

It can be understood that in the embodiments of the present disclosure, the construction method of the BV parameter candidate list includes, but is not limited to, multiple cases as described above, and different methods can be used together to construct a candidate list.

Further, in some embodiments, the action of determining the first BV parameter of the current block based on one or more candidate BV parameters may include: in response to there being one candidate BV parameter that satisfies the first available condition in the BV parameter candidate list, determining the one candidate BV parameter satisfying the first available condition as the first BV parameter; and in response to there being a plurality of candidate BV parameters that satisfies the first available condition in the BV parameter candidate list, making a decision on the plurality of candidate BV parameters satisfying the first available condition to determine the first BV parameter.

It should be noted that, in the embodiments of the present disclosure, if there is one or more candidate BV parameters satisfying the first available condition, when determining the first BV parameter based on the one or more candidate BV parameters, a certain candidate BV parameter satisfying the first available condition may be directly determined as the first BV parameter. That is, if only one BVC candidate in the constructed available BVC candidate list satisfies the first available condition, then the final selected BV (i.e., the first BV parameter) is the BVC.

It should also be noted that, in the embodiments of the present disclosure, if there is one or more candidate BV parameters satisfying the first available condition, when determining the first BV parameter based on the one or more candidate BV parameters, a decision may be made on the plurality of candidate BV parameters satisfying the first available condition. Specifically, it may be: determining a first template of the current block; determining a first matching template of each of the plurality of candidate BV parameters based on the first template and the plurality of candidate BV parameters; when the first template and the first matching template satisfy the second condition, calculating a matching error between the first template and the first matching template of the current block according to a preset error criterion to determine a first cost value for each of the plurality of candidate BV parameters; determining a minimum cost value from the first cost values of the plurality of candidate BV parameters, and determining a candidate BV parameter corresponding to the minimum cost value as the first BV parameter.

That is, in the embodiments of the present disclosure, for the plurality of candidate BV parameters satisfying the first available condition, after the first cost values corresponding to the plurality of candidate BV parameters are determined, one or more second BV parameters may be determined from the plurality of candidate BV parameters based on the first cost values. For example, if a list of available BVC candidates is constructed with multiple available BVC candidates, then a decision needs to be made on these available BVCs to obtain the final BV The decision manner includes, but not limited to, decision manner using a template.

It can be understood that in the embodiments of the present disclosure, the first template includes one or more sample values in an adjacent decoded region of the current block. Accordingly, the type of the first template may include at least one of: an upper template, an upper right template, a left template, a lower left template, or an upper left template. The upper template is located in a decoded region adjacent to and above the current block, the upper right template is located in a decoded region adjacent to and upper-right of the current block, the left template is located in a decoded region adjacent to and to left of the current block, the lower left template is located in a decoded region adjacent to and lower-left of the current block, and the upper left template is located in a decoded region adjacent to and upper-left of the current block.

That is, in the embodiments of the present disclosure, when the template (i.e., the first template of the current block) is selected, whether or not the pixels at the template position are available, including the reconstructed chroma information, may be determined based on the pixel availability of the adjacent region of the current block. FIG. 15 is a schematic diagram of template types. As shown in FIG. 15, templates may be classified into an upper template, a left template, an upper right template, a lower left template, and an upper left template according to the relative positional relationship between the templates and the current block. The sizes of different types of templates of different coding blocks may be fixed the same or may be different.

For example, a same template size is selected for a current block of any size, and the following formula illustrates a setting condition for a template size, where nTbW and nTbH are the width and height of the current block, and iTempW and iTempH are the width and height of an adopted template, respectively:

$$Upper template : \{ \begin{matrix}iTempW = nTbW \\ iTempH = 1\end{matrix} \qquad ( 1 )$$

$$Left template : \{ \begin{matrix}iTempW = 1 \\ iTempH = nTbH\end{matrix} \qquad ( 2 )$$

For example, different template sizes may be selected based on different sizes of the current block. The following formula explains a size setting condition for a template, where nTbW and nTbH are the width and height of the current block, and iTempW and iTempH are the width and height of an adopted template.

$$Upper template : \{ \begin{matrix}\{ \begin{matrix}iTempWnTbW \\ iTempH = 2\end{matrix} , min ( nTbW , nTbH ) \leq 4 \\ \{ \begin{matrix}iTempW = nTbW \\ iTempH = 4\end{matrix} , min ( nTbW , nTbH ) > 4\end{matrix} \qquad ( 3 )$$

$$Left template : \{ \begin{matrix}\{ \begin{matrix}iTempW = 2 \\ iTempH = nTbH\end{matrix} , min ( nTbW , nTbH ) \leq 4 \\ \{ \begin{matrix}iTempW = 4 \\ iTempH = nTbH\end{matrix} , min ( nTbW , nTbH ) > 4\end{matrix} \qquad ( 4 )$$

$$wherein Min ( x , y ) = \{ \begin{matrix}x , x \leq y \\ y , x > y\end{matrix} .$$

For example, different template sizes may be selected based on the number of pixels in the current block, and a size setting condition for a template is described by the following formula, in which nTbW and nTbH are the width and height of the current block, nTbW×nTbH is the number of pixels of the current block, and iTempW and iTempH are the width and height of an adopted template.

$$Upper template : \{ \begin{matrix}\{ \begin{matrix}iTempWnTbW \\ iTempH = 2\end{matrix} , nTbW \times nTbH \leq 16 \\ \{ \begin{matrix}iTempW = nTbW \\ iTempH = 4\end{matrix} , nTbW \times nTbH > 16\end{matrix} \qquad ( 5 )$$

$$Left template : \{ \begin{matrix}\{ \begin{matrix}iTempW = 2 \\ iTempH = nTbH\end{matrix} , nTbW \times nTbH \leq 16 \\ \{ \begin{matrix}iTempW = 4 \\ iTempH = nTbH\end{matrix} , nTbW \times nTbH > 16\end{matrix} \qquad ( 6 )$$

In some embodiments, when determining the first matching template from the plurality of candidate BV parameters, a region indicated by the plurality of candidate BV parameters, having the same shape and containing the same number of sample values as the first template, may be determined as the first matching template by taking the position of the current point as a starting point.

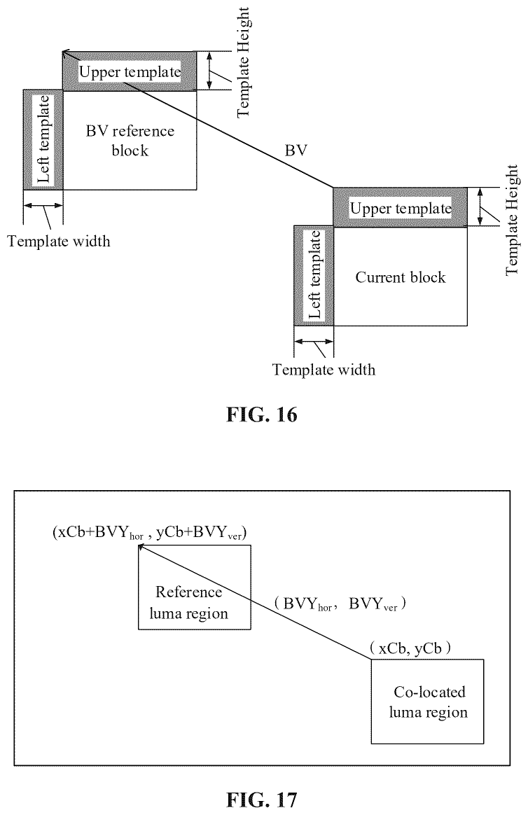

For example, in the embodiments of the present disclosure, when determining the first matching template, motion compensation is performed on the obtained plurality of BVC candidates (that is, candidate BV parameters satisfying the first available condition) using the first template of the current block to obtain a template (i.e., the first matching template) at the corresponding BV. FIG. 16 is a schematic diagram of template motion compensation. As shown in FIG. 16, if a BV (BVC candidate) is available, motion compensation may be performed using the first template and the BV to obtain a template at the corresponding BV, that is, the first matching template.

It is also understood that in the embodiments of the present disclosure, the preset error criterion may include, but is not limited to, any one of: sum of absolute differences (SAD), sum of absolute transformed differences (SATD), sum of squared errors (SSE), mean absolute difference (MAD), mean absolute error (MAE), mean square error (MSE), and the like.

For example, in the embodiments of the present disclosure, when performing a cost calculation, that is, when determining the first cost value, there are a plurality of optional cost functions for calculating the cost of the template region, that is, there are a plurality of optional preset error criteria. For example, such evaluation criteria as sum of absolute differences (SAD), sum of absolute transformed differences (SATD), sum of squared errors (SSE), mean absolute difference (MAD), mean absolute error (MAE), and mean square error (MSE) may be selected. One of the evaluation criteria mentioned below may be selected from the above criteria. Taking the evaluation criterion SAD as an example, the calculation formula is as follows:

$$SAD = {\sum }_{i = 0}^{predTempSizeW - 1} {\sum }_{j = 0}^{predTempSizeH - 1} \vert predTemp [ i ] [ j ] - recTempC [ i ] [ j ] \vert \qquad ( 7 )$$

where predTempSizeW is the width of the template, predTempSizeH is the height of the template, predTemp[i][j] is the pixel of the template at BV, and recTempC[i][j] is the pixel of the template of the current block.

Further, in some embodiments, the method may further include: when the first template and the first matching template do not satisfy the second condition, determining a first candidate BV parameter that satisfies the first available condition in the BV parameter candidate list as the first BV parameter; or,
when the first template and the first matching template do not satisfy the second condition, determining a candidate BV parameter that satisfies the first available condition at a preset position in the BV parameter candidate list as the first BV parameter.

That is, if the first template and the first matching template satisfy the second condition, the matching error between the first template and the first matching template of the current block may be calculated according to the preset error criterion, and the candidate BV parameter corresponding to the minimum cost value may be selected as the first BV parameter. If the first template and the first matching template do not satisfy the second condition, the candidate BV parameter at a specific position of the first candidate BV parameter satisfying the first available condition in the BV parameter candidate list may be used as the first BV parameter.

Exemplarily, for whether the first template and the first matching template satisfy the second condition, the template usage for calculating the cost (that is, the cost value) has the following situations:
Type 1: both the upper template and the left template of the current block exist, and both the upper template and the left template at the corresponding BV exist, in which case, both the upper template and the left template are available;
Type 2: both the upper template and the left template of the current block exist, and only the upper template exists at the corresponding BV, in which case, there are two ways: way 1: no left template exists at the corresponding BV and no left template is used, that is, only the upper template is used for calculation; and way 2: no left template not exists at the corresponding BV, and the leftmost template width column inside the reference block is used to replace the left template, that is, the upper template and the left template are used for calculation;
Type 3: both the upper template and the left template of the current block exist, and only the left template exists at the corresponding BV, in which case, there are two ways: way 1: no upper template exists at the corresponding BV and no upper template is used, that is, only the left template is used for calculation; and way 2: no upper template exists at the corresponding BV, and the uppermost template height row inside the reference block is used instead of the upper template, that is, the upper template and the left template are used for calculation;
Type 4: only the upper template exists in the current block, in which case, there are three ways: way 1: no upper template exists at the corresponding BV and no upper template is used, in this way, the final selected BV is the first BVC in the BVC candidate list or the BVC at a specified position; way 2: no upper template exists at the corresponding BV, and the uppermost template height row inside the reference block is used instead of the upper template; and way 3: an upper template exists at the corresponding BV, so it is used directly;
Type 5: only the left template exists in the current block, in which case, there are three ways: way 1: no left template exists at the corresponding BV and no left template is used, in this way, the final selected BV is the first BVC in the BVC candidate list or a BVC at a specified position; way 2: no left template exists at the corresponding BV, and the leftmost template width column inside the reference block is used instead of the left template; and way 3: a left template exists at the corresponding BV, so it is used directly; and

Type 6: neither the upper template nor the left template exists in the current block, and in this case, the final selected BV is the first BVC in the BVC candidate list or a BVC at a specified position.

For example, in the embodiments of the present disclosure, when the first BV parameter is determined based on the first cost value of each of the plurality of candidate BV parameters, except for the case where the cost cannot be calculated, the cost of each candidate in the BVC candidate list is calculated and sorted, and the sorting method includes but is not limited to bubble sorting, selection sorting, insertion sorting, Hill sorting, merge sorting, quick sorting, radix sorting, heap sorting, count sorting, and bucket sorting and the like. Any number of BVCs with the lowest cost is selected as the final BV (i.e., the first BV parameter), to perform chroma prediction based on the BV. It should also be noted that when calculating the cost values of the plurality of candidate BV parameters, a cost may be calculated for each candidate BV parameter, and the candidate BV parameter with the lowest cost may always be reserved. In this case, it is not required to list or even sort them.

Further, in the embodiments of the present disclosure, if all candidate BV parameters in the BV parameter candidate list do not satisfy the first available condition, the candidate BV parameters in the BV parameter candidate list may be adjusted until one or more candidate BV parameters satisfying the first available condition appears in the BV parameter candidate list.

That is, in the embodiments of the present disclosure, if all candidate BV parameters in the BV parameter candidate list are not available, that is, all candidate BV parameters in the BV parameter candidate list do not satisfy the first availability condition, any one or more BVC candidates (i.e., candidate BV parameters) in the BV parameter candidate list may be selected and adjusted until they are available. The adjustment methods include, but are not limited to, cropping, scaling, and the like. Prediction may also be performed using a PLANAR mode, a CCLM-like mode, or an angular prediction mode, or the like, that is, other modes may be selected as a basis for determining a predicted value of the second color component of the current block determined. For example, if a PLANAR mode or a CCLM-like mode or an angle prediction mode is selected, reference pixels and mode parameters may be acquired for chroma prediction.

S602 includes: a first color-component reference sample and a second color-component reference sample corresponding to the current block are determined based on the first BV parameter, and a mapping relationship between a first color component and a second color component is established based on the first color-component reference sample and the second color-component reference sample.

Note that, in the embodiments of the present disclosure, after the first BV parameter is determined, the luma reference sample and the chroma reference sample at the first BV parameter may be acquired. In some embodiments, the action of determining the first color-component reference sample and the second color-component reference sample corresponding to the current block based on the first BV parameter may include:
determining a position of the current block; scaling the position of the current block to determine a position of the first color component region at the same position as the current block; scaling the first BV parameter to determine a third BV parameter of the first color component region at the same position as the current block; determining a reference block of the first color component based on the position of the first color component region and the third BV parameter, and determining the first color-component reference sample corresponding to the current block based on the reference block of the first color component; and determining a reference block of the second color component, based on the position of the current block and the first BV parameter, and determining the second color-component reference sample corresponding to the current block based on the reference block of the second color component.

In the embodiments of the present disclosure, the position of the first color component region may be obtained by scaling the position of the current block according to a preset sampling format. The third BV parameter of the first color component region may be obtained by scaling the first BV parameter according to a preset sampling format. Here, the preset sampling format is shown in Table 4. It should be noted that the third BV parameter may be obtained by amplifying the chroma BV (i.e., the first BV parameter). However, considering that there may be loss of precision in the luma BV, the luma BV amplified by the chroma BV may be not equal to the original luma BV (i.e., the second BV parameter).

For example, the current block is a chroma block, and the first color component region at the same position is a co-located luma region. For obtaining the first color-component reference sample (i.e., a luma reference sample), it is first to obtain the position of the current block, that is, chromaPos=(x, y) which is the position of the upper-left-corner chroma sample of the current block relative to the upper-left-corner chroma sample of the current picture; and the chromaPos is scaled according to the color sampling format shown in Table 4 to obtain lumaPos=(xCb, yCb) which is the position of the the co-located luma region corresponding to the current block.

For example, the chroma BV=(BVChor, BVCver) is obtained, and the chroma BV is scaled according to the color sampling format shown in Table 4 to obtain the luma BV=(BVYhor, BVYver) of the co-located luma region corresponding to the current block. As shown in FIG. 17, the position lumaPos=(xCb, yCb) of the co-located luma region corresponding to the current block is obtained, the luma BV=(BVYhor, BVYver) is obtained, and the offset position (xCb+BVYhor, yCb+BVYver) of the co-located luma region corresponding to the current block is found.

In a specific implementation, after the luma sample at the offset position is obtained, the luma sample may be downsampled to obtain a luma reference sample. In some embodiments, the action of determining the first color-component reference sample corresponding to the current block based on the reference block of the first color component may include: performing down-sampling processing on the reference block of the first color component to determine the first color-component reference sample corresponding to the current block to make the resolution of the first color-component reference sample the same as that of the second color-component reference sample.

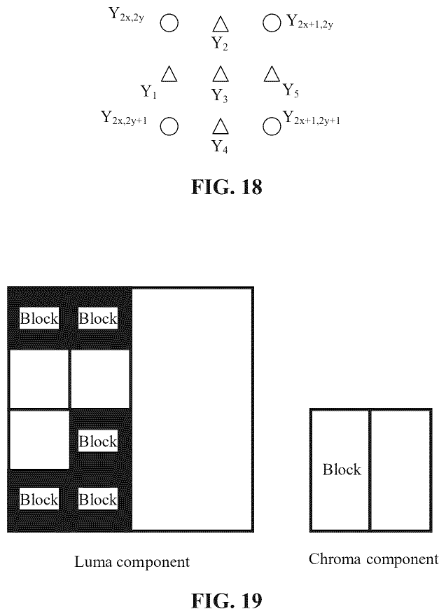

Note that, in the embodiments of the present disclosure, since the resolutions of the luma sample and the chroma sample are inconsistent, it is required to perform downsampling processing on the luma sample to make the resolution of the down-sampled luma sample as same as that of the chroma sample. FIG. 18 shows a schematic diagram of a downsampling position.

It should also be noted that, in the embodiments of the present disclosure, the following sampling manners may compete or a certain sampling manner thereof may be adopted by default, but the present disclosure is not limited to the following six sampling manners. For example, assuming that a luma sample before downsampling is recBvBefDownLuma, the width of buffer is iRecRefLumaStride, and a luma sample after downsampling is recBvAftDownLuma, then the luma sample after downsampling at position (i, j) is:
(1) downsampling method 1:

$$recBvAftDownLuma [ i ] [ j ] = ( r ecBvBefDownLuma [ 2 * i ] * 2 + recBvBefDownLuma [ 2 * i + 1 ] + recBvBefDownLuma [ 2 * i - 1 ] + recBvBefDownLuma [ 2 * i + iRecRefLumaStride ] * 2 + recBvBefDownLuma [ 2 * i + 1 + iRecRefLumaStride ] + recBvBefDownLuma [ 2 * i - 1 + i RecRefLumaStride ] + 4 ) >> 3 ;$$

(2) downsampling method 2:

$$recBvAftDownLuma [ i ] [ j ] = ( r ecBvBefDownLuma [ 2 * i ] + recBvBefDownLuma [ 2 * i + 1 ] + 1 ) >> 1 ;$$

(3) downsampling method 3:

$$recBvAftDownLuma [ i ] [ j ] = ( r ecBvBefDownLuma [ 2 * i ] + recBvBefDownLuma [ 2 * i + i RecRefLumaStride ] + 1 ) >> 1 ;$$

(4) downsampling method 4:

$$recBvAftDownLuma [ i ] [ j ] = ( r ecBvBefDownLuma [ 2 * i + iRecRefLumaStride ] + recBvBefDownLuma [ 2 * i + 1 + i RecRefLumaStride ] + 1 ) >> 1$$

(5) downsampling method 5:

$$recBvAftDownLuma [ i ] [ j ] = ( r ecBvBefDownLuma [ 2 * i + 1 ] + recBvBefDownLuma [ 2 * i + 1 + i RecRefLumaStride ] + 1 ) >> 1 ;$$

(6) downsampling method 6:

$$recBvAftDownLuma [ i ] [ j ] = ( r ecBvBefDownLuma [ 2 * i ] + recBvBefDownLu ma [ 2 * i + 1 ] + recBvBefDownLu ma [ 2 * i + i RecRefLumaStride ] + recBvBefDownLu ma [ 2 * i + 1 + i RecRefLumaStride ] + 2 ) >> 2.$$

In this way, after downsampling, the downsampled luma reference sample recBvAftDownLuma at the BV corresponding to the co-located luma region corresponding to the current block is acquired.

Further, for the chroma sample of the current block, first, the position (xCbC, yCbC) of the current block is obtained, chroma BV=(BVChor, BVCver) is obtained, and the corresponding offset position (xCbC+BVChor, yCbC+BVCver) is found, that is, the chroma reference sample recBvChroma at the corresponding BV of the current block is obtained.

In this way, a mapping relationship between luma and chroma can be constructed based on the luma reference sample recBvAftDownLuma and the chroma reference sample recBvChroma.

In some embodiments, the action of establishing a mapping relationship between a first color component and a second color component based on the first color-component reference sample and the second color-component reference sample may include: determining a first look-up table based on the first color-component reference sample and the second color-component reference sample, wherein the first look-up table is used for recording a value of the second color component when an index key is the first color component.

In some embodiments, the action of establishing a mapping relationship between the first color component and the second color component based on the first color-component reference sample and the second color-component reference sample may include: determining a first discrete model based on the first color-component reference sample and the second color-component reference sample, wherein the first discrete model is used to indicate the mapping relationship between the first color component and the second color component.

That is, in the embodiments of the present disclosure, the mapping relationship may be a Look Up Table (LUT). The index key in the LUT may be the first color component, and the value in the LUT may be the second color component, that is, value=LUT [key]. Alternatively, the mapping relationship may also be a discrete model for characterizing the mapping relationship between key-value.

For example, assuming that the luma component is key and the chroma component is value, each key-value pair in the mapping relationship may be established in a manner including but not limited to the following:

$$LUT [ recBvAftDownLuma [ i ] [ j ] ] = recBvChroma [ i ] [ j ] \qquad ( 8 )$$

It should also be noted that, in the embodiments of the present disclosure, the first color component parameter sample may be limited to a preset sample range. In some embodiments, the method may further include: performing a mapping processing on the first color-component reference sample to make the first color-component reference sample locate in a preset sample range.

In the embodiments of the present disclosure, the preset sample range may be [0, (1<<bitdepth)−1], where bitdepth represents a bit depth. Exemplarily, the preset sample range may be [0,255], [0,511], or the like range, but is not particularly limited. Where there are a plurality of sample ranges, one of them may be selected as the final preset sample range using a rate-distortion cost method.

Exemplarily, taking a video with a bit depth greater than 8 bits as an example, assuming that the bit depth of the video is 10 bits, then the sample range is [0, 1023]. For the recBvAftDownLuma of the key, it may be mapped to a preset sample range of [0,255] or [0,511].

Further, in some embodiments, the method may further include: when the first reference sample values in the first color-component reference sample are the same and correspond to a plurality of different second reference sample values in the second color-component reference sample, performing overwrite processing in sample order, and using the last second reference sample value as a value having a mapping relationship with the first reference sample values.

Further, in some embodiments, the method may further include: when the first reference sample values in the first color-component reference sample are the same and correspond to a plurality of different second reference sample values in the second color-component reference sample, calculating an average value of the plurality of different second reference sample values, and using the obtained average value as a value having a mapping relationship with the first reference sample values.

That is, in the embodiments of the present disclosure, for different chroma values having the same key in the mapping relationship, entries having the same key may be overwritten in the order of samples, or operations such as averaging can be performed. Additionally, in the mapping relationship, the initialization of LUT [ ] is set to −1, which is an unavailable value. “Overwrite” mainly means that if there is the same key later, a new value will be used for storage. However, it is not limited to this manner. All values may also be stored and then an average value may be calculated as the value corresponding to the key.

It can be understood that in the embodiments of the present disclosure, the first color-component reference sample and the second color-component reference sample used for constructing the mapping relationship may be obtained in other ways, and the following will be exemplarily described in conjunction with several implementations.

In another specific implementation, the luma sample is not downsampled, and in this case, the chroma sample may be upsampled to obtain the chroma reference sample. In some embodiments, the action of determining the second color-component reference sample corresponding to the current block based on the reference block of the second color component may include: performing upsampling processing on the reference block of the second color component to determine the second color-component reference sample corresponding to the current block to make the resolution of the first color-component reference sample the same as the resolution of the second color-component reference sample.

That is, in the embodiments of the present disclosure, downsampling is not performed after the luma sample recBvBefDownLuma of the co-located luma region is acquired. In this case, after obtaining the chroma sample recBvChroma at the BV corresponding to the current block, it is required to perform up-sampling, including but not limited to linear interpolation, etc., to obtain the chroma sample recBvChromaUp having the same size as the luma sample at the BV Thus, the luma sample recBvBefDownLuma at BV is used as the luma reference sample, and the obtained up-sampled chroma sample recBvChromaUp is used as the chroma reference sample; and then, a mapping relationship between luma and chroma is constructed based on the luma reference sample and the chroma reference sample.

Accordingly, in the embodiments of the present disclosure, it is further required to perform downsampling processing on the predicted value of the second color component of the current block. That is, if the chroma sample is upsampled when the mapping relationship is constructed, a luma-to-chroma prediction is performed on the current block based on the mapping relationship, and the obtained chroma predicted value is required to be downsampled to obtain the final chroma predicted value of the current block. The downsampling includes, but is not limited to, average downsampling and the like.

In yet another specific implementation, the method may further include: determining a first template of the current block; and determining a first color-component reference sample and a second color-component reference sample corresponding to the current block based on the first template.

In the embodiments of the present disclosure, the first color-component reference sample and the second color-component reference sample used for constructing the mapping relationship may further include the first color-component reference sample and the second color-component reference sample determined by the first template of the current block. Specifically, based on the first template of the current block, a first color-component-region template at the same position as the first template may be determined. The first color-component reference sample may then be determined from a reconstructed sample in the first color-component-region template; and the second color-component reference sample may be determined from a reconstructed sample in the first template. The first template includes one or more reconstructed samples in adjacent decoded regions of the current block.

Exemplarily, in the embodiments of the present disclosure, a chroma reference sample may be obtained based on a current chroma template of a current block; after a co-located luma region template of the current chroma template is determined, a luma reference sample may be obtained based on the co-located luma region template. Then, combining the luma reference samples and the chroma reference samples obtained in the above embodiments, a mapping relationship between luma and chroma may be constructed based on the luma reference samples and the chroma reference samples.

In yet another specific implementation, the method may further include: determining a first template of the current block; determining a second matching template of the current block based on the first BV parameter and the first template; and determining a first color-component reference sample and a second color-component reference sample corresponding to the current block based on the second matching template.

In the embodiments of the present disclosure, the first color-component reference sample and the second color-component reference sample used for constructing the mapping relationship may include the first color-component reference sample and the second color-component reference sample determined by the second matching template of the current block in addition to those determined by the reference block and the first template of the current block. Specifically, a first color-component-region matching template at the same position as the second matching template is first determined, and then the first color-component reference sample may be determined based on a reconstructed sample in the first color-component-region matching template; the second color-component reference sample may be determined from a reconstructed sample in the second matching template. The second matching template may be determined based on the first BV parameter and the offset position indicated by the first template.

Exemplarily, in the embodiments of the present disclosure, a chroma matching template of the current block may be determined based on the current chroma template of the current block and the first BV parameter. Based on the chroma matching template, a chroma reference sample may be obtained; after determining a co-located-luma-region matching template of the current chroma matching template, a luma reference sample may be obtained based on the co-located-luma-region matching template. Then, combining the luma reference samples and the chroma reference samples obtained in the above embodiments, a mapping relationship between luma and chroma may be constructed based on the luma reference samples and the chroma reference samples.

S603 includes: a predicted value of the second color component of the current block is determined based on the mapping relationship and a sample value of the first color component of the current block.

It should be noted that, in the embodiments of the present disclosure, the action of determining the sample value of the first color component of the current block may include: determining a reconstructed pixel sample of a first color component region at the same position of the current block; and determining the sample value of the first color component of the current block based on the reconstructed pixel sample of the first color component region. However, the reconstructed pixel sample of the first color component region may be directly used as the sample value of the first color component of the current block; or, the reconstructed pixel sample of the first color component region may be filtered, and the filtered reconstructed pixel sample may be used as the sample value of the first color component of the current block, which is not specifically limited here.

For example, in the embodiments of the present disclosure, the filtering process is a downsampling process. Here, a reconstructed luma sample recBefDownLuma at lumaPos=(xCb, yCb) which is the position of the co-located luma region corresponding to the current block may be acquired, and downsampling may be performed on the luma sample to obtain a down-sampled reconstructed luma sample recAftDownLuma, and the down-sampled reconstructed luma sample may be used as the sample value of the first color component of the current block. In addition, if a luma reference sample has been subjected to sample-range mapping processing, the down-sampled reconstructed luma sample is also required to be subjected to the same sample-range mapping processing to obtain the sample value of the first color component of the current block.

In some embodiments, the action of determining the predicted value of the second color component of the current block based on the mapping relationship and the sample value of the first color component of the current block may include: in response to finding a value of the first color component equal to the sample value of the first color component in the mapping relationship, determining a value of the second color component corresponding to the value of the first color component as the predicted value of the second color component of the current block.

For example, in the embodiments of the present disclosure, assuming that the predicted value of the current block is predSamples, the variable cIdx in predSamples [cIdx] [x] [y] represents the color-component index of the current block, and the following prediction method may be adopted:
deriving a chroma predicted value using the mapping relationship (i.e., a discrete model) established in the foregoing embodiments by referring to the luma value Yc corresponding to the same position of the color component.

In some embodiments, for determining the predicted value of the second color component of the current block, the method may further include: in response to failing to find the value of the first color component equal to the sample value of the first color component in the mapping relationship, performing correction processing on the sample value of the first color component to determine a corrected value of the first color component, and continuing to search whether a value of the first color component equal to the corrected value of the first color component exists in the mapping relationship.

In a specific embodiment, the action of performing correction processing on the the reconstructed value of the first color component to determine the corrected value of the first color component may include: performing an offset calculation on the sample value of the first color component based on one or more preset offset values to determine the corrected value of the first color component.

In the embodiments of the present disclosure, the offset value may be +1, −1, +2, −2, +3, −3, etc., and specific values and the number of offset values are not limited. Further, for the correction processing of the reconstructed value of the first color component, a plurality of offset values may be set in a predetermined order, and the correction processing may be performed in the order of {+1, −1, +2, −2, +3, −3}, for example.

For example, in the embodiments of the present disclosure, if Yc is not found in the input luma set in the mapping relationship established in the foregoing embodiments, the following processing may include, but is not limited to, performing correction processing on Yc in the order of {Yc+1, Yc−1, Yc+2, Yc−2, Yc+3, Yc−3}, then performing matching check in the input luma set based on the corrected Yc, and then determining a value corresponding to the corrected Yc as the chroma predicted value of the current block.

In some embodiments, for determining the predicted value of the second color component of the current block, the method may further include: in response to failing to find the value of the first color component equal to the corrected value of the first color component in the mapping relationship, calculating an average value for the second color-component reference sample, and determining the obtained average value as the predicted value of the second color component of the current block.

For example, in the embodiments of the present disclosure, if Yc is not found in the input luma set in the mapping relationship established in the foregoing embodiments, the following processing may include, but is not limited to, performing correction processing on Yc in the order of {Yc+1, Yc−1, Yc+2, Yc−2, Yc+3, Yc−3}, and setting the chroma predicted value to the average value of the reconstructed chroma sample recBvChroma at the corresponding BV if the mapping relationship fails to match all the above corrected Yc.

In some embodiments, for determining the predicted value of the second color component of the current block, the method may further include: determining a first initial predicted value of the second color component of the current block based on the mapping relationship and the sample value of the first color component of the current block; and performing a correction operation on the first initial predicted value to determine the predicted value of the second color component of the current block.

It should be noted that, in the embodiments of the present disclosure, for the action of performing a correction operation on the first initial predicted value obtained based on the mapping relationship, the correction operation thereof may include a clip operation, a filtering operation, a weighting operation with predicted values obtained in other prediction modes, and the like, and there is no limitation thereon.

In a specific embodiment, the action of performing a correction operation on the first initial predicted value to determine the predicted value of the second color component of the current block may include: performing prediction processing on the second color component of the current block according to a first preset mode to determine a second initial predicted value of the second color component of the current block; and performing a weighting calculation on the first initial predicted value and the second initial predicted value to determine the predicted value of the second color component of the current block. Note that, in the embodiments of the present disclosure, the first preset mode includes at least one of the following: a PLANAR mode, a DM mode, a DC mode, or a CCLM mode. That is, the action of performing the correction operation on the first initial predicted value obtained based on the mapping relationship may include, but is not limited to, weighting with the CCLM-like mode or other prediction modes to obtain the chroma predicted value of the current block.

In another specific embodiment, the action of performing a correction operation on the first initial predicted value to determine the predicted value of the second color component of the current block may include: limiting the first initial predicted value to a preset value range, which may also be called a “clip operation”. Note that, in the embodiments of the present disclosure, the lower limit value of the preset value range is the minimum predicted value (min), and the upper limit value of the preset value range is the maximum predicted value (max). If the first initial predicted value is within the preset value range, the first initial predicted value may be used as the chroma predicted value of the current block; if the first initial predicted value is greater than max, then max may be used as the chroma predicted value of the current block; and if the first initial predicted value is less than min, min may be used as the chroma predicted value of the current block.

In some embodiments, for determining the predicted value of the second color component of the current block, the method may further include: determining a plurality of third initial predicted values of the second color component of the current block when the number of the first BV parameters is more than one; and performing a weighting calculation on the plurality of third initial predicted values to determine the predicted value of the second color component of the current block.

It should be noted that, in the embodiments of the present disclosure, if a plurality of BVs (i.e., the first BV parameters) are determined in the foregoing embodiments, a plurality of third initial predicted values may be obtained based on the plurality of BVs. Then the plurality of third initial predicted values are weighted, and the weighted predicted values are used as chroma predicted values of the current block. Alternatively, the weighted predicted values may be continuously corrected, including but not limited to weighting with a CCLM-like mode or other prediction modes, to obtain a chroma predicted value of the current block.

In some embodiments, for determining the predicted value of the second color component of the current block, the method may further include: when the first color component block of the current block includes a plurality of candidate blocks, determining a second BV parameter for each of the plurality of candidate blocks; constructing a plurality of BV parameter candidate lists of the second color component of the current block based on the second BV parameters of the plurality of candidate blocks, and determining a plurality of first BV parameters of the second color component of the current block based on the plurality of BV parameter candidate lists; and establishing the mapping relationship between the first color component and the second color component based on the plurality of first BV parameters, and determining the predicted value of the second color component of the current block based on the mapping relationship and the sample value of the first color component of the current block.

Note that, in the embodiments of the present disclosure, a plurality of blocks in the co-located luma region are acquired, and the positions of the plurality of blocks include but are not limited to the following positions, as shown in FIG. 19. First, whether the plurality of blocks are available is determined, and then candidates of respective BVC candidate lists are constructed based on the luma BV of the available blocks in the plurality of blocks; the plurality of blocks determine the availability of BVs in the candidate list to further determine one or more BVs, and a mapping table LUT between luma and chroma can be established based on all available BVC of the plurality of blocks, so that the chroma predicted value of the current block can be obtained according to the mapping table LUT.

In some embodiments, for determining the predicted value of the second color component of the current block, the method may further include: determining a plurality of sets of first color-component reference samples and second color-component reference samples corresponding to the current block based on the plurality of first BV parameters; establishing a plurality of candidate mapping relationships between the first color component and the second color component based on the plurality of sets of the first color-component reference samples and the second color-component reference samples corresponding to the current block; decoding a bitstream and determining mapping relationship index values; determining a target mapping relationship according to the mapping relationship index values and the plurality of candidate mapping relationships; and determining the predicted value of the second color component of the current block according to the target mapping relationship and the sample value of the first color component of the current block.

It should be noted that, in the embodiments of the present disclosure, a plurality of mapping tables LUT between luma and chroma may be established, and then a selected target mapping table LUT may be specified using a syntax element. Exemplarily, a plurality of blocks of the co-located luma region are acquired, and the positions of the plurality of blocks include, but are not limited to, the following positions, as shown in FIG. 19. First, whether the plurality of blocks are available is determined, and then candidates of respective BVC candidate lists of the plurality of blocks may be constructed based on the luma BV of the available blocks in the plurality of blocks; the plurality of blocks respectively determine the availability of the BVs in the candidate lists to further determine one BV or a plurality of BVs, and a mapping table LUT may be established respectively based on respective available BVC of the plurality of blocks. At the decoding end, the mapping relationship index values may be determined by decoding the corresponding syntax element; according to the mapping relationship index values, the target mapping relationship may be determined, and then the chroma predicted value of the current block may be determined. It is to be noted that the number of mapping relationships established here may be set arbitrarily, and for example, the number may be set to 4, but is not particularly limited.

In some embodiments, for determining the predicted value of the second color component of the current block, the method may further include: determining a plurality of sets of first color-component reference samples and second color-component reference samples corresponding to the current block based on the plurality of first BV parameters; establishing a plurality of candidate mapping relationships between the first color component and the second color component based on the plurality of sets of first color-component reference samples and second color-component reference samples corresponding to the current block; performing a matching error calculation on the plurality of candidate mapping relationships based on a template matching method to determine a second cost value of each of the plurality of candidate mapping relationships; determining a minimum cost value from the second cost values of the plurality of candidate mapping relationships, and determining a candidate mapping relationship corresponding to the minimum cost value as a target mapping relationship; and determining the predicted value of the second color component of the current block according to the target mapping relationship and the sample value of the first color component of the current block.

In a specific embodiment, the action of performing a matching error calculation on the plurality of candidate mapping relationships based on a template matching method to determine a second cost value of each of the plurality of candidate mapping relationships may include: determining a first template of the current block; determining reconstructed pixel sample values of a first color-component-region template at a same position as the first template; determining predicted values of respective second color components of the first template under the plurality of candidate mapping relationships based on the plurality of candidate mapping relationships and the reconstructed pixel sample values of the first color-component-region template; performing cost calculations based on reconstructed values of the second color components of the first template and the predicted values of the respective second color components of the first template under the plurality of candidate mapping relationships, and determining respective second cost values of the plurality of candidate mapping relationships.

Note that, in the embodiments of the present disclosure, a plurality of mapping table LUTs between luma and chroma may be established, and then a template may be used to select which mapping table LUT to use. Exemplarily, a plurality of blocks of the co-located luma region are acquired, and the positions of the plurality of blocks include, but are not limited to, the following positions, as shown in FIG. 19. First, whether the plurality of blocks are available is determined, and then candidates of respective BVC candidate lists are constructed based on the luma BVs of the available blocks in the plurality of blocks; the plurality of blocks respectively determine the availability of the BVs in the candidate list to further determine one BV or a plurality of BVs, and a mapping table LUT may be established respectively based on respective available BVC of the plurality of blocks. The template of the current block may be predicted using different mapping tables LUT, and the difference value may be calculated with the reconstructed value of the template, and then which mapping relationship is specifically used may be decided, and then the chroma predicted value of the current block may be determined using the finally decided mapping relationship. It is to be noted that the number of mapping relationships established here may be set arbitrarily, and for example, the number may be set to 4, but is not particularly limited.

In a specific embodiment, a specific process of performing LUT prediction on the template of the current block is as follows:
acquiring a reconstructed luma sample recBef DownLumaR at lumaPos=(xCbR, yCbR) which is a position of a co-located luma region template corresponding to the template of the current block, downsampling the luma sample to obtain a downsampled reconstructed luma sample recAftDownLumaR, and performing a same sample-range mapping processing on the sample.

Assuming that the predicted value of the template of the current block is predSamplesR, the variable cIdx in predSamplesR [cIdx] [x] [y] represents the color component index of the current block, and the prediction method is: referring to the luma value Yc corresponding to the same position of the color component to derive the predicted value using the established mapping relationship. If Yc is not found in the input luma set in the established mapping relationship, the following processing includes, but not limited to, checking in the order of {Yc+1, Yc−1, Yc+2, Yc−2, Yc+3, Yc−3}, and if the mapping relationship cannot match all the above values, the chroma predicted value of the current block is set to the average value of the reconstructed chroma samples recBvChroma at the corresponding BV.

When performing a cost calculation based on template of the current block and the template predicted value of each LUT, the usage of the template has the following situations:
the first type: both the upper template and the left template of the current block exist, and both the upper template and the left template are available;
the second type: only the upper template exists in the current block, and only the upper template is available;
the third type: only the left template exists in the current block, and only the left template is available; and
the fourth type: neither the upper template nor the left template of the current block exists, in which case, the final selected LUT is a first established LUT or a LUT at a specified position.

Exemplarily, in the embodiments of the present disclosure, assuming that the reconstructed value of the template of the current block is recSamplesR, there are a plurality of optional cost functions for calculating the template region cost, for example, such evaluation criteria as sum of absolute differences (SAD), sum of absolute transformed differences (SATD), sum of squared errors (SSE), mean absolute difference (MAD), mean absolute error (MAE), mean square error (MSE) may be selected. One of the evaluation criteria mentioned below may be selected from the above criteria. Taking SAD as an example, the calculation formula is as follows:

$$SAD = {\sum }_{i = 0}^{p r e d T e m p S i z e W - 1} {\sum }_{j = 0}^{p r e d T e m p S i z e H - 1} \vert predSamplesR [ i ] [ j ] - recSamplesR [ i ] [ j ] \vert ) \qquad ( 9 )$$

Here, predTempSizeW is a width of the template, predTempSizeH is a height of the template, predSamplesR [i] [j] is a prediction pixel of the template of the current block after LUT, and recSamplesR [i] [j] is a reconstructed pixel of the template of the current block.

It should also be noted that, in the embodiments of the present disclosure, for the final LUT selected using the template of the current block, except for the case where the cost cannot be calculated, the cost of each established LUT candidate may be calculated and sorted in other cases, and the sorting method includes but is not limited to bubble sorting, selection sorting, insertion sorting, Hill sorting, merge sorting, quick sorting, radix sorting, heap sorting, count sorting, and bucket sorting. The LUT candidate with the lowest cost is selected as the finally used LUT.

In some embodiments, the method may further include: decoding a bitstream and determining a value of first syntax element identification information; and performing the action of determining a first BV parameter of a current block when the first syntax element identification information indicates that the second color component of the current block uses a target prediction mode.

Note that, in the embodiments of the present disclosure, if the value of the first syntax element identification information is a first value, it is determined that the first syntax element identification information indicates that the second color component of the current block uses the target prediction mode; and if the value of the first syntax element identification information is a second value, it is determined that the first syntax element identification information indicates that the second color component of the current block does not use the target prediction mode.

It should also be noted that in the embodiments of the present disclosure, the first color component region at the same position of the current block is determined. If the current block uses the DM mode and the first color component region is predicted based on a BV, it is determined that the second color component of the current block uses the target prediction mode.

For example, in the embodiments of the present disclosure, under the dual-tree partition, in the DM mode, if the corresponding luma region has BV information, prediction is performed for the current block by use of the target prediction mode. For example:
If CuPredMode [0] [xCb+cbWidth/2] [yCb+cbHeight/2] is equal to MODE_IBC, intra bvgplt_flag=1 is set, then the intra-chroma prediction mode IntraPredModeC [xCb] [yCb] is the target prediction mode.
If CuPredMode [0] [xCb+cbWidth/2] [yCb+cbHeight/2] is equal to MODE_INTRA, if IntraTmpFlag [xCb+cbWidth/2] [yCb+cbHeight/2] is equal to 1, intra bvgplt_flag=1 is set, then the intra-chroma prediction mode IntraPredModeC [xCb] [yCb] is the target prediction mode.

In the embodiments of the present disclosure, the first syntax element identification information may be represented by intra_bvgplt_flag or bvgplt_flag, and the target prediction mode may be represented by BVG-PLT or BVG-LUT. The chroma prediction mode is derived as follows:
the intra-chroma prediction mode IntraPredModeC [xCb] [yCb] uses cclm_mode_flag, cclm_mode_idx, intra_chroma_pred_mode, lumaIntraPredMode, and lumaTempPredMode specified in the following table. These padding items other than the BVG-LUT mode are exemplarily given values, and it is not necessary to fill in with these values. Table 10 shows an example of derivation of a chroma prediction mode. As shown in Table 10, 0 represents the Planar mode, 1 represents the DC mode, 18 represents the horizontal mode, 50 represents the vertical mode, and 81 to 83 represent the CCLM mode.

TABLE 10

| | | | lumaIntraPredMode | | | | | |
|---|---|---|---|---|---|---|---|---|
| | | | (intra_bvgplt_flag == 0) | | | | | |
| | | | | | | | X | |
| cclm_mode_flag | cclm_mode_idx | intra_chroma_pred_mode | 0 | 50 | 18 | 1 | (0 ≤ X ≤ 66) | intra_bvgplt_flag == 1 |
| 0 | — | 0 | 66 | 0 | 0 | 0 | 0 | 0 |
| 0 | — | 1 | 50 | 66 | 50 | 50 | 50 | 50 |
| 0 | — | 2 | 18 | 18 | 66 | 18 | 18 | 18 |
| 0 | — | 3 | 1 | 1 | 1 | 66 | 1 | 1 |
| 0 | — | 4 | 0 | 50 | 18 | 1 | X | BVG-LUT |
| 1 | 0 | — | 81 | 81 | 81 | 81 | 81 | 81 |
| 1 | 1 | — | 82 | 82 | 82 | 82 | 82 | 82 |
| 1 | 2 | — | 83 | 83 | 83 | 83 | 83 | 83 |

As can be seen from Table 10, in the DM mode, if intra_ibc_flag==1, that is, the information acquired by the center block of the co-located luma region includes a BV, the intra-chroma prediction mode IntraPredModeC [xCb] [yCb] is the BVG-LUT mode.

In some embodiments, the method may further include: decoding the bitstream and determining a value of second syntax element identification information; and in response to the second syntax element identification information indicating that the second color component of the current block is allowed to use the target prediction mode, performing the action of decoding a bitstream and determining a value of first syntax element identification information.

Note that, in the embodiments of the present disclosure, the second syntax element identification information may be represented by BvgpltEnabled. If the value of the second syntax element identification information is a first value, the second syntax element identification information indicates that the second color component of the current block is allowed to use the target prediction mode; and if the value of the second syntax element identification information is a second value, the second syntax element identification information indicates that the second color component of the current block is not allowed to use the target prediction mode.

It should also be noted that in the embodiments of the present disclosure, the first value is different from the second value. The first value and the second value may be in the form of parameters or numerics. Specifically, both the first syntax element identification information and the second syntax element identification information may be parameters written in a profile, or may be values of flags/identifiers, and is not specifically limited here.

Exemplarily, the first value may be set to 1 and the second value may be set to 0; alternatively, the first value may be set to 0 and the second value may be set to 1; alternatively, the first value may be set to true and the second value may be set to false; alternatively, the first value may be set to false and the second value may be set to true. However, in the embodiments of the present disclosure, the first value may be set to 1, and the second value may be set to 0, and this is not specifically limited.

Exemplarily, in the embodiments of the present disclosure, if the syntax element sps_ibc_enabled_flag is equal to 0 and sps_intratmp_enabled_flag is equal to 0, then BvgpltEnabled is equal to 0, otherwise, the variable ModeIncludeBv is set. If the corresponding luma block is not coded in the mode with BV information, the variable ModeIncludeBv is equal to 0; otherwise ModeIncludeBv equals 1.

BvgpltEnabled is equal to 1 if multiple following conditions are true at the same time (including but not limited to the following conditions):
ModeIncludeBv equals 1;
Sh_slice_type is equal to I-frame;
CtbLog2SizeC is less than or equal to MaxChromalbcSize, and MaxChromalbcSize may be determined based on a chroma CTU size or a preset value.

Otherwise, BvgpltEnabled is equal to 0. Here, if BvgpltEnabled is equal to 0, the value of the first syntax element identification information may be inferred to be 0.

It should also be noted that, in the embodiments of the present disclosure, the value of the first syntax element identification information may be determined by competing between the BVG-LUT mode and other modes at the coding side. In the DM mode, in addition to the BVG-LUT mode, competition may be performed with other modes. The final mode to be used may be determined based on the template cost. For example, instead of directly using the BV obtained by luma, a BV copy may be directly used, or the BVG-LUT mode defined in the embodiments of the present disclosure may be used, and after both modes are applied to the template of the current block, the one having the lower template cost is selected as the target prediction mode of the current block.

An embodiment provides a decoding method, in which a first BV parameter of a current block is determined; a first color-component reference sample and a second color-component reference sample corresponding to the current block are determined based on the first BV parameter; a mapping relationship between a first color component and a second color component is established based on the first color-component reference sample and the second color-component reference sample; based on the mapping relationship and a sample value of the first color component of the current block, a predicted value of the second color component of the current block is determined. Thus, after the first BV parameter to which the chroma component is applied is determined based on the BV parameter of the luma block, a mapping relationship between the luma component and the chroma component is established based on the luma component reference sample and the chroma component reference sample at the first BV parameter, and then prediction of the chroma component is performed using the mapping relationship. In this way, the singularity of chroma prediction is improved, the relevant information of the co-located luma block is fully utilized, and the accuracy of chroma prediction can be improved. Furthermore, pixel-level prediction can be effectively carried out according to the established mapping relationship, thus further reducing the bit rate and improving the codec efficiency.

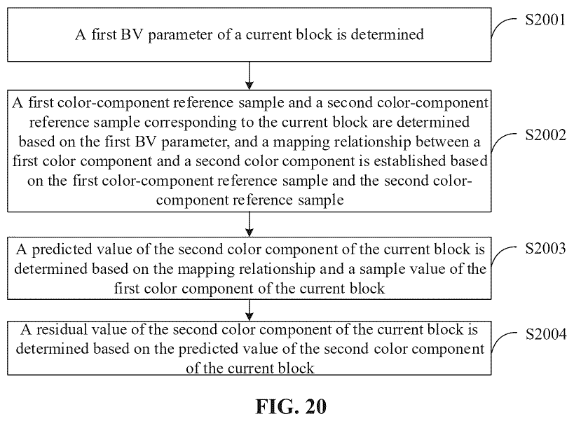

In another embodiment of the present disclosure, see FIG. 20, which shows a schematic flow diagram of a coding method provided by an embodiment of the present disclosure. As shown in FIG. 20, the method may include following actions.

S2001 includes: a first BV parameter of a current block is determined.

The coding method according to the embodiments of the present disclosure is applied to a coder. In addition, the coding method may specifically refer to an intra prediction method, and more specifically, a BV-based chroma prediction method. Here, a video picture may be divided into a plurality of coding blocks, each coding block may include a first color component, a second color component, and a third color component, and the current block in the embodiments of the present disclosure refers to a coding block currently to be subjected to chroma prediction in the video picture.

Here, if the current block is subjected to prediction of the first color component, and the first color component is a luma component, then the current block may also be called a luma block; alternatively, if the current block is subjected to prediction of the second color component and the second color component is a chroma component, then the current block may also be called a chroma block.

It should also be noted that, in the dural-tree partitioning, for the DM mode, when the prediction mode of a co-located luma block satisfies a first condition, the first BV parameter applied to chroma may be derived based on the BV parameter of the co-located luma block in the embodiments of the present disclosure, thereby improving the coding efficiency.

In some embodiments, the action of determining a first BV parameter of a current block may include: determining a first color component block of the current block; determining a second BV parameter of the first color component block when a prediction mode of the first color component block satisfies a first condition; and determining the first BV parameter of the current block based on the second BV parameter of the first color component block.

It can be understood that in the embodiments of the present disclosure, the action of determining the first color component block of the current block may include: determining a first color component region at the same position as the current block; and determining the first color component block of the current block from the plurality of blocks divided from the first color component region.

Note that, in the embodiments of the present disclosure, if the first color component is a luma component, then the first color component region may also be called an “co-located luma region”. For example, if the current block is a chroma block, then the co-located luma region may be the co-located luma region corresponding to the current block. The first color component region at the same position as the current block may be divided into blocks, for example, by using a binary tree structure, a triple tree structure, a quadtree structure, or the like. A plurality of blocks can be obtained, and each block may be regarded as a CU, a sub-block, a transform block, or the like. The first color component block of the current block may be then determined from the plurality of blocks.

Exemplarily, FIG. 3 is taken as an example, in which a region filled with diagonal lines represents a co-located luma region corresponding to a chroma component. The co-located luma region may be divided into a plurality of blocks. The block at the center position may be selected from the blocks as the corresponding luma block of the current block, for example, the block filled with black in FIG. 3 is the corresponding luma block (i.e., the first color component block) of the current block.

Further, in some embodiments, the action of determining the first color component block of the current block from the plurality of blocks divided from the first color component region may include: selecting a target block from the plurality of blocks divided from the first color component region, and using the target block as the first color component block of the current block.

The target block may be a block at any position. In a specific embodiment, a block in the center of the first color component region may be selected as a target block. Alternatively, a block in the upper-left corner of the first color component region may be selected as a target block. Alternatively, a block in the lower-right corner of the first color component region may be selected as the target block.

Further, in some embodiments, the action of determining the first color component block of the current block may include: determining position information of the current block; scaling the position information of the current block according to a preset sampling format to obtain the position information of a co-located region corresponding to the current block; determining target position information based on the position information of the co-located region, and using the target block including the target position information as the first color component block of the current block.

Further, in some embodiments, the action of determining the target position information based on the position information of the co-located region may include: calculating a central position based on the position information of the co-located region, and using information of the obtained central position as the target position information; alternatively, performing an upper-left-corner position calculation based on the position information of the co-located region, and using the obtained upper-left position information as the target position information; alternatively, performing a lower-right-corner position calculation on the basis of the position information of the co-located region, and using the obtained lower-left position information as the target position information.

In the embodiments of the present disclosure, the preset sampling format may be a chroma sampling format (or a color sampling format). Exemplarily, the mapping relationship between the position (x, y) of the current block and the position (xCb, yCb) of the co-located region is shown in Table 4.

In a possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 3) corresponding to the current block is cbWidth and the height thereof is cbHeight, then the block at the center position (which is the block at the center of the luma region) is a luma block including the center position information (xCb+cbWidth>>1, yCb+cbHeight>>1), where the block is filled with black in FIG. 3.

In another possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 7) corresponding to the current block is cbWidth, and the height thereof is cbHeight, then the block at the upper-left corner (i.e., the block at the upper-left corner of the luma region) is a luma block including the position coordinates (xCb, yCb), where the block is filled with black in FIG. 7.

In another possible implementation, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left corner of the current block relative to the luma pixel at the upper-left corner of the picture is (xCb, yCb), and the width of the co-located luma region (that is, the entire oblique-filled region of the luma component in FIG. 8) corresponding to the current block is cbWidth and the height thereof is cbHeight, then the block in the lower-right corner (i.e., the block at the lower-right corner of the luma region) is a luma block including the position coordinates (xCb+cbWidth−1, yCb+cbHeight−1), where the block is filled with black in FIG. 8.

That is, in the embodiments of the present disclosure, the target block as the first color component block may be a block at any position among the plurality of blocks illustrated in FIG. 3, for example, a block in the center of the co-located luma region (a block filled with black) as shown in FIG. 3, a block in the upper-left corner of the co-located luma region (a block filled with black) as shown in FIG. 7, a block in the lower-right corner of the co-located luma region (a block filled with black) as shown in FIG. 8, even a block in the upper-right corner of the co-located luma region, a block in the lower-left corner of the co-located luma region, or even a block in the center of the upper-left region, etc., which is not limited here.

Further, in some embodiments, the action of determining the first color component block of the current block from the plurality of blocks divided from the first color component region may include: determining at least one candidate block at a preset position from the plurality of blocks divided from the first color component region; and determining the first color component block of the current block based on the at least one candidate block.

In a specific embodiment, the action of determining the first color component block of the current block based on the at least one candidate block may include: using the at least one candidate block as the first color component block of the current block.

In another specific embodiment, the action of determining the first color component block of the current block based on the at least one candidate block may include: determining a target candidate block satisfying a preset determination condition from the at least one candidate block, and using the target candidate block as the first color component block of the current block.

Note that, in the embodiments of the present disclosure, determining whether or not a candidate block satisfies the preset determination condition may include: acquiring at least one candidate block in turn in a preset order and performing a mode determination, and determining a first candidate block as the first color component block of the current block if the prediction mode of the determined first candidate block satisfies the first condition.

Further, in the embodiments of the present disclosure, determining whether the candidate block satisfies the preset determination condition may include: determining a first BV parameter of a first candidate block when the prediction mode of the determined first candidate block satisfies the first condition; determining whether the first BV parameter of the first candidate block satisfies an available condition; when the first BV parameter of the first candidate block satisfies the available condition, using the first candidate block as the first color component block of the current block; when the first BV parameter of the first candidate block does not satisfy the available condition, continuing the mode determination for the next candidate block until a target candidate block of which the prediction mode satisfies the first condition and the corresponding first BV parameter satisfies the available condition is determined, and using the target candidate block as the first color component block of the current block.

In the embodiments of the present disclosure, the first color component block may be determined by performing the mode determination for at least one candidate block at a preset position. For example, as shown in FIG. 9, CUs at five luma pixel positions are included here, specifically: C, TL, TR, BL, and BR. However, the embodiments of the present disclosure are not limited to the five positions, and there may be a plurality of different positions. Furthermore, the present disclosure is not limited to the five positions shown in FIG. 9, and no limits are set here.

In another possible implementation, the blocks including five luma pixel positions shown in FIG. 9 is taken as an example. The blocks may be sequentially acquired in a preset order until the obtained block is determined to perform prediction coding in a mode with BV information, that is, the block at the first luma pixel position is found to perform prediction coding in a mode with BV information, and the preset order for the sequential acquisition includes, but is not limited to, the following order: C->TL->TR->BL->BR.

For the detailed position derivation of C, TL, TR, BL, and BR, the position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format shown in Table 4 to obtain lumaPos=(xCb, yCb) which is the position of the co-located luma region corresponding to the current block.

Here, it is assumed that the position of the co-located luma pixel corresponding to the upper-left-corner of the current block relative to position of the luma pixel at the upper-left corner of the picture (that is, the position of the luma pixel TL) is (xCb, yCb), and the width of the co-located luma region (that is, the entire oblique-filled region of the luma component in FIG. 9) corresponding to the current chroma coding block is cbWidth and the height thereof is cbHeight.

The coordinates of the position of the luma pixel C are (xCb+cbWidth/2, yCb+cbHeight/2);

The coordinates of the position of the luma pixel TL are (xCb, yCb);

The coordinates of the position of the luma pixel TR are (xCb+cbWidth−1, yCb);

The coordinates of the position of the luma pixel BL are (xCb, yCb+cbHeight−1);

The coordinates of the position of the luma pixel BR are (xCb+cbWidth−1, yCb+cbHeight−1).

For the current block, firstly it is needed to determine the corresponding first color component block. For example, when the first color component is a luma component, it is needed to determine the corresponding luma block of the current block.

It is also understood that in the embodiments of the present disclosure, the method may further include: determining whether the current block uses a target prediction mode when the first color component block performs prediction based on a BV; and in response to the current block using the target prediction mode, determining that the prediction mode of the first color component block satisfies the first condition.

Note that, in the embodiments of the present disclosure, the target prediction mode is a BV guided prediction mode, and may be represented as a BVG-PLT mode or a BVG-LUT mode.

It should also be noted that, in the embodiments of the present disclosure, if the corresponding luma block of the current block performs decoding using a mode having BV information and the target prediction mode is applied to the current block, it may be determined that the prediction mode of the corresponding luma block satisfies the first condition, and in this case, the BV of the corresponding luma block may be acquired, and the first BV parameter of the current block may be determined based on the BV of the corresponding luma block. The mode using BV information includes, but is not limited to, an IBC mode or an IntraTMP mode.

It should also be noted that in the embodiments of the present disclosure, the number of first color component blocks may be any number, that is, the first color component block of the current block is not limited to one block here, and may be composed of a plurality of blocks. Accordingly, when determining whether or not to perform prediction based on a BV, such determination is required to be performed for each first color component block, and only the first color component block satisfying the prediction based on a BV can be used to subsequently determine the first BV parameter of the current block.

Further, in the embodiments of the present disclosure, if the first color component block does not perform prediction based on a BV, that is, the first color component block is not processed in a mode with BV information, first syntax element identification information may be not analyzed. The first syntax element identification information is used to indicate whether the second color component of the current block uses the target prediction mode.

In a specific implementation, when the first BV parameter of the current block is determined based on a second BV parameter of the first color component block, the second BV parameter of the first color component block may be directly used as the first BV parameter of the current block.

In another specific implementation, when the first BV parameter of the current block is determined based on the second BV parameter of the first color component block, a BV parameter candidate list of the second color component of the current block may be constructed based on the second BV parameter. Based on the BV parameter candidate list, the first BV parameter of the current block is determined.

That is, in the embodiments of the present disclosure, the second BV parameter of the first color component block may be directly used as the first BV parameter of the current block, or the second BV parameter may be used to construct a BV parameter candidate list of the second color component first, and then the first BV parameter of the current block may be determined based on the BV parameter candidate list.

In some embodiments, the action of constructing a BV parameter candidate list of the second color component of the current block based on the second BV parameter may include: adjusting the second BV parameter to determine a candidate BV parameter of the second color component of the current block; and adding the candidate BV parameter to the BV parameter candidate list.

That is, in the embodiments of the present disclosure, the second BV parameter of the first color component block may be directly used as the first BV parameter of the current block; alternatively, the second BV parameter of the first color component block may be adjusted to determine a candidate BV parameter of the second color component, and then the candidate BV parameter may be used as the first BV parameter of the current block; alternatively, a BV parameter candidate list of the second color component may be constructed based on the candidate BV parameter, and then the first BV parameter of the current block may be determined based on the BV parameter candidate list.

Assuming that the current block is a chroma block and the first color component block is a luma block, then the first BV parameter may be a BV of the chroma block, i.e., a BVC, and the second BV parameter may be a BV of a luma block, that is, a BVL.

It can be understood that, in the embodiments of the present disclosure, assuming that the second BV parameter is luma BV=(BVLhor, BVLver) and the first BV parameter is chroma BV=(BVChor, BVCver), then a BVC candidate list including one or more candidate BV parameters may be constructed by adjusting BVL or BVC.

Further, in some embodiments, the action of adjusting the second BV parameter to determine a candidate BV parameter of the second color component of the current block may include: determining a preset sampling format of the current block; and scaling the second BV parameter according to the preset sampling format to determine the candidate BV parameter of the second color component of the current block.

Note that, in the embodiments of the present disclosure, the above adjustment may include performing scaling according to a preset sampling format. The preset sampling format may be a mapping relationship between a luma BV parameter and a scaled chroma BV parameter as shown in Table 8.

Here, the syntax element sps_chroma_format_idc is used to indicate the type of a color sampling format, and the color sampling format here is a chroma sampling format. Here, the types of color sampling formats are different, and the corresponding scaling operations are also different.

For example, when the value of sps_chroma_format_idc is 0, it is determined that the color sampling format is monochrome, that is, there is no chroma BV parameter (BVCₕₒᵣ, BVCₕₒᵣ); when the value of sps_chroma_format_idc is 1, the color sampling format is determined to be 4:2:0, and in this case, the mapping relationship between a luma BV parameter and a chroma BV parameter is: BVCₕₒᵣ=BVLₕₒᵣ>>1, BVCₕₒᵣ=BVLᵥₑᵣ>>1; when the value of sps_chroma_format_idc is 2, the color sampling format is determined to be 4:2:2, and in this case, the mapping relationship between a luma BV parameter and a chroma BV parameter is: BVCₕₒᵣ=BVLₕₒᵣ>>1, BVCₕₒᵣ=BVLᵥₑᵣ; when the value of sps_chroma_format_idc is 3, it means that the color sampling format is 4:4:4, and in this case, the mapping relationship between a luma BV parameter and a chroma BV parameter is: BVCₕₒᵣ=BVLₕₒᵣ, BVCₕₒᵣ=BVLᵥₑᵣ.

Thus, based on Table 8, scaling may be performed according to the color sampling format, and the scaled BVC as a candidate BV parameter may be added to the BVC candidate list (i.e., the BV parameter candidate list).

Further, in some embodiments, the action of adjusting the second BV parameter to determine a candidate BV parameter of the second color component of the current block may include: determining a preset sampling format of the current block; scaling the second BV parameter according to the preset sampling format to determine a first initial BV parameter of the second color component of the current block; performing an offset calculation on the first initial BV parameter based on one or more offset values to determine the candidate BV parameter of the second color component of the current block.

Further, in some embodiments, the action of adjusting the second BV parameter to determine a candidate BV parameter of the second color component of the current block may include: performing an offset calculation on the second BV parameter based on one or more offset values to determine one or more second initial BV parameters; determining a preset sampling format of the current block, and scaling one or more second initial BV parameters according to the preset sampling format to determine the candidate BV parameter of the second color component of the current block.

It should be noted that, in the embodiments of the present disclosure, the one or more offset values described above may be any number of arbitrary numerical values, such as −1, +1, −2, +2, −3, +3, etc., and are not limited herein.

That is, in the embodiments of the present disclosure, after the BV of the corresponding luma block is acquired, the BV may be denoted as BVL, the chroma BV acquired by the BVL may be denoted as BVC, and then BVC candidates including one or more candidates may be constructed by adjusting the BVL or the BVC. That is, based on Table 8, scaling may be performed according to the color sampling format, and the scaled BVL or BVC as the candidate BV parameter may be added to the BVC candidate list.

For example, in the embodiments of the present disclosure, the BVL may be adjusted to form four cases to further adjust the BVC. When BVL is an odd number, four cases are taken: BVL=(BVLhor, BVLver), BVL=(BVLhor+1, BVLver), BVL=(BVLhor, BVLver+1), and BVL=(BVLhor+1, BVLver+1). When BVL is even, BVL=(BVLhor, BVLver) is taken. Then, using Table 8, the BVL may be scaled according to the color sampling format to obtain a BVC, so that when the BVL is odd, four types of BVC candidate BV parameters may be formed, and these candidate BV parameters may be added to the BVC candidate list.

For example, in the embodiments of the present disclosure, the BVL may be be adjusted to form four cases to further adjust the BVC. When the BVL is an odd number, four cases are taken: BVL=(BVLhor, BVLver), BVL=(BVLhor+1, BVLver), BVL=(BVLhor, BVLver+1), and BVL=(BVLhor+1, BVLver+1). When BVL is even, four cases are taken: BVL=(BVLhor, BVLver), BVL=(BVLhor−1, BVLver), BVL=(BVLhor, BVLver−1), and BVL=(BVLhor−1, BVLver−1). Then, using Table 8, the BVL may be scaled according to the color sampling format to obtain the BVC, so that when the BVL is odd or even, four BVC candidates may be formed, and these candidates may be added to the BVC candidate list.

For example, in the embodiments of the present disclosure, the operations in the odd and even situations may be unified by calculation as follows: directly taking four cases of BVL=(BVLhor−1, BVLver−1), BVL=(BVLhor+1, BVLver−1), BVL=(BVLho−1r, BVLver+1), and BVL=(BVLhor+1, BVLver+1).

For example, in the embodiments of the present disclosure, the BVL may be adjusted to form a variety of situations to further realize adjustment of the BVC. When BVL is odd, BVL=(BVLhor, BVLver), BVL=(BVLhor+1, BVLver), BVL=(BVLhor, BVLver+1), BVL=(BVLhor+1, BVLver+1), BVL=(BVLhor+3, BVLver), BVL=(BVLhor, BVLver+3), BVL=(BVLhor+3, BVLver+3), BVL=(BVLhor−2, BVLver), BVL=(BVLhor, BVLver−2) and other cases are taken, and a list is constructed for these candidates in order. When BVL is even, take BVL=(BVLhor, BVLver), BVL=(BVLhor−1, BVLver), BVL=(BVLhor, BVLver−1), BVL=(BVLhor−1, BVLver−1), BVL=(BVLhor−3, BVLver), BVL=(BVLhor, BVLver−3), BVL=(BVLhor−3, BVLver−3), BVL=(BVLhor+2, BVLver), BVL=(BVLhor, BVLver+2) and similar cases are taken. Then, using Table 8, the BVL may be scaled according to the color sampling format to obtain the BVC, so that when the BVL is odd or even, a plurality of BVC candidates may be formed, and these candidates may be added to the BVC candidate list.

Exemplarily, in the embodiments of the present disclosure, the operations in situations of odd and even may be unified by calculation as follows: directly taking BVL=(BVLhor−1, BVLver−1), BVL=(BVLhor+1, BVLver−1), BVL=(BVLhor−1, BVLver+1), BVL=(BVLhor+1, BVLver+1), BVL=(BVLhor+3, BVLver−1), BVL=(BVLhor−1, BVLver+3), BVL=(BVLhor+3, BVLver+3), BVL=(BVLhor−3, BVLver −1), BVL=(BVLhor−1, BVLver−3), and the like.

Exemplarily, in the embodiments of the present disclosure, the obtained BVC may be adjusted to obtain nine types of candidates, namely, setting BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), BVC=(BVChor+1, BVCver−1), to form nine types of BVC candidates which are then added to the BVC candidate list.

Exemplarily, in the embodiments of the present disclosure, the obtained BVC may be adjusted to obtain multiple types of candidates, that is, setting BVC=(BVChor, BVCver), BVC=(BVChor−1, BVCver), BVC=(BVChor, BVCver−1), BVC=(BVChor−1, BVCver−1), BVC=(BVChor+1, BVCver), BVC=(BVChor, BVCver+1), BVC=(BVChor+1, BVCver+1), BVC=(BVChor−1, BVCver+1), BVC=(BVChor+1, BVCver−1), BVC=(BVChor−2, BVCver), BVC=(BVChor, BVCver−2), BVC=(BVChor−2, BVCver−2), BVC=(BVChor+2, BVCver), BVC=(BVChor, BVCver+2), BVC=(BVChor+2, BVCver+2), BVC=(BVChor−2, BVCver+2), BVC=(BVChor+2, BVCver−2) etc., to form multiple types of BVC candidates, and adding the BVC candidates to the BVC candidate list.

It should be noted that, in the embodiments of the present disclosure, in the case where the BVL is an odd or even number, since the BVL is a two-dimensional vector, the case means that a component of the BVL is an odd or even number. Here, “+1”, “−1”, “+2”, “−2”, “+3′”, and “−3” all refer to the integer pixel precision.

Further, in some embodiments, when determining the BV parameter candidate list of the second color component of the current block based on the second BV parameter of the first color component block, a best BV parameter may be determined based on the second BV parameter first. The best BV parameter may be scaled according to the preset sampling format to determine the candidate BV parameter of the second color component. The BV parameter candidate list may be determined based on the candidate BV parameter.

For example, in the embodiments of the disclosure, in the IBC mode under single-tree inter-prediction and single-tree partition, a luma BV is denoted as BVL, the best BVL (i.e., best BV parameter) is determined by RDO, and then the best BV parameter is scaled according to a preset sampling format to obtain a chroma BV, denoted as BVC. Here, the processing of scaling the best BV parameter may be performed using the above table 8, or the best BV parameter may be adjusted in combination with any one of the above adjustment or scaling methods to obtain a corresponding candidate BV parameter, thereby completing the construction of the BV parameter candidate list.

Further, in some embodiments, when determining the BV parameter candidate list of the second color component of the current block based on the second BV parameter of the first color component block, the best BV parameter corresponding to the first color component block may be determined, and then the BV parameter candidate list of the second color component of the current block may be determined based on the best BV parameter.

For example, in the embodiments of the disclosure, the best BV parameter corresponding to the luma block may be found through the template and denoted as BVL; then, the BV parameter candidate list may be constructed based on the best BV parameter by using a construction method combined with any one of the above lists.

It is also understood that in the embodiments of the present disclosure, when determining the first BV parameter of the current block based on the BV parameter candidate list, it is also required to determine whether the candidate BV parameter is available, that is, it is required to select one or more available candidate BV parameters from the BV parameter candidate list. Thus, in some embodiments, the action of determining the first BV parameter of the current block based on the BV parameter candidate list may include:
determining whether one or more candidate BV parameters satisfying the first available condition exist in the BV parameter candidate list; and in response to there being one or more candidate BV parameters satisfying the first available condition in the BV parameter candidate list, determining the first BV parameter of the current block based on the one or more candidate BV parameters.

Specifically, in the embodiments of the present disclosure, only when the candidate BV parameter satisfies the first available condition, the candidate BV parameter may be determined as the first BV parameter of the current block.

In some embodiments, the case of one or more candidate BV parameters satisfying the first available condition includes but is not limited to:
an offset position indicated based on the one or more candidate BV parameters does not exceed a picture boundary;
an offset position indicated based on the one or more candidate BV parameters does not exceed a slice boundary;
an offset position indicated based on the one or more candidate BV parameters does not cover the current block;
an offset position indicated based on the one or more candidate BV parameters does not exceed a preset available region; and
an offset position indicated based on the one or more candidate BV parameters has been reconstructed.

Note that, in the embodiments of the present disclosure, assuming the position of the current block is (xCb, yCb), BVC=(BVChor, BVCver), for each candidate BV parameter BVC=(BVChor, BVCver), the corresponding offset position (xCb+BVChor, yCb+BVCver) is found. Here, the offset position not exceeding the picture boundary may be described using data such as coordinate position information and size parameters of the current block, for example, xCb+width+BVChor<=xCb or yCb+height+BVCver<=yCb.

It should also be noted that in the embodiments of the present disclosure, whether or not the slice boundary is exceeded is also taken into account for the first available condition. For example, the offset position indicated based on the one or more candidate BV parameters does not exceed the slice boundary, or the offset position indicated based on the one or more candidate BV parameters does not exceed the tile boundary.

It should be understood that in the embodiments of the present disclosure, only when all of the above-described conditions are satisfied, it can be determined that the candidate BV parameter satisfies the first available condition, that is, the candidate BV parameter is available. In a specific embodiment, taking one of the candidate BV parameters as an example, the candidate BV parameter satisfies the first available condition, including at least: the offset position indicated based on the candidate BV parameter does not exceed the picture boundary; and the offset position indicated based on the candidate BV parameter does not exceed the slice boundary; and the offset position indicated based on the candidate BV parameter does not cover the current block; and the offset position indicated based on the candidate BV parameter does not exceed the preset available region; and the offset position indicated from the candidate BV parameter has been reconstructed.

Further, in some embodiments, when constructing the BV parameter candidate list, the method may further include: adjusting at least one candidate BV parameter in the BV parameter candidate list until at least one candidate BV parameter satisfies the first available condition, in response to all candidate BVs in the BV parameter candidate list not satisfying the first available condition.

In the embodiments of the present disclosure, in response to all candidate BVs in the BV parameter candidate list not satisfying the first available condition, the predicted value of the second color component of the current block may be determined according to other modes. The other modes include at least one of: a PLANAR mode, a DM mode, a DC mode, a CCLM mode, or a skip mode.

In the embodiments of the present disclosure, the candidate BV parameter of the second color component may be determined based on the second BV parameter of the first color component block. If the candidate BV parameter satisfies the first available condition, correction processing may be performed on the candidate BV parameter, and the BV parameter candidate list may be determined based on the corrected candidate BV parameter. Accordingly, if the candidate BV parameter does not satisfy the first available condition, adjustment processing may be performed on the candidate BV parameter until the adjusted candidate BV parameter satisfies the first available condition.

Note that, in the embodiments of the present disclosure, when the candidate BV parameter is corrected, the offset position of the current block may be determined based on the candidate BV parameter and the position information of the current block. Then, search processing may be performed based on the offset position of the current block, to determine the corrected candidate BV parameter.

It should also be understood that in the embodiments of the present disclosure, after the second BV parameter of the first color component block is scaled according to the preset sampling format, the obtained candidate BV parameter needs to be further corrected. Before the correction processing, it is further required to determine whether the candidate BV parameter satisfies the first available condition. When the candidate BV parameter satisfies the first available condition, the correction processing is performed on the candidate BV parameter of the current block, thereby determining the corrected parameter as the first BV parameter of the current block. Alternatively, when the candidate BV parameter does not satisfy the first available condition, the adjustment processing is performed on the candidate BV parameter until the adjusted BV parameter satisfies the first available condition, and then the adjusted BV parameter is corrected, so that the corrected parameter is determined as the first BV parameter of the current block.

That is, in the embodiments of the present disclosure, the chroma BV may be corrected, and the corrected BVC may be added to the BVC candidate list, and only the corrected BVC may be included in the BVC candidate list in this case.

Exemplarily, after obtaining the chroma BV scaled according to the preset sampling format, the scaled chroma BV is further corrected. Before correction, it is required to determine whether the BV is available; the BV is correct if available; otherwise, if not available, the BV is adjusted to be available and is then corrected. The corrected BVC is added to the BVC candidate list.

When determining whether it is available, the position (xCb, yCb) of the current block may be obtained, the BVC=(BVChor, BVCver) may be obtained, the corresponding offset position (xCb+BVChor, yCb+BVCver) may be found, and the following conditions (i.e., the first available condition) may be judged, and if all of them are true, the BVC is determined to be available;
whether the obtained offset position does not exceed the picture boundary;
whether the obtained offset position does not cover the current block, see FIG. 10 for details;
whether the obtained offset position does not exceed the preset available region, see FIG. 11 for details; and
whether the obtained offset position has been reconstructed.

For example, in the embodiments of the present disclosure, template search may be used for correction, that is, after obtaining the corrected chroma BV parameter, the offset position is found by using the position of the current block and the corrected chroma BV parameter, and then a template matching method is used to perform fine search in the vicinity of the offset position to obtain the best chroma BV parameter, and the reference block at the best offset position obtained after the fine search is copied, that is, the chroma prediction block of the current block is obtained. As shown in FIG. 12, the region filled with diagonal lines represents the chroma reconstructed region. For the current block, the best matching template and the corresponding best BV may be found by template matching, and the reference block of the current block may be determined based on the best BV (that is, IntraTMP BV), and then the chroma predicted value of the current block can be determined.

Since whether the BV is available or not has been determined before correction, it is possible to directly determine the second BV parameter instead of determining whether the BV is available or not (i.e., whether the first availability condition is met).

Further, in the embodiments of the present disclosure, before constructing the BV parameter candidate list, the second BV parameter of the first color component block may be corrected, and the BV parameter candidate list may be determined based on the corrected first BV parameter. For example, the BVL is corrected, and then the BVC candidate list is constructed using any of the above-described list construction schemes.

Exemplarily, in the embodiments of the present disclosure, the co-located luma region corresponding to the current block may be acquired first. Here, as shown in FIG. 13 which is a schematic diagram of positions of a current chroma block and a corresponding co-located luma region, the position chromaPos=(xCb, yCb) of the current block is obtained, and the chromaPos is scaled according to the color sampling format based on the above table 4 to obtain lumaPos=(xCb_Y, yCb_Y) which is the position of the co-located luma region corresponding to the current block. The size parameter chromaSize=(cbWidth, cbHeight) of the current block is obtained, and the chromaSize is scaled based on the color sampling format based on the mapping relationship as shown in Table 9 to obtain lumaSize=(cbWidth_Y, cbHeight_Y) which is the size of the co-located luma region corresponding to the current block.

For example, the BVL may be further corrected, and before the correction, it is required to first determine whether the BVL is available (i.e., whether the second availability condition is satisfied); if available, the BVL is corrected; otherwise, if not available, the BVL is adjusted to be available and then is corrected.

In some embodiments, when determining whether the BVL is available, the position (xCb_Y, yCb_Y) of the co-located luma region is obtained, BVL=(BVLhor, BVLver) is obtained, and the corresponding offset position (xCb_Y+BVLhor, yCb_Y+BVLver) is found, as shown in FIG. 14. The BVL (i.e., the first BV parameter) is available if the following conditions, including but not limited to the followings, are all satisfied:
the offset position indicated based on the first BV parameter does not exceed the picture boundary;
the offset position indicated based on the first BV parameter does not exceed the slice boundary;
the offset position indicated based on the first BV parameter does not exceed the preset available region, as shown in FIG. 11; and
the offset position indicated based on the first BV parameter has been reconstructed.

Further, in the embodiments of the present disclosure, when the correction processing is performed, the offset position of the first color component block may be determined based on the second BV parameter of the first color component block and the position information of the first color component block; and search processing may be performed based on the offset position of the first color component block to determine a corrected second BV parameter.

Exemplarily, the correction processing includes, but is not limited to, the following manners: performing correction by searching the co-located luma region corresponding to the current block, that is, after obtaining the BVL, finding an offset position based on the position of the co-located luma region and the obtained BVL, and performing a fine search in the vicinity of the offset position based on the co-located luma region to finally obtain the best BVL, the range of the fine search needing to meet a limited available region (as shown in FIG. 11).

It can be understood that in the embodiments of the present disclosure, the construction method of the BV parameter candidate list includes, but is not limited to, a variety of cases as described above, and different methods can be used together to construct one candidate list.

Further, in some embodiments, the action of determining the first BV parameter of the current block based on one or more candidate BV parameters may include: in response to there being one candidate BV parameter that satisfies the first available condition in the BV parameter candidate list, determining the one candidate BV parameter satisfying the first available condition as the first BV parameter; and in response to there being a plurality of candidate BV parameters that satisfies the first available condition in the BV parameter candidate list, making a decision on the plurality of candidate BV parameters satisfying the first available condition to determine the first BV parameter.

It should be noted that, in the embodiments of the present disclosure, if there is one or more candidate BV parameters satisfying the first available condition, when determining the first BV parameter based on the one or more candidate BV parameters, a certain candidate BV parameter satisfying the first available condition may be directly determined as the first BV parameter. That is, if only one BVC candidate in the constructed available BVC candidate list satisfies the first available condition, then the final selected BV (i.e., the first BV parameter) is the BVC.

It should also be noted that, in the embodiments of the present disclosure, if there is one or more candidate BV parameters satisfying the first available condition, when determining the first BV parameter based on the one or more candidate BV parameters, a decision may be made on the plurality of candidate BV parameters satisfying the first available condition. Specifically, it may be: determining a first template of the current block; determining a first matching template of each of the plurality of candidate BV parameters based on the first template and the plurality of candidate BV parameters; when the first template and the first matching template satisfy the second condition, calculating a matching error between the first template and the first matching template of the current block according to a preset error criterion to determine a first cost value for each of the plurality of candidate BV parameters; determining a minimum cost value from the first cost values of the plurality of candidate BV parameters, and determining a candidate BV parameter corresponding to the minimum cost value as the first BV parameter.

That is, in the embodiments of the present disclosure, for the plurality of candidate BV parameters satisfying the first available condition, after the first cost values corresponding to the plurality of candidate BV parameters are determined, one or more second BV parameters may be determined from the plurality of candidate BV parameters based on the first cost values. For example, if a list of available BVC candidates is constructed with multiple available BVC candidates, then a decision needs to be made on these available BVCs to obtain the final BV. The decision manner includes, but not limited to, decision manner using a template.

It can be understood that in the embodiments of the present disclosure, the first template includes one or more sample values in an adjacent coded region of the current block. Accordingly, the type of the first template may include at least one of: an upper template, an upper right template, a left template, a lower left template, or an upper left template. The upper template is located in a decoded region adjacent to and above the current block, the upper right template is located in a decoded region adjacent to and upper-right of the current block, the left template is located in a decoded region adjacent to and to left of the current block, the lower left template is located in a decoded region adjacent to and lower-left of the current block, and the upper left template is located in a decoded region adjacent to and upper-left of the current block.

That is, in the embodiments of the present disclosure, when the template (i.e., the first template of the current block) is selected, whether or not the pixels at the template position are available, including the reconstructed chroma information, may be determined based on the pixel availability of the adjacent region of the current block. FIG. 15 is a schematic diagram of template types. As shown in FIG. 15, templates may be classified into an upper template, a left template, an upper right template, a lower left template, and an upper left template according to the relative positional relationship between the templates and the current block. The sizes of different types of templates of different coding blocks may be fixed the same or may be different.

For example, a same template size is selected for a current block of any size, and the following formula illustrates a setting condition for a template size, where nTbW and nTbH are the width and height of the current block, and iTempW and iTempH are the width and height of an adopted template, respectively:

$$Upper template : \{ \begin{matrix}iTempW = nTbW \\ iTempH = 1\end{matrix} \qquad ( 10 )$$

$$Left template : \{ \begin{matrix}iTempW = 1 \\ iTempH = nTbH\end{matrix} \qquad ( 11 )$$

For example, different template sizes may be selected based on different sizes of the current block. The following formula explains a size setting condition for a template, where nTbW and nTbH are the width and height of the current block, and iTempW and iTempH are the width and height of an adopted template.

$$Upper template : \{ \begin{matrix}\{ \begin{matrix}iTempW = nTbW \\ iTempH = 2\end{matrix} , min ( nTbW , nTbH ) \leq 4 \\ \{ \begin{matrix}iTempW = nTbW \\ iTempH = 4\end{matrix} , min ( nTbW , nTbH ) > 4\end{matrix} \qquad ( 12 )$$

$$Left template : \{ \begin{matrix}\{ \begin{matrix}iTempW = 2 \\ iTempH = nTbH\end{matrix} , min ( nTbW , nTbH ) \leq 4 \\ \{ \begin{matrix}iTempW = 4 \\ iTempH = nTbH\end{matrix} , min ( nTbW , nTbH ) > 4\end{matrix} \qquad ( 13 )$$

$$wherein , Min ( x , y ) = \{ \begin{matrix}x , x \leq y \\ y , x > y\end{matrix} .$$

For example, different template sizes may be selected based on the number of pixels in the current block, and a size setting conditions for a template is described by the following formula, in which nTbW and nTbH are the width and height of the current block, nTbW×nTbH is the number of pixels of the current block, and iTempW and iTempH are the width and height of an adopted template:

$$Upper template : \{ \begin{matrix}\{ \begin{matrix}iTempW = nTbW \\ iTempH = 2\end{matrix} , nTbW \times nTbH \leq 16 \\ \{ \begin{matrix}iTempW = nTbW \\ iTempH = 4\end{matrix} , nTbW \times nTbH > 16\end{matrix} \qquad ( 14 )$$

$$Left template : \{ \begin{matrix}\{ \begin{matrix}iTempW = 2 \\ iTempH = nTbH\end{matrix} , nTbW \times nTbH \leq 16 \\ \{ \begin{matrix}iTempW = 4 \\ iTempH = nTbH\end{matrix} , nTbW \times nTbH > 16\end{matrix} \qquad ( 15 )$$

In some embodiments, when determining the first matching template from the plurality of candidate BV parameters, a region indicated by the plurality of candidate BV parameters, having the same shape and containing the same number of sample values as the first template, may be determined as the first matching template by taking the position of the current point as a starting point.

For example, in the embodiments of the present disclosure, when determining the first matching template, motion compensation is performed on the obtained plurality of BVC candidates (that is, candidate BV parameters satisfying the first available condition) using the first template of the current block to obtain a template (i.e., the first matching template) at the corresponding BV. As shown in FIG. 16, if a BV (BVC candidate) is available, motion compensation may be performed using the first template and the BV to obtain a template at the corresponding BV, that is, the first matching template.

It is also understood that in the embodiments of the present disclosure, the preset error criterion may include, but is not limited to, any one of: sum of absolute differences (SAD), sum of absolute transformed differences (SATD), sum of squared errors (SSE), mean absolute difference (MAD), mean absolute error (MAE), mean square error (MSE), and the like.

For example, in the embodiments of the present disclosure, when performing a cost calculation, that is, when determining the first cost value, there are a plurality of optional cost functions for calculating the cost of the template region, that is, there are a plurality of optional preset error criteria. For example, such evaluation criteria as sum of absolute differences (SAD), sum of absolute transformed differences (SATD), sum of squared errors (SSE), mean absolute difference (MAD), mean absolute error (MAE), and mean square error (MSE) may be selected. One of the evaluation criteria mentioned below may be selected from the above criteria. Taking the evaluation criterion SAD as an example, the calculation formula is as follows:

$$SAD = {\sum }_{i = 0}^{p r e d T e m p S i z e W - 1} {\sum }_{j = 0}^{p r e d T e m p S i z e H - 1} \vert predTemp [ i ] [ j ] - recTempC [ i ] [ j ] \vert \qquad ( 16 )$$

where predTempSizeW is the width of the template, predTempSizeH is the height of the template, predTemp[i][j] is the pixel of the template at BV, and recTempC[i][j] is the pixel of the template of the current block.

Further, in some embodiments, the method may further include: when the first template and the first matching template do not satisfy the second condition, determining a first candidate BV parameter that satisfies the first available condition in the BV parameter candidate list as the first BV parameter; or,
when the first template and the first matching template do not satisfy the second condition, determining a candidate BV parameter that satisfies the first available condition at a preset position in the BV parameter candidate list as the first BV parameter.

That is, if the first template and the first matching template satisfy the second condition, the matching error between the first template and the first matching template of the current block may be calculated according to the preset error criterion, and the candidate BV parameter corresponding to the minimum cost value can be selected as the first BV parameter. If the first template and the first matching template do not satisfy the second condition, the candidate BV parameter at a specific position of the first candidate BV parameter satisfying the first available condition in the BV parameter candidate list may be used as the first BV parameter.

Exemplarily, for whether the first template and the first matching template satisfy the second condition, the template usage for calculating the cost (that is, the cost value) has the following situations:
Type 1: both the upper template and the left template of the current block exist, and both the upper template and the left template at the corresponding BV exist, in which case, both the upper template and the left template are available;
Type 2: both the upper template and the left template of the current block exist, and only the upper template exists at the corresponding BV, in which case, there are two ways: way 1: no left template exists at the corresponding BV and no left template is used, that is, only the upper template is used for calculation; and way 2: no left template not exists at the corresponding BV, and the leftmost template width column inside the reference block is used to replace the left template, that is, the upper template and the left template are used for calculation;
Type 3: both the upper template and the left template of the current block exist, and only the left template exists at the corresponding BV, in which case, there are two ways: way 1: no upper template exists at the corresponding BV and no upper template is used, that is, only the left template is used for calculation; and way 2: no upper template exists at the corresponding BV, and the uppermost template height row inside the reference block is used instead of the upper template, that is, the upper template and the left template are used for calculation;
Type 4: only the upper template exists in the current block, in which case, there are three ways: way 1: no upper template exists at the corresponding BV and no upper template is used, in this way, the final selected BV is the first BVC in the BVC candidate list or the BVC at a specified position; way 2: no upper template exists at the corresponding BV, and the uppermost template height row inside the reference block is used instead of the upper template; and way 3: an upper template exists at the corresponding BV, so it is used directly;
Type 5: only the left template exists in the current block, in which case, there are three ways: way 1: no left template exists at the corresponding BV and no left template is used, in this way, the final selected BV is the first BVC in the BVC candidate list or a BVC at a specified position; way 2: no left template exists at the corresponding BV, and the leftmost template width column inside the reference block is used instead of the left template; and way 3: a left template exists at the corresponding BV, so it is used directly; and
Type 6: neither the upper template nor the left template exists in the current block, and in this case, the final selected BV is the first BVC in the BVC candidate list or a BVC at a specified position.

For example, in the embodiments of the present disclosure, when the first BV parameter is determined based on the first cost value of each of the plurality of candidate BV parameters, except for the case where the cost cannot be calculated, the cost of each candidate in the BVC candidate list is calculated and sorted, and the sorting method includes but is not limited to bubble sorting, selection sorting, insertion sorting, Hill sorting, merge sorting, quick sorting, radix sorting, heap sorting, count sorting, and bucket sorting. Any number of BVCs with the lowest cost is selected as the final BV (i.e., the first BV parameter), to perform chroma prediction based on BV. It should also be noted that when calculating the cost values of the plurality of candidate BV parameters, a cost may be calculated for each candidate BV parameter, and the candidate BV parameter with the lowest cost may always be reserved. In this case, it is not required to list or even sort them.

Further, in the embodiments of the present disclosure, if all candidate BV parameters in the BV parameter candidate list do not satisfy the first available condition, the candidate BV parameters in the BV parameter candidate list may be adjusted until one or more candidate BV parameters satisfying the first available condition appears in the BV parameter candidate list.

That is, in the embodiments of the present disclosure, if all candidate BV parameters in the BV parameter candidate list are not available, that is, all candidate BV parameters in the BV parameter candidate list do not satisfy the first availability condition, any one or more BVC candidates (i.e., candidate BV parameters) in the BV parameter candidate list may be selected and adjusted until they are available. The adjustment methods include, but are not limited to, cropping, scaling, and the like. Prediction may also be performed using a PLANAR mode, a CCLM-like mode, or an angular prediction mode, or the like, that is, other modes may be selected as a basis for determining a predicted value of the second color component of the current block determined. For example, if a PLANAR mode or a CCLM-like mode or an angle prediction mode is selected, reference pixels and mode parameters may be acquired for chroma prediction.

S2002 includes: a first color-component reference sample and a second color-component reference sample corresponding to the current block are determined based on the first BV parameter, and a mapping relationship between a first color component and a second color component is established based on the first color-component reference sample and the second color-component reference sample.

Note that, in the embodiments of the present disclosure, after the first BV parameter is determined, the luma reference sample and the chroma reference sample at the first BV parameter may be acquired. In some embodiments, the action of determining the first color-component reference sample and the second color-component reference sample corresponding to the current block based on the first BV parameter may include:
determining a position of the current block; scaling the position of the current block to determine a position of the first color component region at the same position as the current block; scaling the first BV parameter to determine a third BV parameter of the first color component region at the same position as the current block; determining a reference block of the first color component based on the position of the first color component region and the third BV parameter, and determining the first color-component reference sample corresponding to the current block based on the reference block of the first color component; and determining a reference block of the second color component, based on the position of the current block and the first BV parameter, and determining the second color-component reference sample corresponding to the current block based on the reference block of the second color component.

In the embodiments of the present disclosure, the position of the first color component region may be obtained by scaling the position of the current block according to a preset sampling format. The third BV parameter of the first color component region may be obtained by scaling the first BV parameter according to a preset sampling format. Here, the preset sampling format can be shown in Table 4. It should be noted that the third BV parameter may be obtained by amplifying the chroma BV (i.e., the first BV parameter); However, considering that there may be loss of precision in the luma BV, the luma BV amplified by the chroma BV may be not equal to the original luma BV (i.e., the second BV parameter).

For example, the current block is a chroma block, and the first color component region at the same position is a co-located luma region. For obtaining the first color-component reference sample (i.e., a luma reference sample), it is first to obtain the position of the current block, that is, chromaPos=(x, y) which is the position of the upper-left-corner chroma sample of the current block relative to the upper-left-corner chroma sample of the current picture; and the chromaPos is scaled according to the color sampling format shown in Table 4 to obtain lumaPos=(xCb, yCb) which is the position of the the co-located luma region corresponding to the current block.

For example, the chroma BV=(BVChor, BVCver) is obtained, and the chroma BV is scaled according to the color sampling format shown in Table 4 to obtain the luma BV=(BVYhor, BVYver) of the co-located luma region corresponding to the current block. As shown in FIG. 17, the position lumaPos=(xCb, yCb) of the co-located luma region corresponding to the current block is obtained, the luma BV=(BVYhor, BVYver) is obtained, and the offset position (xCb+BVYhor, yCb+BVYver) of the co-located luma region corresponding to the current block is found.

In a specific implementation, after the luma sample at the offset position is obtained, the luma sample may be downsampled to obtain a luma reference sample. In some embodiments, the action of determining the first color-component reference sample corresponding to the current block based on the reference block of the first color component may include: performing down-sampling processing on the reference block of the first color component to determine the first color-component reference sample corresponding to the current block to make the resolution of the first color-component reference sample the same as that of the second color-component reference sample.

Note that, in the embodiments of the present disclosure, since the resolutions of the luma sample and the chroma sample are inconsistent, it is required to perform downsampling processing on the luma sample to make the resolution of the down-sampled luma sample as same as that of the chroma sample. FIG. 18 shows a schematic diagram of a downsampling position.

It should also be noted that, in the embodiments of the present disclosure, the following sampling manners may compete or a certain sampling manner thereof may be adopted by default, but the present disclosure is not limited to the following six sampling manners. For example, assuming that a luma sample before downsampling is recBvBefDownLuma, the width of buffer is iRecRefLumaStride, and a luma sample after downsampling is recBvAftDownLuma, then the luma sample after downsampling at position (i, j) is:
(1) downsampling method 1:

$$recBvAftDownLuma [ i ] [ j ] = ( recBvBefDownLuma [ 2 * i ] * 2 + recBvBefDownLuma [ 2 * i + 1 ] + recBvBefDownLu ma [ 2 * i - 1 ] + recBvBefDow nLuma [ 2 * i + i RecRefLumaStride ] * 2 + recBvBefDownLu ma [ 2 * i + 1 + i RecRefLumaStride ] + recBvBefDownLu ma [ 2 * i - 1 + i RecRefLumaStride ] + 4 ) >> 3 ;$$

(2) downsampling method 2:

$$recBvAftDownLuma [ i ] [ j ] = ( r e cBvBefDownLuma [ 2 * i ] + recBvBefDownLu ma [ 2 * i + 1 ] + 1 ) >> 1 ;$$

(3) downsampling method three:

$$recBvAftDownLuma [ i ] [ j ] = ( r e cBvBefDownLuma [ 2 * i ] + recBvBefDownLu ma [ 2 * i + i RecRefLumaStride ] + 1 ) >> 1 ;$$

(4) downsampling method 4:

$$recBvAftDownLuma [ i ] [ j ] = ( r e c B v B e f D o w n L u ma [ 2 * i + i R e c R e f L u m a S t r i de ] + recBvBefDownLu ma [ 2 * i + 1 + i R e c R e f L u m a S t r i d e ] + 1 ) >> 1 ;$$

(5) downsampling method 5:

$$recBvAftDownLuma [ i ] [ j ] = ( r e c B v B e f D o w n L u ma [ 2 * i + 1 ] + recBvBefDownLu ma [ 2 * i + 1 + i R e c R e f L u m a S t r i d e ] + 1 ) >> 1 ;$$

(6) downsampling method 6:

$$recBvAftDownLuma [ i ] [ j ] = ( r e c B v B e f D o w n L u ma [ 2 * i ] + recBvBefDownLu ma [ 2 * i + 1 ] + recBvBefDownLu ma [ 2 * i + i R e c R e f L u m a S t r i de ] + recBvBefDownLu ma [ 2 * i + 1 + i R e c R e f L u m a S t r i d e ] + 2 ) >> 2.$$

In this way, after downsampling, the downsampled luma reference sample recBvAftDownLuma at the BV corresponding to the co-located luma region corresponding to the current block is acquired.

Further, for the chroma sample of the current block, first, the position (xCbC, yCbC) of the current block is obtained, chroma BV=(BVChor, BVCver) is obtained, and the corresponding offset position (xCbC+BVChor, yCbC+BVCver) is found, that is, the chroma reference sample recBvChroma at the corresponding BV of the current block is obtained.

In this way, a mapping relationship between luma and chroma can be constructed based on the luma reference sample recBvAftDownLuma and the chroma reference sample recBvChroma.

In some embodiments, the action of establishing a mapping relationship between a first color component and a second color component based on the first color-component reference sample and the second color-component reference sample may include: determining a first look-up table based on the first color-component reference sample and the second color-component reference sample, wherein the first look-up table is used for recording a value of the second color component when an index key is the first color component.

In some embodiments, the action of establishing the mapping relationship between the first color component and the second color component based on the first color-component reference sample and the second color-component reference sample may include: determining a first discrete model based on the first color-component reference sample and the second color-component reference sample, wherein the first discrete model is used to indicate the mapping relationship between the first color component and the second color component.

That is, in the embodiments of the present disclosure, the mapping relationship may be a Look Up Table (LUT). The index key in the LUT may be the first color component, and the value in the LUT may be the second color component, that is, LUT [key]=value. Alternatively, the mapping relationship may also be a discrete model for characterizing the mapping relationship between key-value.

For example, assuming that the luma component is key and the chroma component is value, each key-value pair in the mapping relationship may be established in a manner including but not limited to the following:

$$L U T [ r e c B v A f t D o w n L u m a [ i ] [ j ] ] = r e c B v C h r o m a [ i ] [ j ] \qquad ( 17 )$$

It should also be noted that, in the embodiments of the present disclosure, the first color component parameter sample may be limited to a preset sample range. In some embodiments, the method may further include: performing a mapping processing on the first color-component reference sample to make the first color-component reference sample locate in a preset sample range.

In the embodiments of the present disclosure, the preset sample range may be [0, (1<<bitdepth)−1], where bitdepth represents a bit depth. Exemplarily, the preset sample range may be [0,255], [0,511], or the like range, but is not particularly limited. Where there are a plurality of sample ranges, one of them may be selected as the final preset sample range using a rate-distortion cost method.

Exemplarily, taking a video with a bit depth greater than 8 bits as an example, assuming that the bit depth of the video is 10 bits, then the sample range is [0, 1023]. For the recBvAftDownLuma of the key, it may be mapped to a preset sample range of [0,255] or [0,511].

Further, in some embodiments, the method may further include: when the first reference sample values in the first color-component reference sample are the same and correspond to a plurality of different second reference sample values in the second color-component reference sample, performing overwrite processing in sample order, and using the last second reference sample value as a value having a mapping relationship with the first reference sample values.

Further, in some embodiments, the method may further include: when the first reference sample values in the first color-component reference sample are the same and correspond to a plurality of different second reference sample values in the second color-component reference sample, calculating an average value of the plurality of different second reference sample values, and using the obtained average value as a value having a mapping relationship with the first reference sample values.

That is, in the embodiments of the present disclosure, for different chroma values having the same key in the mapping relationship, entries having the same key may be overwritten in the order of samples, or operations such as averaging can be performed. Additionally, in the mapping relationship, the initialization of LUT [ ] is set to −1, which is an unavailable value. “Overwrite” mainly means that if there is the same key later, a new value will be used for storage. However, it is not limited to this manner. All values may also be stored and then an average value may be calculated as the value corresponding to the key.

It can be understood that in the embodiments of the present disclosure, the first color-component reference sample and the second color-component reference sample used for constructing the mapping relationship may be obtained in other ways, and the following will be exemplarily described in conjunction with several implementations.

In another specific implementation, the luma sample is not downsampled, and in this case, the chroma sample may be upsampled to obtain the chroma reference sample. In some embodiments, the action of determining the second color-component reference sample corresponding to the current block based on the reference block of the second color component may include: performing upsampling processing on the reference block of the second color component to determine the second color-component reference sample corresponding to the current block to make the resolution of the first color-component reference sample the same as the resolution of the second color-component reference sample.

That is, in the embodiments of the present disclosure, downsampling is not performed after the luma sample recBvBefDownLuma of the co-located luma region is acquired. In this case, after obtaining the chroma sample recBvChroma at the BV corresponding to the current block, it is required to perform up-sampling, including but not limited to linear interpolation, etc., to obtain the chroma sample recBvChromaUp having the same size as the luma sample at the BV Thus, the luma sample recBvBefDownLuma at BV is used as the luma reference sample, and the obtained up-sampled chroma sample recBvChromaUp is used as the chroma reference sample; and then, a mapping relationship between luma and chroma is constructed based on the luma reference sample and the chroma reference sample.

Accordingly, in the embodiments of the present disclosure, it is further required to perform downsampling processing on the predicted value of the second color component of the current block. That is, if the chroma sample is upsampled when the mapping relationship is constructed, a luma-to-chroma prediction is performed on the current block based on the mapping relationship, and the obtained chroma predicted value is required to be downsampled to obtain the final chroma predicted value of the current block. The downsampling includes, but is not limited to, average downsampling and the like.

In yet another specific implementation, the method may further include: determining a first template of the current block; and determining a first color-component reference sample and a second color-component reference sample corresponding to the current block based on the first template.

In the embodiments of the present disclosure, the first color-component reference sample and the second color-component reference sample used for constructing the mapping relationship may further include the first color-component reference sample and the second color-component reference sample determined by the first template of the current block. Specifically, based on the first template of the current block, a first color-component-region template at the same position as the first template may be determined. The first color-component reference sample may then be determined from a reconstructed sample in the first color-component-region template; and the second color-component reference sample may be determined from a reconstructed sample in the first template. The first template includes one or more reconstructed samples in adjacent decoded regions of the current block.

Exemplarily, in the embodiments of the present disclosure, a chroma reference sample may be obtained based on a current chroma template of a current block; after a co-located luma region template of the current chroma template is determined, a luma reference sample may be obtained based on the co-located luma region template. Then, combining the luma reference samples and the chroma reference samples obtained in the above embodiments, a mapping relationship between luma and chroma may be constructed based on the luma reference samples and the chroma reference samples.

In yet another specific implementation, the method may further include: determining a first template of the current block; determining a second matching template of the current block based on the first BV parameter and the first template; and determining a first color-component reference sample and a second color-component reference sample corresponding to the current block based on the second matching template.

In the embodiments of the present disclosure, the first color-component reference sample and the second color-component reference sample used for constructing the mapping relationship may include the first color-component reference sample and the second color-component reference sample determined by the second matching template of the current block in addition to those determined by the reference block and the first template of the current block. Specifically, a first color-component-region matching template at the same position as the second matching template is first determined, and then the first color-component reference sample may be determined based on a reconstructed sample in the first color-component-region matching template; the second color-component reference sample may be determined from a reconstructed sample in the second matching template. The second matching template may be determined based on the first BV parameter and the offset position indicated by the first template.

Exemplarily, in the embodiments of the present disclosure, a chroma matching template of the current block may be determined based on the current chroma template of the current block and the first BV parameter. Based on the chroma matching template, a chroma reference sample may be obtained; after determining a co-located luma-region matching template of the current chroma matching template, a luma reference sample may be obtained based on the co-located luma-region matching template. Then, combining the luma reference samples and the chroma reference samples obtained in the above embodiments, a mapping relationship between luma and chroma may be constructed based on the luma reference samples and the chroma reference samples.

S2003 includes: a predicted value of the second color component of the current block is determined based on the mapping relationship and a sample value of the first color component of the current block.

It should be noted that, in the embodiments of the present disclosure, the action of determining the sample value of the first color component of the current block may include: determining a reconstructed pixel sample of a first color component region at the same position of the current block; and determining the sample value of the first color component of the current block based on the reconstructed pixel sample of the first color component region. However, the reconstructed pixel sample of the first color component region may be directly used as the sample value of the first color component of the current block; or, the reconstructed pixel sample of the first color component region may be filtered, and the filtered reconstructed pixel sample may be used as the sample value of the first color component of the current block, which is not specifically limited here.

For example, in the embodiments of the present disclosure, the filtering process is a downsampling process. Here, a reconstructed luma sample recBefDownLuma at lumaPos=(xCb, yCb) which is the position of the co-located luma region corresponding to the current block may be acquired, and downsampling may be performed on the luma sample to obtain a down-sampled reconstructed luma sample recAftDownLuma, and the down-sampled reconstructed luma sample may be used as the sample value of the first color component of the current block. In addition, if a luma reference sample has been subjected to sample-range mapping processing, the down-sampled reconstructed luma sample is also required to be subjected to the same sample-range mapping processing to obtain the sample value of the first color component of the current block.

In some embodiments, the action of determining the predicted value of the second color component of the current block based on the mapping relationship and the sample value of the first color component of the current block may include: in response to finding a value of the first color component equal to the sample value of the first color component in the mapping relationship, determining a value of the second color component corresponding to the value of the first color component as the predicted value of the second color component of the current block.

For example, in the embodiments of the present disclosure, assuming that the predicted value of the current block is predSamples, the variable cIdx in predSamples [cIdx] [x] [y] represents the color-component index of the current block, and the following prediction method may be adopted:
deriving a chroma predicted value using the mapping relationship (i.e., a discrete model) established in the foregoing embodiments by referring to the luma value Yc corresponding to the same position of the color component.

In some embodiments, for determining the predicted value of the second color component of the current block, the method may further include: in response to failing to find the value of the first color component equal to the sample value of the first color component in the mapping relationship, performing correction processing on the sample value of the first color component to determine a corrected value of the first color component, and continuing to search whether a value of the first color component equal to the corrected value of the first color component exists in the mapping relationship.

In a specific embodiment, the action of performing correction processing on the the reconstructed value of the first color component to determine the corrected value of the first color component may include: performing an offset calculation on the sample value of the first color component based on one or more preset offset values to determine the corrected value of the first color component.

In the embodiments of the present disclosure, the offset value may be +1, −1, +2, −2, +3, −3, etc., and specific values and the number of offset values are not limited. Further, for the correction processing on the reconstructed value of the first color component, a plurality of offset values may be set in a predetermined order, and the correction processing may be performed in the order of {+1, −1, +2, −2, +3, −3}, for example.

For example, in the embodiments of the present disclosure, if Yc is not found in the input luma set in the mapping relationship established in the foregoing embodiments, the following processing may include, but is not limited to, performing correction processing on Yc in the order of {Yc+1, Yc−1, Yc+2, Yc−2, Yc+3, Yc−3}, then performing matching check in the input luma set based on the corrected Yc, and then determining a value value corresponding to the corrected Yc as the chroma predicted value of the current block.

In some embodiments, for determining the predicted value of the second color component of the current block, the method may further include: in response to failing to find the value of the first color component equal to the corrected value of the first color component in the mapping relationship, calculating an average value for the second color-component reference sample, and determining the obtained average value as the predicted value of the second color component of the current block.

For example, in the embodiments of the present disclosure, if Yc is not found in the input luma set in the mapping relationship established in the foregoing embodiments, the following processing may include, but is not limited to, performing correction processing on Yc in the order of {Yc+1, Yc−1, Yc+2, Yc−2, Yc+3, Yc−3}, and setting the chroma predicted value to the average value of the reconstructed chroma sample recBvChroma at the corresponding BV if the mapping relationship fails to match all the above corrected Yc.

In some embodiments, for determining the predicted value of the second color component of the current block, the method may further include: determining a first initial predicted value of the second color component of the current block based on the mapping relationship and the sample value of the first color component of the current block; and performing a correction operation on the first initial predicted value to determine the predicted value of the second color component of the current block.

It should be noted that, in the embodiments of the present disclosure, for the action of performing a correction operation on the first initial predicted value obtained based on the mapping relationship, the correction operation thereof may include a clip operation, a filtering operation, a weighting operation with predicted values obtained in other prediction modes, and the like, and there is no limitation thereon.

In a specific embodiment, the action of performing a correction operation on the first initial predicted value to determine the predicted value of the second color component of the current block may include: performing prediction processing on the second color component of the current block according to a first preset mode to determine a second initial predicted value of the second color component of the current block; and performing a weighting calculation on the first initial predicted value and the second initial predicted value to determine the predicted value of the second color component of the current block. Note that, in the embodiments of the present disclosure, the first preset mode includes at least one of the following: a PLANAR mode, a DM mode, a DC mode, or a CCLM mode. That is, the action of performing the correction operation on the first initial predicted value obtained based on the mapping relationship may include, but is not limited to, weighting with the CCLM-like mode or other prediction modes to obtain the chroma predicted value of the current block.

In another specific embodiment, the action of performing a correction operation on the first initial predicted value to determine the predicted value of the second color component of the current block may include: limiting the first initial predicted value to a preset value range, which may also be called a “clip operation”. Note that, in the embodiments of the present disclosure, the lower limit value of the preset value range is the minimum predicted value (min), and the upper limit value of the preset value range is the maximum predicted value (max). If the first initial predicted value is within the preset value range, the first initial predicted value may be used as the chroma predicted value of the current block; If the first initial predicted value is greater than max, then max may be used as the chroma predicted value of the current block; and if the first initial predicted value is less than min, min may be used as the chroma predicted value of the current block.

In some embodiments, for determining the predicted value of the second color component of the current block, the method may further include: determining a plurality of third initial predicted values of the second color component of the current block when the number of the first BV parameters is more than one; and performing a weighting calculation on the plurality of third initial predicted values to determine the predicted value of the second color component of the current block.

It should be noted that, in the embodiments of the present disclosure, if a plurality of BVs (i.e., the first BV parameters) are determined in the foregoing embodiments, a plurality of third initial predicted values may be obtained based on the plurality of BVs. Then the plurality of third initial predicted values are weighted, and the weighted predicted values are used as chroma predicted values of the current block. Alternatively, the weighted predicted values may be continuously corrected, including but not limited to weighting with a CCLM-like mode or other prediction modes, to obtain a chroma predicted value of the current block.

In some embodiments, for determining the predicted value of the second color component of the current block, the method may further include: when the first color component block of the current block includes a plurality of candidate blocks, determining a second BV parameter for each of the plurality of candidate blocks; constructing a plurality of BV parameter candidate lists of the second color component of the current block based on the second BV parameters of the plurality of candidate blocks, and determining a plurality of first BV parameters of the second color component of the current block based on the plurality of BV parameter candidate lists; and establishing the mapping relationship between the first color component and the second color component based on the plurality of first BV parameters, and determining the predicted value of the second color component of the current block based on the mapping relationship and the sample value of the first color component of the current block.

Note that, in the embodiments of the present disclosure, a plurality of blocks in the co-located luma region are acquired, and the positions of the plurality of blocks include but are not limited to the following positions, as shown in FIG. 19. First, whether the plurality of blocks are available is determined, and then candidates of respective BVC candidate lists are constructed based on the luma BV of the available blocks in the plurality of blocks; the plurality of blocks determine the availability of BVs in the candidate list to further determine one or more BVs, and a mapping table LUT between luma and chroma can be established based on all available BVC of the plurality of blocks, so that the chroma predicted value of the current block can be obtained according to the mapping table LUT.

In some embodiments, for determining the predicted value of the second color component of the current block, the method may further include: determining a plurality of sets of first color-component reference samples and second color-component reference samples corresponding to the current block based on the plurality of first BV parameters; establishing a plurality of candidate mapping relationships between the first color component and the second color component based on the plurality of sets of the first color-component reference samples and the second color-component reference samples corresponding to the current block; determining a target mapping relationship from the plurality of candidate mapping relationships; and according to the target mapping relationship and the sample value of the first color component of the current block, determining the predicted value of the second color component of the current block.

In a specific embodiment, the action of determining a target mapping relationship from the plurality of candidate mapping relationships may include: performing cost calculations on the plurality of candidate mapping relationships respectively based on a rate-distortion cost method to determine a plurality of rate-distortion cost results; determining a minimum rate-distortion cost result from the plurality of rate-distortion cost results, and determining a candidate mapping relationship corresponding to the minimum rate-distortion cost result as the target mapping relationship.

It should be noted that, in the embodiments of the present disclosure, the cost result may be determined using a distortion value, and specifically, the cost result may be determined by a rate-distortion cost method. However, it may also be the size of a SAD, the size of an MSE, the size of an SSE, or other criteria for determining the cost, which are not specifically limited herein.

Further, in some embodiments, the method may further include: determining a mapping relationship index value, wherein the mapping relationship index value is used to indicate a candidate mapping relationship corresponding to the minimum rate-distortion cost result among the plurality of rate-distortion cost results; and coding the mapping relationship index value, and writing the obtained coded bit into a bitstream.

It should also be noted that, in the embodiments of the present disclosure, the mapping relationship index value may be determined and written in the bitstream based on the index number of the candidate mapping relationship corresponding to the minimum rate-distortion cost result among the plurality of candidate mapping relationships, so that the decoding end can determine the corresponding target mapping relationship based on the mapping relationship index value obtained by decoding.

That is, in the embodiments of the present disclosure, a plurality of mapping tables LUT between luma and chroma may be established, and then a selected target mapping table LUT may be specified using a syntax element. Exemplarily, a plurality of blocks of the co-located luma region are acquired, and the positions of the plurality of blocks include, but are not limited to, the following positions, as shown in FIG. 19. First, whether the plurality of blocks are available is determined, and then candidates of respective BVC candidate lists are constructed based on the luma BVs of the available blocks in the plurality of blocks; the plurality of blocks respectively determine the availability of the BVs in the candidate list to further determine one BV or a plurality of BVs, and a mapping table LUT may be established respectively based on respective available BVC of the plurality of blocks. The coding end may predict the template of the current block by using different mapping tables LUT, and calculate the difference between the predicted values and the reconstructed value of the template, and then decide which mapping relationship to use. Subsequently, at the decoding end, the mapping relationship index value may be determined by decoding the corresponding syntax element; then, according to the mapping relationship index value, the target mapping relationship can be determined, and then the chroma predicted value of the current block can be determined. It is to be noted that the number of mapping relationships established here may be set arbitrarily, and for example, the number may be set to 4, but is not particularly limited.

In some embodiments, for determining the predicted value of the second color component of the current block, the method may further include: determining a plurality of sets of first color-component reference samples and second color-component reference samples corresponding to the current block based on the plurality of first BV parameters; establishing a plurality of candidate mapping relationships between the first color component and the second color component based on the plurality of sets of the first color-component reference samples and the second color-component reference samples corresponding to the current block; performing a matching error calculation on the plurality of candidate mapping relationships based on a template matching method to determine a second cost value of each of the plurality of candidate mapping relationships; determining a minimum cost value from the second cost values of the plurality of candidate mapping relationships, and determining a candidate mapping relationship corresponding to the minimum cost value as a target mapping relationship; and determining the predicted value of the second color component of the current block according to the target mapping relationship and the sample value of the first color component of the current block.

In a specific embodiment, the action of performing a matching error calculation on the plurality of candidate mapping relationships based on a template matching method to determine a second cost value of each of the plurality of candidate mapping relationships may include: determining a first template of the current block; determining reconstructed pixel sample values of a first color-component-region template at a same position as the first template; determining predicted values of respective second color components of the first template under the plurality of candidate mapping relationships based on the plurality of candidate mapping relationships and the reconstructed pixel sample values of the first color-component-region template; performing cost calculations based on reconstructed values of the second color components of the first template and the predicted values of the respective second color components of the first template under the plurality of candidate mapping relationships, and determining respective second cost values of the plurality of candidate mapping relationships.

Note that, in the embodiments of the present disclosure, a plurality of mapping table LUTs between luma and chroma may be established, and then a template may be used to select which mapping table LUT to use. Exemplarily, a plurality of blocks of the co-located luma region are acquired, and the positions of the plurality of blocks include, but are not limited to, the following positions, as shown in FIG. 19. First, whether the plurality of blocks are available is determined, and then candidates of respective BVC candidate lists are constructed based on the luma BVs of the available blocks in the plurality of blocks; the plurality of blocks respectively determine the availability of the BVs in the candidate list to further determine one BV or a plurality of BVs, and a mapping table LUT may be established respectively based on respective available BVC of the plurality of blocks. The template of the current block may be predicted using different mapping tables LUT, and the difference value may be calculated with the reconstructed value of the template, and then which mapping relationship is specifically used may be decided, and then the chroma predicted value of the current block may be determined using the finally decided mapping relationship. It is to be noted that the number of mapping relationships established here may be set arbitrarily, and for example, the number may be set to 4, but is not particularly limited.

In a specific embodiment, a specific process of performing LUT prediction on the template of the current block is as follows:
acquiring a reconstructed luma sample recBef DownLumaR at lumaPos=(xCbR, yCbR) which is a position of a co-located luma region template corresponding to the template of the current block, downsampling the luma sample to obtain a downsampled reconstructed luma sample recAftDownLumaR, and performing a same sample-range mapping processing on the sample.

Assuming that the predicted value of the template of the current block is predSamplesR, the variable cIdx in predSamplesR [cIdx] [x] [y] represents the color component index of the current block, and the prediction method is: referring to the luma value Yc corresponding to the same position of the color component to derive the predicted value using the established mapping relationship. If Yc is not found in the input luma set in the established mapping relationship, the following processing includes, but not limited to, checking in the order of {Yc+1, Yc−1, Yc+2, Yc−2, Yc+3, Yc−3}, and if the mapping relationship cannot match all the above values, the chroma predicted value of the current block is set to the average value of the reconstructed chroma samples recBvChroma at the corresponding BV.

When performing a cost calculation based on template of the current block and the template predicted value of each LUT, the usage of the template has the following situations:
the first type: both the upper template and the left template of the current block exist, and both the upper template and the left template are available;
the second type: only the upper template exists in the current block, and only the upper template is available;
the third type: only the left template exists in the current block, and only the left template is available; and
the fourth type: neither the upper template nor the left template of the current block exists, in which case, the final selected LUT is a first established LUT or a LUT at a specified position.

Exemplarily, in the embodiments of the present disclosure, assuming that the reconstructed value of the template of the current block is recSamplesR, there are a plurality of optional cost functions for calculating the template region cost, for example, such evaluation criteria as sum of absolute differences (SAD), sum of absolute transformed differences (SATD), sum of squared errors (SSE), mean absolute difference (MAD), mean absolute error (MAE), mean square error (MSE) may be selected. One of the evaluation criteria mentioned below may be selected from the above criteria. Taking SAD as an example, the calculation formula is as follows:

$$SAD = {\sum }_{i = 0}^{p r e d T e m p S i z e W - 1} {\sum }_{j = 0}^{p r e d T e m p S i z e H - 1} \vert predSamples R [ i ] [ j ] - r e c S a m p l e s R [ i ] [ j ] \vert ) \qquad ( 18 )$$

Here, predTempSizeW is a width of the template, predTempSizeH is a height of the template, predSamplesR[i][j] is a prediction pixel of the template of the current block after LUT, and recSamplesR[i][j] is a reconstructed pixel of the template of the current block.

It should also be noted that, in the embodiments of the present disclosure, for the final LUT selected using the template of the current block, except for the case where the cost cannot be calculated, the cost of each established LUT candidate may be calculated and sorted in other cases, and the sorting method includes but is not limited to bubble sorting, selection sorting, insertion sorting, Hill sorting, merge sorting, quick sorting, radix sorting, heap sorting, count sorting, and bucket sorting. The LUT candidate with the lowest cost is selected as the final LUT used.

Further, in the embodiments of the present disclosure, the method may further include: determining a prediction mode of the current block; in response to the prediction mode indicating that the second color component of the current block uses a target prediction mode, performing the action of determining the first BV parameter of the current block.

In some embodiments, determining the prediction mode of the current block may include: determining a plurality of candidate modes, the plurality of candidate modes including at least a target prediction mode; performing cost calculations on a plurality of candidate modes respectively based on a preset cost mode to determine a plurality of third cost values; determining a minimum cost value from the plurality of third cost values, and determining a candidate mode corresponding to the minimum cost value as the prediction mode of the current block, wherein the preset cost mode includes at least one of the following: a rate-distortion cost mode or a template matching mode.

That is, in the embodiments of the present disclosure, the BVG-LUT mode and other modes may be used simultaneously. In the DM mode, in addition to the BVG-LUT mode, competition may be performed with other modes. The final mode to be used is determined according to the template cost. For example, instead of directly using the BV obtained by the luma, a BV copy may be directly used, or the BVG-LUT mode defined in the embodiments of the present disclosure may be used, and after both modes are applied to the template of the current block, the one having the lower template cost is selected as the target prediction mode of the current block.

Further, in the embodiments of the present disclosure, the method may further include: determining a first color component region at the same position of the current block; and when the current block uses the DM mode and the first color component region performs prediction based on a BV, determining that the second color component of the current block uses the target prediction mode.

For example, in the embodiments of the present disclosure, under the dual-tree partition, in the DM mode, if the corresponding luma region has BV information, prediction is performed for the current block by use of the target prediction mode. For example:
If CuPredMode [0] [xCb+cbWidth/2] [yCb+cbHeight/2] is equal to MODE_IBC, intra bvgplt_flag=1 is set, then the intra-chroma prediction mode IntraPredModeC [xCb] [yCb] is the target prediction mode.
If CuPredMode [0] [xCb+cbWidth/2] [yCb+cbHeight/2] is equal to MODE_INTRA, if IntraTmpFlag [xCb+cbWidth/2] [yCb+cbHeight/2] is equal to 1, intra bvgplt_flag=1 is set, then the intra-chroma prediction mode IntraPredModeC [xCb] [yCb] is the target prediction mode.

In the embodiments of the present disclosure, the first syntax element identification information may be represented by intra_bvgplt_flag or bvgplt_flag, and the target prediction mode may be represented by BVG-PLT or BVG-LUT. The chroma prediction mode is derived as follows:
the intra-chroma prediction mode IntraPredModeC [xCb] [yCb] uses cclm_mode_flag, cclm_mode_idx, intra_chroma_pred_mode, lumaIntraPredMode, and lumaTempPredMode specified in the following table. These padding items other than the BVG-LUT mode are exemplarily given values, and it is not necessary to fill in with these values. Table 10 shows an example of derivation of a chroma prediction mode. As shown in Table 10, 0 represents the Planar mode, 1 represents the DC mode, 18 represents the horizontal mode, 50 represents the vertical mode, and 81 to 83 represent the CCLM mode.

As can be seen from Table 10, in the DM mode, if intra_ibc_flag==1, that is, the information acquired by the center block of the co-located luma region includes a BV, the intra-chroma prediction mode IntraPredModeC [xCb] [yCb] is the BVG-LUT mode.

Further, in the embodiments of the present disclosure, the method may further include: determining a value of first syntax element identification information, wherein the first syntax element identification information is used to indicate whether the second color component of the current block uses the target prediction mode; coding the value of the first syntax element identification information, and writing the obtained coded bit into a bitstream.

Note that, in the embodiments of the present disclosure, if the second color component of the current block uses the target prediction mode, it is determined that the value of the first syntax element identification information is a first value. If the second color component of the current block does not use the target prediction mode, it is determined that the value of the first syntax element identification information is a second value. Further, in the embodiments of the present disclosure, when the first syntax element identification information indicates that the second color component of the current block uses the target prediction mode, the action of determining the first BV parameter of the current block is performed.

Further, in the embodiments of the present disclosure, the method may further include: determining a value of second syntax element identification information, wherein the second syntax element identification information is used to indicate whether the second color component of the current block is allowed to use the target prediction mode; coding the value of the second syntax element identification information, and writing the obtained coded bit into the bitstream.

Note that, in the embodiments of the present disclosure, the second syntax element identification information may be represented by BvgpltEnabled. If the second color component of the current block is allowed to use the target prediction mode, it is determined that the value of the second syntax element identification information is a first value; and if the second color component of the current block is not allowed to use the target prediction mode, the value of the second syntax element identification information is determined to be a second value.

It should also be noted that in the embodiments of the present disclosure, the first value is different from the second value. The first value and the second value may be in the form of parameters or numerics. Specifically, both the first syntax element identification information and the second syntax element identification information may be parameters written in a profile, or may be values of flags/identifiers, which is not limited here.

Exemplarily, the first value may be set to 1 and the second value may be set to 0; alternatively, the first value may be set to 0 and the second value may be set to 1; alternatively, the first value may be set to true and the second value may be set to false; alternatively, the first value may be set to false and the second value may be set to true. However, in the embodiments of the present disclosure, the first value may be set to 1, and the second value may be set to 0, and this is not limited.

Exemplarily, in the embodiments of the present disclosure, if the syntax element sps_ibc_enabled_flag is equal to 0 and sps_intratmp_enabled_flag is equal to 0, then BvgpltEnabled is equal to 0; otherwise, the variable ModeIncludeBv is set. if the corresponding luma block is not coded in the mode with BV information, the variable ModeIncludeBv is equal to 0; otherwise ModeIncludeBv equals 1.

BvgpltEnabled is equal to 1 if multiple following conditions are true at the same time (including but not limited to the following conditions):
ModeIncludeBv equals 1;
Sh_slice_type is equal to I-frame;
CtbLog2SizeC is less than or equal to MaxChromalbcSize, and MaxChromalbcSize may be determined based on a chroma CTU size or a preset value.

Otherwise, BvgpltEnabled is equal to 0. Here, if BvgpltEnabled is equal to 0, the value of the first syntax element identification information can be inferred to be 0.

It can also be understood that in the embodiments of the present disclosure, referring to FIG. 20, after the action S2003, the method may further include:

S2004: a residual value of the second color component of the current block is determined based on the predicted value of the second color component of the current block.

Note that, in the embodiments of the present disclosure, an original value of the second color component of the current block may be determined, and the residual value of the second color component of the current block may be determined based on the original value and the predicted value of the second color component of the current block. Specifically, subtraction may be performed for the original value and the predicted value of the second color component of the current block to obtain a residual value of the second color component of the current block.

Further, in the embodiments of the present disclosure, the residual value of the second color component of the current block may be coded, and the obtained coded bit may be written into the bitstream. Thus, at the decoding end, the residual value of the second color component of the current block may be determined by decoding the bitstream; a reconstructed value of the second color component of the current block may be determined from the residual value and the predicted value of the second color component of the current block. Specifically, an addition operation may be performed for the residual value of the second color component of the current block and the predicted value to recover the reconstructed value of the second color component of the current block.

An embodiment of the present disclosure further provides a bitstream generated by bit coding based on information to be coded. The information to be coded includes at least one of the followings: a residual value of the second color component of the current block, the value of first syntax element identification information, the value of second syntax element identification information, or a mapping relationship index value.

In the embodiments of the present disclosure, the first syntax element identification information is used to indicate whether the second color component of the current block uses the target prediction mode, the second syntax element identification information is used to indicate whether the second color component of the current block is allowed to use the target prediction mode, and the mapping relationship index value is used to indicate an index number of the candidate mapping relationship corresponding to the minimum rate-distortion cost result among the plurality of candidate mapping relationships. In this way, the coding end writes the information to be coded into a bitstream and transmits it to the decoding end, so that the decoding end can obtain the information by decoding the bitstream, so that a chroma reconstructed value of the current block can be recovered.

An embodiment provides a coding method, in which a first BV parameter of a current block is determined; a first color-component reference sample and a second color-component reference sample corresponding to the current block are determined based on the first BV parameter; a mapping relationship between a first color component and a second color component is established based on the first color-component reference sample and the second color-component reference sample; based on the mapping relationship and a sample value of the first color component of the current block, a predicted value of the second color component of the current block is determined. Thus, after the first BV parameter to which the chroma component is applied is determined based on the BV parameter of the luma block, a mapping relationship between the luma component and the chroma component may be established based on the luma component reference sample and the chroma component reference sample at the first BV parameter, and then prediction of the chroma component may be performed using the mapping relationship. In this way, the singularity of chroma prediction is improved, the relevant information of the co-located luma block is fully utilized, and the accuracy of chroma prediction can be improved. Furthermore, according to the established mapping relationship, pixel-level prediction can be effectively carried out, thus further reducing the bit rate and improving the codec efficiency.

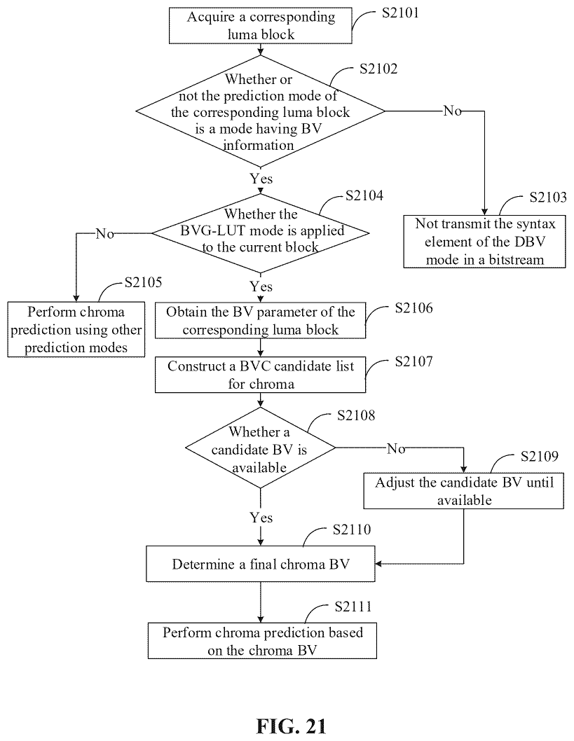

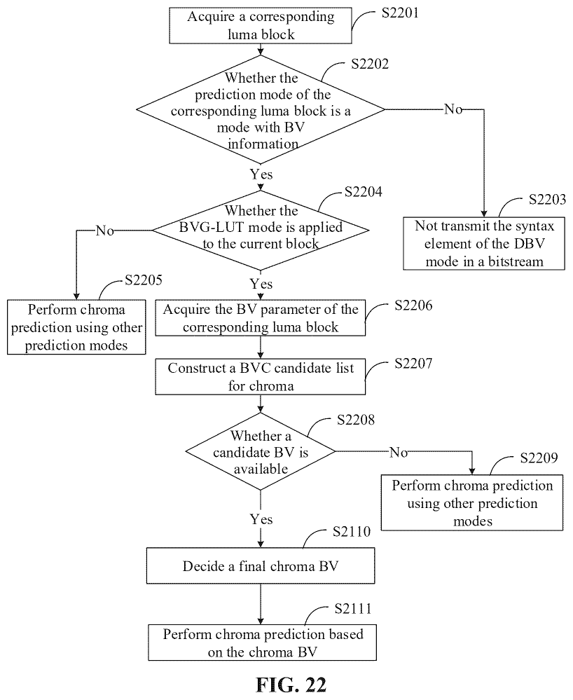

In another embodiment of the present disclosure, based on the codec method described in the foregoing embodiments, a new prediction mode BVG-LUT mode (i.e., Scheme 1) is added in the embodiments of the present disclosure. In the flow of the first scheme, a corresponding luma block is obtained, and whether the corresponding luma block is coded in a mode having BV information is determined. Then the following processing may be adopted:
if not coded in a mode having BV information, no syntax elements of the mode are transmitted in the bitstream; and
if coded in a mode having BV information and if the BVG-LUT mode is true, the BV of the corresponding luma block is obtained, the luma BV (BVL) is adjusted and applied to the chroma, and a list of the chroma BV (BVC) candidates is constructed. Then, whether the BVC candidates in the BVC candidate list are available is determined: if available, enter the decision-making process; if not available, adjust the BVC to be available and then enter the decision-making process; or if none of the BVC candidates in the BVC candidate list is available, the PLANAR mode or other chroma prediction mode is used for prediction. Different processing flowcharts for the case where a BVC candidate is not available are shown in FIGS. 21 and 22.

Referring to FIG. 21, a detailed flow diagram of a coding method according to an embodiment of the present disclosure is shown. As shown in FIG. 21, the detailed flow may include:
S2101: a corresponding luma block is acquired;
S2102: it is determined whether or not the prediction mode of the corresponding luma block is a mode having BV information;
S2103: the syntax element of the DBV mode is not transmitted in a bitstream;
S2104: it is determined whether or not the BVG-LUT mode is applied to the current block;
S2105: if the BVG-LUT mode is not applied to the current block, chroma prediction is performed using another prediction mode;
S2106: if the BVG-LUT mode is applied to the current block, the BV parameter of the corresponding luma block is acquired;
S2107: a BVC candidate list is constructed for chroma;
S2108: it is determined whether or not a candidate BV is available;
S2109: if the candidate BV is not available, the candidate BV is adjusted until the candidate BV is available;
S2110: if the candidate BV is available, a final chroma BV is decided; and
S2111: chroma prediction is performed based on the chroma BV.

Referring to FIG. 22, a detailed flow diagram of another coding method provided by an embodiment of the present disclosure is shown. As shown in FIG. 22, the detailed flow may include:
S2201: a corresponding luma block is acquired;
S2202: it is determined whether or not the prediction mode of the corresponding luma block is a mode having BV information;
S2203: the syntax element of the DBV mode is not transmitted in a bitstream;
S2204: it is determined whether or not the BVG-LUT mode is applied to the current block;
S2205: if the BVG-LUT mode is not applied to the current block, chroma prediction is performed using another prediction mode;
S2206: if the BVG-LUT mode is applied to the current block, the BV parameter of the corresponding luma block is acquired;
S2207: a BVC candidate list is constructed for chroma;
S2208: it is determined whether or not a candidate BV is available;
S2209: if the candidate BV is not available, chroma prediction is performed using another prediction mode;
S2210: if the candidate BV is available, a final chroma BV is decided; and
S2211: chroma prediction is performed based on the chroma BV.

In a specific embodiment, the coding method according to the embodiments of the present disclosure may specifically include the following actions.

S1 includes: a corresponding luma block is acquired.

An obtained block position may be any position, including but not limited to the following positions:

An obtained block position may be any position, including but not limited to the following positions:
(1) the central block in the co-located luma region, as shown in FIG. 3.
(2) the block in the upper-left corner of the co-located luma region, as shown in FIG. 7.
(3) the block at the lower right corner of the co-located luma region, as shown in FIG. 8.
(4) the block including five luma pixel positions shown in FIG. 9 (including but not limited to five positions, which may also be a plurality of different positions), which is sequentially acquired until it is determined that the obtained block is coded in a mode with BV information, that is, the block at the first luma pixel position is found to be coded in a mode with BV information, and the acquisition order includes but is not limited to the following: C->TL->TR->BL->BR.

S2 includes: the luma block is coded in a mode having BV information.

A block at a corresponding position is acquired, and the luma block is determined to be processed in a mode with BV information, including but not limited to an IBC mode or an IntraTMP mode:
If so, obtaining a BV of a corresponding luma block; and
If not, transmitting no syntax elements of the mode in the bitstream.

S3 includes: constructing a BVC candidate list.

Assuming luma BV=(BVLₕₒᵣ, BVLᵥₑᵣ) and chroma BV=(BVChor, BVCver), a BVC candidate list including one or more candidates is constructed by adjusting the BVL or the BVC. Construction methods include, but are not limited to, one of the following situations, and different methods can be used simultaneously to construct a candidate list.

Method 1: scaling is performed according to a chroma sampling format, and the scaled BVC is added to the BVC candidate list.

Method 2: after obtaining a BV of a corresponding luma block, the obtained BV is recorded as BVL; a chroma BV obtained by BVL is denoted as BVC; BVC candidates including one or more candidates are constructed by adjusting the BVL or the BVC.

Candidate construction schemes include, but are not limited to, the following:

Construction scheme 1: BVL is adjusted to form four situations, and then the adjustment of BVC is realized.

When BVL is odd, the four cases where BVL=(BVLₕₒᵣ, BVLᵥₑᵣ), BVL=(BVLₕₒᵣ+1, BVLᵥₑᵣ), BVL=(BVLₕₒᵣ, BVLᵥₑᵣ+1), BVL=(BVLₕₒᵣ+1, BVLᵥₑᵣ+1) are taken.

When BVL is even, BVL=(BVLₕₒᵣ, BVLᵥₑᵣ) is taken.

The BVL may be scaled according to the chroma sampling format in scheme 1 to obtain a BVC, so that when the BVL is odd, four types of BVC candidates may be formed and added to the BVC candidate list.

Construction scheme 2: BVL is adjusted to form four situations, and then the adjustment of BVC is realized.

When BVL is odd, four cases where BVL=(BVLₕₒᵣ, BVLᵥₑᵣ), BVL=(BVLₕₒᵣ+1, BVLᵥₑᵣ), BVL=(BVLₕₒᵣ, BVLᵥₑᵣ+1), BVL=(BVLₕₒᵣ+1, BVLᵥₑᵣ+1) are taken.

When BVL is even, four cases where BVL=(BVLₕₒᵣ, BVLᵥₑᵣ), BVL=(BVLₕₒᵣ−1, BVLᵥₑᵣ), BVL=(BVLₕₒᵣ, BVLᵥₑᵣ−1), BVL=(BVLₕₒᵣ−1, BVLᵥₑᵣ−1) are taken.

The BVL may be scaled according to the chroma sampling format in the scheme 1 to obtain a BVC, so that when the BVL is odd or even, four types of BVC candidates may be formed and added to the BVC candidate list. This scheme may not distinguish operations for odd and even numbers by the following calculations:
setting four cases where BVL=(BVLₕₒᵣ−1, BVLᵥₑᵣ−1), BVL=(BVLₕₒᵣ+1, BVLᵥₑᵣ−1), BVL=(BVLho−1r, BVLᵥₑᵣ+1), BVL=(BVLₕₒᵣ+1, BVLᵥₑᵣ+1), which is not limited.

Construction scheme 3: BVL is adjusted to form a variety of situations, and then the adjustment of BVC is realized.

When BVL is odd, other situations where BVL=(BVLₕₒᵣ, BVLᵥₑᵣ), BVL=(BVLₕₒᵣ+1, BVLᵥₑᵣ), BVL=(BVLₕₒᵣ, BVLᵥₑᵣ+1), BVL=(BVLₕₒᵣ+1, BVLᵥₑᵣ+1), BVL=(BVLₕₒᵣ+3, BVLᵥₑᵣ), BVL=(BVLₕₒᵣ, BVLᵥₑᵣ+3), BVL=(BVLₕₒᵣ+3, BVLᵥₑᵣ+3), BVL=(BVLₕₒᵣ−2, BVLᵥₑᵣ), BVL=(BVLₕₒᵣ, BVLᵥₑᵣ−2) are taken.

When BVL is even, other situations where BVL=(BVLₕₒᵣ, BVLᵥₑᵣ), BVL=(BVLₕₒᵣ−1, BVLᵥₑᵣ), BVL=(BVLₕₒᵣ, BVLᵥₑᵣ−1), BVL=(BVLₕₒᵣ−1, BVLᵥₑᵣ−1), BVL=(BVLₕₒᵣ−3, BVLᵥₑᵣ), BVL=(BVLₕₒᵣ, BVLᵥₑᵣ−3), BVL=(BVLₕₒᵣ−3, BVLᵥₑᵣ−3), BVL=(BVLₕₒᵣ+2, BVLᵥₑᵣ), BVL=(BVLₕₒᵣ, BVLᵥₑᵣ+2) are taken.

The BVL may be scaled according to the chroma sampling format in the scheme 1 to obtain a BVC, so that when the BVL is odd or even, a plurality of BVC candidates may be formed and added to the BVC candidate list. It should be noted that these candidates may be added to the BVC candidate list in order.

Similar to the scheme 2, there is no need to distinguish between odd and even cases, and it can be uniformly expressed as:
setting BVL=(BVLhor−1, BVLver−1), BVL=(BVLhor+1, BVLver−1), BVL=(BVLhor−1, BVLver+1), BVL=(BVLhor+1, BVLver+1), BVL=(BVLhor+3, BVLver−1), BVL=(BVLhor−1, BVLver+3), BVL=(BVLhor+3, BVLver+3), BVL=(BVLhor−3, BVLver −1), BVL=(BVLhor−1, BVLver −3), etc.

Construction scheme 4: the BVC obtained in scheme 1 is adjusted to obtain nine candidates, and the number is not limited here.

BVC=(BVCₕₒᵣ, BVCᵥₑᵣ), BVC=(BVCₕₒᵣ−1, BVCᵥₑᵣ), BVC=(BVCₕₒᵣ, BVCᵥₑᵣ−1), BVC=(BVCₕₒᵣ−1, BVCᵥₑᵣ−1), BVC=(BVCₕₒᵣ+1, BVCᵥₑᵣ), BVC=(BVCₕₒᵣ, BVCᵥₑᵣ+1), BVC=(BVCₕₒᵣ+1, BVCᵥₑᵣ+1), BVC=(BVCₕₒᵣ−1, BVCᵥₑᵣ+1), BVC=(BVCₕₒᵣ+1, BVCᵥₑᵣ−1) are set to form nine BVC candidates, which are added to the BVC candidate list.

Construction scheme 5: the BVC obtained in scheme 1 is adjusted to obtain a variety of candidates.

BVC=(BVCₕₒᵣ, BVCᵥₑᵣ), BVC=(BVCₕₒᵣ−1, BVCᵥₑᵣ), BVC=(BVCₕₒᵣ, BVCᵥₑᵣ−1), BVC=(BVCₕₒᵣ−1, BVCᵥₑᵣ−1), BVC=(BVCₕₒᵣ+1, BVCᵥₑᵣ), BVC=(BVCₕₒᵣ, BVCᵥₑᵣ+1), BVC=(BVCₕₒᵣ+1, BVCᵥₑᵣ+1), BVC=(BVCₕₒᵣ−1, BVCᵥₑᵣ+1), BVC=(BVCₕₒᵣ+1, BVCᵥₑᵣ−1), BVC=(BVCₕₒᵣ−2, BVCᵥₑᵣ), BVC=(BVCₕₒᵣ, BVCᵥₑᵣ−2), BVC=(BVCₕₒᵣ−2, BVCᵥₑᵣ−2), BVC=(BVCₕₒᵣ+2, BVCᵥₑᵣ), BVC=(BVCₕₒᵣ, BVCᵥₑᵣ+2), BVC=(BVCₕₒᵣ+2, BVCᵥₑᵣ+2), BVC=(BVCₕₒᵣ−2, BVCᵥₑᵣ+2), BVC=(BVCₕₒᵣ+2, BVCᵥₑᵣ−2) etc., are set to form a plurality of BVC candidates, which are added to the BVC candidate list.

S4 includes: it is determined whether or not the BV is available.

The position (xCb, yCb) of the current block is obtained, all BVC candidates obtained in S3 are acquired, each BVC candidate satisfies BVC=(BVCₕₒᵣ, BVCᵥₑᵣ), and the corresponding offset position (xCb+BVCₕₒᵣ, yCb+BVCᵥₑᵣ) is found. The following conditions, which are not limited here, are judged; if all of them are true, the candidate chroma BV is available, and thus constructing an available BVC candidate list:
whether the obtained offset position does not exceed a Picture boundary, such as xCb+width+BVCₕₒᵣ<=xCb or yCb+height+BVCᵥₑᵣ<=yCb;
whether the obtained offset position does not cover the current block, as shown in FIG. 10;
whether the obtained offset position does not exceed an available region, as shown in FIG. 11; and
whether the obtained offset position has been reconstructed.

Here, if at least one BVC candidate is available, the process proceeds to S5 for making a BV decision. If none of them are available, a certain BVC candidate may be adjusted to be available, and the process proceeds to S5 to make a BV decision. Manners of adjustment include, but are not limited to, cropping, scaling, and the like.

If no BVC candidate is available, reference pixels and mode parameters may be obtained for chroma mode prediction, including but not limited to PLANAR mode or CCLM-like mode, or other angular prediction modes.

S5 includes: a BV decision is made.

In S4, there is only one BVC candidate in the available BVC candidate list, and the final selected BV is the BVC.

The available BVC candidate list obtained in S4 has a plurality of BVC candidates, and it is required to make decisions on these BVCs to obtain the final BV The decision-making includes but is not limited to the following methods.

Use templates to make a decision:

### (1) Template Selection

Based on the pixel availability of an adjacent region of the current block, whether a pixel at a template position is available is determined, including reconstructing chroma information, which includes but is not limited to: according to the relative positional relationship between templates and the current block, the template can be classified into an upper template, a left template, an upper right template, a lower left template, and an upper left template, as shown in FIG. 15.

The sizes of different types of templates of different coding blocks may be fixed the same or may be different:

For example, a same template size is selected for any current coding block, and the following formula explains a setting condition for a template size, where nTbW and nTbH are the width and height of the current chroma coding block, and iTempW and iTempH are the width and height of an adopted template:

$$Upper template : \{ \begin{matrix}iTempW = nTbW \\ iTempH = 1\end{matrix} \qquad ( 19 )$$

$$Left template : \{ \begin{matrix}iTempW = 1 \\ iTempH - nTbH\end{matrix} \qquad ( 20 )$$

For example, different template sizes may be selected based on different sizes of the current coding block, and the following formula explains a size setting condition for a template, where nTbW and nTbH are the width and height of the current chroma coding block, and iTempW and iTempH are the width and height of an adopted template:

$$Upper template : \{ \begin{matrix}\{ \begin{matrix}iTempW = nTbW \\ iTempH = 2\end{matrix} , min ( nTbW , nTbH ) \leq 4 \\ \{ \begin{matrix}iTempW = nTbW \\ iTempH = 4\end{matrix} , min ( nTbW , nTbH ) > 4\end{matrix} \qquad ( 21 )$$

$$Left template : \{ \begin{matrix}\{ \begin{matrix}iTempW = 2 \\ iTempH = nTbH\end{matrix} , min ( nTbW , nTbH ) \leq 4 \\ \{ \begin{matrix}iTempW = 4 \\ iTempH = nTbH\end{matrix} , min ( nTbW , nTbH ) > 4\end{matrix} \qquad ( 22 )$$

$$wherein Min ( x , y ) = \{ \begin{matrix}x , x \leq y \\ y , x > y\end{matrix} .$$

For example, different template sizes may be selected based on the number of pixels in the current chroma coding block, and a size setting condition for a template is described by the following formula, in which nTbW and nTbH are the width and height of the current chroma coding block, nTbW×nTbH is the number of pixels of the current chroma coding block, and iTempW and iTempH are the width and height of an adopted template:

$$Upper template : \{ \begin{matrix}\{ \begin{matrix}iTempW = nTbW \\ iTempH = 2\end{matrix} , nTbW \times nTbH \leq 16 \\ \{ \begin{matrix}iTempW = nTbW \\ iTempH = 4\end{matrix} , nTbW \times nTbH > 16\end{matrix} \qquad ( 23 )$$

$$Left template : \{ \begin{matrix}\{ \begin{matrix}iTempW = 2 \\ iTempH = nTbH\end{matrix} , nTbW \times nTbH \leq 16 \\ \{ \begin{matrix}iTempW = 4 \\ iTempH = nTbH\end{matrix} , nTbW \times nTbH > 16\end{matrix} \qquad ( 24 )$$

### (2) BV Prediction of Template.

Motion compensation is performed for a plurality of obtained BVC candidates by using the template of the current block to obtain a template at a corresponding BV, as shown in FIG. 16. The template usage for calculating the cost has the following situations:
Type 1: both the upper template and the left template of the current block exist, and both the upper template and the left template at the corresponding BV exist, in which case, both the upper template and the left template are available;
Type 2: both the upper template and the left template of the current block exist, and only the upper template exists at the corresponding BV, in which case, there are two ways: way 1: no left template exists at the corresponding BV and no left template is used, that is, only the upper template is used for calculation; and way 2: no left template not exists at the corresponding BV, and the leftmost template width column inside the reference block is used to replace the left template, that is, the upper template and the left template are used for calculation;
Type 3: both the upper template and the left template of the current block exist, and only the left template exists at the corresponding BV, in which case, there are two ways: way 1: no upper template exists at the corresponding BV and no upper template is used, that is, only the left template is used for calculation; and way 2: no upper template exists at the corresponding BV, and the uppermost template height row inside the reference block is used instead of the upper template, that is, the upper template and the left template are used for calculation;
Type 4: only the upper template exists in the current block, in which case, there are three ways: way 1: no upper template exists at the corresponding BV and no upper template is used, in this way, the final selected BV is the first BVC in the BVC candidate list or the BVC at a specified position; way 2: no upper template exists at the corresponding BV, and the uppermost template height row inside the reference block is used instead of the upper template; and way 3: an upper template exists at the corresponding BV, so it is used directly;
Type 5: only the left template exists in the current block, in which case, there are three ways: way 1: no left template exists at the corresponding BV and no left template is used, in this way, the final selected BV is the first BVC in the BVC candidate list or a BVC at a specified position; way 2: no left template exists at the corresponding BV, and the leftmost template width column inside the reference block is used instead of the left template; and way 3: a left template exists at the corresponding BV, so it is used directly; and
Type 6: neither the upper template nor the left template exists in the current block, and in this case, the final selected BV is the first BVC in the BVC candidate list or a BVC at a specified position.

### (3) Cost Calculation.

There are many optional cost functions for calculating the cost of a template region. For example, such evaluation criteria as SAD, SATD, SSE, MAD, MAE, MSE, rate-distortion function (RDO), etc. may be selected, and one of the evaluation criteria mentioned here may be selected for cost calculation.

### (4) Selection of the Final BV.

Except for the situation where the cost cannot be calculated in (2), the cost of each candidate in the candidate list of BVC may be calculated and sorted in other situations. The sorting methods include but are not limited to bubble sorting, selection sorting, insertion sorting, Hill sorting, merge sorting, quick sorting, radix sorting, heap sorting, count sorting, and bucket sorting. The BVC with the lowest cost may be selected as the final BV, so as to perform chroma prediction based on a BV. It should be noted that when the cost calculation is performed on a plurality of candidate BV parameters, cost may be calculated for each candidate BV parameter, and the candidate BV parameter with the lowest cost may always be reserved. In this case, a list or even sorting is not required.

S6 includes: BV-based chroma prediction is performed.

Chroma prediction includes but is not limited to the following manners.

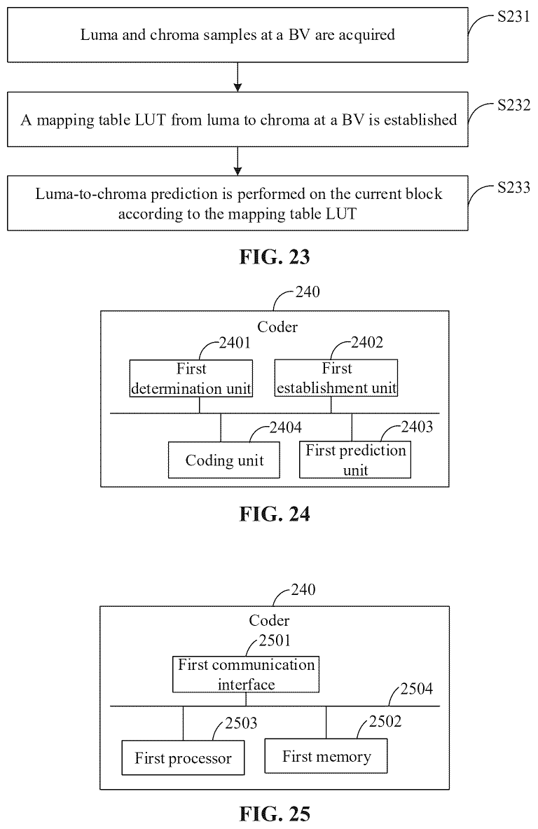

In the first manner, FIG. 23 illustrates a schematic diagram of a BV-based chroma prediction flow according to an embodiment of the present disclosure. As shown in FIG. 23, the flow may include the following actions.

S231 includes: luma and chroma samples at a BV are acquired.

### (1) Obtain Luma Samples:

The position of the current block, that is, chromaPos=(x, y) which is the position of the upper-left-corner chroma sample of the current block relative to the upper-left-corner chroma sample of the current picture, is obtained, and the chromaPos is scaled according to the chroma sampling format to obtain lumaPos=(xCb, yCb) which is the position of a co-located luma region corresponding to the current block.

The chroma BV=(BVChor, BVCver) is obtained, and the chroma BV is adjusted according to the chroma sampling format to obtain the luma BV=(BVYhor, BVYver) of the co-located luma region corresponding to the current block.

As shown in FIG. 17, the position lumaPos=(xCb, yCb) of the co-located luma region corresponding to the current block is obtained, the luma BV=(BVYhor, BVYver) is obtained, and the offset position (xCb+BVYhor, yCb+BVYver) of the co-located luma region corresponding to the current block is found. The luma at the position is downsampled to obtain a downsampled luma sample. The following sampling methods may compete or one sampling method may be adopted by default, including but not limited to the following downsampling methods.

Assuming that the luma sample before downsampling is recBvBefDownLuma, the width of the buffer is iRecRefLumaStride, and the luma sample after downsampling is recBvAftDownLuma, then the sample after downsampling at position (i, j) is:
Downsampling method 1:

$$recBvAftDownLuma [ i ] [ j ] = ( r e c B v B e f D o w n L u ma [ 2 * i ] * 2 + recBvBefDownLu ma [ 2 * i + 1 ] + recBvBefDownLu ma [ 2 * i - 1 ] + recBvBefDownLuma [ 2 * i + i R e c R e f L u m a S t r i de ] * 2 + recBvBefDownLu ma [ 2 * i + 1 + i R e c R e f L u m a S t r i de ] + recBvBefDownLu ma [ 2 * i - 1 + i R e c R e f L u m a S t r i d e ] + 4 ) >> 3 ;$$

Downsampling method 2:

$$recBvAftDownLuma [ i ] [ j ] = ( r e c B v B e f D o w n L u ma [ 2 * i ] + recBvBefDownLu ma [ 2 * i + 1 ] + 1 ) >> 1 ;$$

Downsampling method 3:

$$recBvAftDownLuma [ i ] [ j ] = ( r e c B v B e f D o w n L u ma [ 2 * i ] + recBvBefDownLuma [ 2 * i + iRecRefLumaStride ] + 1 ) >> 1 ;$$

Downsampling method 4:

$$recBvAftDownLuma [ i ] [ j ] = ( r e c B v B e f D o w n L u ma [ 2 * i + i R e c R e f L u m a S t r i de ] + recBvBefDownLu ma [ 2 * i + 1 + i R e c R e f L u m a S t r i d e ] + 1 ) >> 1 ;$$

Downsampling method 5:

$$recBvAftDownLuma [ i ] [ j ] = ( r e c B v B e f D o w n L u ma [ 2 * i + 1 ] + recBvBefDownLu ma [ 2 * i + 1 + i R e c R e f L u m a S t r i d e ] + 1 ) >> 1 ;$$

Downsampling method 6:

$$recBvAftDownLuma [ i ] [ j ] = ( r e c B v B e f D o w n L u ma [ 2 * i ] + recBvBefDownLu ma [ 2 * i + 1 ] + recBvBefDownLu ma [ 2 * i + i R e c R e f L u m a S t r i de ] + recBvBefDownLu ma [ 2 * i + 1 + i R e c R e f L u m a S t r i d e ] + 2 ) >> 2.$$

In this way, after downsampling, the downsampled reconstructed luma sample recBvAftDownLuma at the BV corresponding to the co-located luma region corresponding to the current block is acquired.

### (2) Obtain Chroma Samples:

The position (xCbC, yCbC) of the current block is obtained, the chroma BV=(BVChor, BVCver) is obtained, and the corresponding offset position (xCbC+BVChor, yCbC+BVCver) is found, that is, the reconstructed chroma sample recBvChroma at the corresponding BV of the current block is obtained.

S232 includes: a mapping table LUT from luma to chroma at a BV is established.

The luma-to-chroma mapping table LUT may be established for the reconstructed luma sample recBvAftDownLuma and the reconstructed chroma sample recBvChroma at the corresponding BV acquired in S231, including but not limited to the following manner:

Luma is key, and chroma is value.

For a video with a bit depth greater than 8 bits, the sample range is [0, 1023], and the key recBvAftDownLuma may be mapped to [0, 255], [0, 511], and other range.

For each key-value pair in the LUT table, a discrete model may be built in a manner including, but not limited to, the following:

$$L U T [ r e c B v A f t D o w n L u m a [ i ] [ j ] ] = r e c B v C h r o m a [ i ] [ j ] \qquad ( 25 )$$

For different chroma values of the same key, entries of the same key may be overwritten in sample order, or operations such as averaging may be taken.

S233 includes: Luma-to-chroma prediction is performed on the current block according to the mapping table LUT.

A reconstructed luma sample recBefDownLuma is acquired at lumaPos=(xCb, yCb) which is the position of the co-located luma region corresponding to the current block, the same down-sampling method on the luma sample in the method of S231 is performed to obtain the down-sampled reconstructed luma sample recAftDownLuma, and mapping processing is performed on the sample in the same sample range as in S232. It should be noted that the downsampling described in the embodiments of the present disclosure is performed for YUV420.

Assuming that the predicted value of the current block is predSamples, the variable cIdx in predSamples [cIdx] [x] [y] represents the color component index of the current block, and the following prediction method is adopted:
deriving the predicted value using the discrete model established at S232 by referring to the luma value Yc corresponding to the same position of the color component.

If Yc is not found in the input luma set in the discrete model established in S232, the following processing includes, but is not limited to, checking in the order of {Yc+1, Yc−1, Yc+2, Yc−2, Yc+3, Yc−3}, and if the model cannot match all the above values, the prediction is set to an average value of the reconstructed chroma sample recBvChroma at the corresponding BV.

In the second manner, the predicted value of the first method is corrected to obtain a final predicted value, including but not limited to weighting with a CCLM-like mode or other mode.

In the third manner, a plurality of BVs are determined in step S5, the BV-based prediction in the first manner is performed to obtain a plurality of predicted values, and then the plurality of predicted values are weighted to obtain weighted predicted values, and the predicted values may be continuously corrected, including but not limited to weighting with a CCLM-based mode or another mode.

S7 includes: other situations.

If it is the PLANAR mode or the CCLM-type mode or other angular modes, reference pixels and mode parameters may be obtained for chroma prediction.

In another embodiment, correction of the DM mode is improved (i.e., scheme 2). Under the dual-tree partition, in the DM mode, if a corresponding luma region has BV information, the BVG-LUT mode may be adopted by the current chroma block for prediction. For example:
If CuPredMode [0] [xCb+cbWidth/2] [yCb+cbHeight/2] is equal to MODE_IBC, setting intra_bvgplt_flag=1, then the intra-chroma prediction mode IntraPredModeC [xCb] [yCb] is the BVG-LUT mode.
If CuPredMode [0] [xCb+cbWidth/2] [yCb+cbHeight/2] is equal to MODE_INTRA, if IntraTmpFlag [xCb+cbWidth/2] [yCb+cbHeight/2] is equal to 1, set intra bvgplt_flag=1, then the intra-chroma prediction mode IntraPredModeC [xCb] [yCb] is the BVG-LUT mode.

Here, the derivation of chroma prediction mode is shown in Table 10. In the DM mode, if intra bvgplt_flag==1, that is, the information acquired by the center block of the co-located luma region includes a BV, the intra-chroma prediction mode IntraPredModeC [xCb] [yCb] is the BVG-LUT mode.

In addition, the flow of the BVG-LUT mode in Scheme 1 is used for prediction, and the actions are the same as S1, S2, S3, S4, S5 and S6 in Scheme 1. In action S1, a center block in a co-located luma region is acquired. In action S2, a BV of the corresponding luma block is directly acquired. If the chroma BV in action S7 is not available, the corresponding luma prediction mode is acquired.

Based on the codec method described in the foregoing embodiments, an embodiment of the present disclosure further provides a bitstream organizing method. This may include, but is not limited to, the following manners.

Manner 1: Coding is performed inside MODE_INTRA. Only one bitstream parsing position is listed herein for exemplary illustration only.

Added in front of intra_chroma_pred_mode, the specific syntax-element description is shown in Table 11.

TABLE 11

| | |
|---|---|
| if( lcu_act_enabled_flag ) { | |
| if( cbWidth / SubWidthC <= MaxTsSize && cbHeight / SubHeightC <= | |
| MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else { | |
| if(BvgpltEnabled ) | |
| bvgplt_flag | ae(v) |
| if( !bvgplt_flag) | |
| intra_chroma_pred_mode | ae(v) |
| } | |
| } | |
| } | |

If sps_ibc_enabled_flag is equal to 0 and sps_intratmp_enabled_flag is equal to 0, then BvgpltEnabled is equal to 0. Otherwise, the variable ModeIncludeBv is set, and if the corresponding luma block is not coded in a mode with BV information, the variable ModeIncludeBv is equal to 0; otherwise ModeIncludeBv equals 1. The syntax element signal sps_intraTmp_enabled_flag indicates whether or not the intraTmp technology is included in the coding tools of the reference platform; if included, the syntax element is transmitted; if not included, the syntax element is not transmitted. There may be an identifier of the BVG-PLT mode individually controlled by the SPS, and the bitstream table is an example. There may be no SPS control, and whether or not to apply the technique may be determined based on block-level constraints.

BvgpltEnabled is equal to 1 if multiple following conditions are true at the same time (including but not limited to the following conditions):
ModeIncludeBv equals 1;
Sh_slice_type is equal to I-frame; and
CtbLog2SizeC is less than or equal to MaxChromalbcSize.

MaxChromalbcSize may be determined based on a chroma CTU size or a preset value.

Otherwise, BvgpltEnabled is equal to 0.

BvgpltEnabled is equal to 0, then bvgplt_flag is inferred to be 0.

The bvgplt_flag of 1 indicates that the current chroma prediction mode is BVG-LUT, including but not limited to the following binarization manner, and may be coded by a context model or a bypass model. Exemplarily, as shown in Table 12, Table 13, Table 14, or Table 15. Here, FL denotes a fixed length.

TABLE 12

| | | |
|---|---|---|
| bvgplt_flag | FL | cMax = 1 |

TABLE 13

| Value of intra_chroma_pred_mode | Bin string |
|---|---|
| 0 | 100 |
| 1 | 101 |
| 2 | 110 |
| 3 | 111 |
| 4 | 0 |

TABLE 14

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| bvgplt_flag | 0 | na | na | na | na | na |
| intra_chroma_pred_mode | 0 | bypass | bypass | na | na | na |

Or:

TABLE 15

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| bvgplt_flag | bypass | na | na | na | na | na |
| intra_chroma_pred_mode | 0 | bypass | bypass | na | na | na |

Manner 2: Coding is performed in MODE_IBC, and a specific syntax-element description is shown in Table 16.

TABLE 16

| | |
|---|---|
| if(sh_slice_type!=I\|\|sps_ibc_enabled_flag) { | |
| if(treeType!=DUAL_TREE_CHROMA&& | |
| ((!(cbWidth==4&&cbHeight==4)&& | |
| modeType!=MODE_TYPE_INTRA)\|\| | |
| (sps_ibc_enabled_flag&&cbWidth<=64&&cbHeight<=64))) | |
| cu_skip_flag[x0][y0] | ae(v) |
| if(cu_skip_flag[x0][y0]==0&&sh_slice_type!=I&& | |
| !(cbWidth==4&&cbHeight==4)&&modeType==MODE_TYPE_ALL) | |
| pred_mode_flag | ae(v) |
| if(((sh_slice_type==I&&cu_skip_flag[x0][y0]==0)\|\| | |
| (sh_slice_type!=I&&(CuPredMode[chType][x0][y0]!=MODE_INTRA\|\|(((cbWidth==4&&c | |
| bHeight==4)\|\|modeType==MODE_TYPE_INTRA) | |
| &&cu_skip_flag[x0][y0]==0))))&&cbWidth<=64&&cbHeight<=64&&modeType!=MODE | |
| _TYPE_INTER&&sps_ibc_enabled_flag [symbol] ) | |
| if(treeType!=DUAL_TREE_CHROMA\|\| | |
| (treeType==DUAL_TREE_CHROMA&&BvgpltEnabled)){ | |
| pred_mode_ibc_flag | ae(v) |
| } | |
| } | |

If sps_ibc_enabled_flag is equal to 0 and sps_intratmp_enabled_flag is equal to 0, then BvgpltEnabled is equal to 0; otherwise, the variable ModeIncludeBv is set. If the corresponding luma block is not coded in the mode with BV information, the variable ModeIncludeBv is equal to 0; otherwise ModeIncludeBv equals 1.

BvgpltEnabled is equal to 1 if multiple following conditions are true at the same time (including but not limited to the following conditions):
ModeIncludeBv equals 1;
Sh_slice_type is equal to I-frame; and
CtbLog2SizeC is less than or equal to MaxChromaIbcSize.

MaxChromalbcSize may be determined based on a chroma CTU size or a preset value.

Otherwise BvgpltEnabled is equal to 0.

Under treeType==DUAL_TREE_CHROMA, BvgpltEnabled is equal to 0, then pred_mode_ibc_flag is inferred to be 0.

Under treeType==DUAL_TREE_CHROMA, pred_mode_ibc_flag is 1, which indicates that the current chroma prediction mode is BVG-LUT. Here, for the syntax element pred_mode_ibc_flag, the syntax description in the coding is shown in Table 17 and Table 18. Here, FL denotes a fixed length.

TABLE 17

| | | |
|---|---|---|
| pred_mode_ibc_flag | FL | cMax = 1 |

TABLE 18

| Initialization | ctxIdx of pred_mode_ibc_flag | | | | | | | | |
|---|---|---|---|---|---|---|---|---|---|
| variable | 0 | 1 | 2 | 3 | 4 | 5 | 6 | 7 | 8 |
| initValue | 17 | 42 | 36 | 0 | 57 | 44 | 0 | 43 | 45 |
| shiftIdx | 1 | 5 | 8 | 1 | 5 | 8 | 1 | 5 | 8 |

Both of the first and second manners correspond to the first scheme of the above-described embodiments.

### Scheme 2:

In the implementation, specific syntax-element descriptions are shown in Table 19.

TABLE 19

| | |
|---|---|
| if( !cu_act_enabled_flag ) { | |
| if(cbWidth / SubWidthC<=MaxTsSize&&cbHeight / SubHeightC | |
| <=MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| intra_chroma_pred_mode | ae(v) |
| } | |
| } | |

In addition, for different syntax elements (for example, cclm_mode_flag, cclm_mode_idx, intra_chroma_pred_mode, etc.), the coding method adopted by each coded bit is specifically shown in Table 20. For the value of the syntax element intra_chroma_pred_mode, its corresponding binarized string (Bin string) is shown in Table 21.

TABLE 20

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

TABLE 21

| Value of intra_chroma_pred_mode | Bin string |
|---|---|
| 0 | 100 |
| 1 | 101 |
| 2 | 110 |
| 3 | 111 |
| 4 | 0 |

The 0th bin of intra_chroma_pred_mode represents the DM mode, and the coding method is the same as that of VVC. The syntax element BvgpltEnabled is used to distinguish whether to apply, and “is applied” is used in decoding. The derivation process of BvgpltEnabled is as follows:
if sps_ibc_enabled_flag is equal to 0 and sps_intratmp_enabled flag is equal to 0, then BvgpltEnabled is equal to 0;
otherwise, BvgpltEnabled is equal to 1 if multiple following conditions are true at the same time (including but not limited to the following):
Sh_slice_type is equal to I-frame; and
CtbLog2SizeC is less than or equal to MaxChromalbcSize.

MaxChromalbcSize may be determined based on a chroma CTU size or a preset value.

If BvgpltEnabled equals 1:
when intra_chroma_pred_mode is equal to four chroma prediction modes 0, 1, 2, or 3, the four chroma prediction modes refer to Table 4; and when intra_chroma_pred_mode is equal to 4, Scheme 2 is implemented.

Otherwise, reference is made to the chroma prediction in the H.266 standard.

Further, in the embodiments of the present disclosure, a plurality of blocks in the co-located luma region are acquired, and the positions of the plurality of blocks include but are not limited to the following positions, as shown in FIG. 19. whether the plurality of blocks are available is determined in S2, candidates of the respective BVC candidate lists of the plurality of blocks are constructed in S3 based on luma BVs of the available blocks in the plurality of blocks, the availability of the BVs in the candidate list is determined respectively in S4, one BV or a plurality of BVs are decided in S5, a mapping table is established based on all the available chroma BVC of the plurality of blocks by S231 and S232 of S6, and the final predicted value is obtained according to the mapping table.

Further, in the embodiments of the present disclosure, a plurality of LUTs may be created, and the scheme of the selected LUT may be indicated by a syntax element. A plurality of blocks of the co-located luma region are acquired, and the positions of the plurality of blocks include but are not limited to the following positions, as shown in FIG. 19. Whether the plurality of blocks are available or not is determined in S2, candidates of the respective BVC candidate lists are constructed based on the luma BVs of the available blocks in the plurality of blocks in S3, the availability of the BVs in the candidate list is determined by the plurality of blocks in S4, one BV or a plurality of BVs are determined by the plurality of blocks in S5, a mapping table is established respectively based on the available chroma BVC of each of the plurality of blocks in S231 and S232 of S6, the coding end decides which mapping table to use based on RDO in S233 of S6 and transmits the decided mapping table to the decoding end through a syntax element identification, and the final predicted value is obtained based on the decided mapping table in S233 of S6. The number of mapping tables to be created can be set arbitrarily, and here, the number is set to 4 to explain the bitstream identifier.

For example, only one bitstream parsing position is listed here for illustration only, and the specific syntax description is shown in Table 22.

TABLE 22

| | |
|---|---|
| if( !cu_act_enabled_flag ) { | |
| if(cbWidth/SubWidthC<=MaxTsSize&&cbHeight / SubHeightC | |
| <= MaxTsSize && sps_bdpcm_enabled_flag ) | |
| intra_bdpcm_chroma_flag | ae(v) |
| if( intra_bdpcm_chroma_flag ) | |
| intra_bdpcm_chroma_dir_flag | ae(v) |
| else { | |
| if( CclmEnabled ) | |
| cclm_mode_flag | ae(v) |
| if( cclm_mode_flag ) | |
| cclm_mode_idx | ae(v) |
| else | |
| if(BvgpltEnabled ) | |
| bvgplt_flag | ae(v) |
| if(bvgplt_flag) | |
| lut_idx | ae(v) |
| if( !bvgplt_flag) | |
| intra_chroma_pred_mode | ae(v) |
| } | |
| } | |

Here, bvgplt_flag is true, indicating that the current chroma prediction mode is BVG-PLT, and lut_idx of the mapping table used for further coding includes, but is not limited to, the following binarization method, and may be coded by a context model or a bypass model. Exemplarily, as shown in Table 23, Table 24, or Table 25. Here, FL denotes a fixed length.

TABLE 23

| | | |
|---|---|---|
| lut_idx | FL | cMax = 2 |

TABLE 24

binIdx

| Syntax element | 0 | 1 | 2 | 3 | 4 | >=5 |
|---|---|---|---|---|---|---|
| lut_idx | 0 | 0 | na | na | na | na |

Or:

TABLE 25

| | binIdx | | | | | |
|---|---|---|---|---|---|---|
| Syntax element | 0 | 1 | 2 | 3 | 4 | >=5 |
| lut_idx | bypass | bypass | na | na | na | na |

Further, in the embodiments of the present disclosure, a plurality of LUTs may be established, and a template may be used to select which LUT is used. A plurality of blocks of a co-located luma region are acquired, and the positions of the plurality of blocks include but are not limited to the following positions, as shown in FIG. 19. Whether the plurality of blocks are available or not is determined in S2; candidates of respective BVC candidate lists of the plurality of blocks are constructed based on the luma BVs of the available blocks in the plurality of blocks in S3; the availability of the BVs in the candidate list is determined by the plurality of blocks in S4; one BV or a plurality of BVs are determined by the plurality of blocks in S5; a mapping table LUT is determined in S231 and S232 of S6; the template of the current block is subjected to prediction using different LUTs and a difference between a predicted value and a template reconstructed value to further decide which mapping table to use, all of the actions needing to be performed by both the coding and decoding ends; and the final predicted value is obtained based on the finally decided mapping table in S233 of S6. The number of mapping tables to be created may be arbitrarily set.

Here, the specific process of performing LUT prediction on the template of the current block is as follows: obtaining the reconstructed luma sample recBefDownLumaR at lumaPos=(xCbR, yCbR) which is the position of the co-located luma region template corresponding to the template of the current block, obtaining the down-sampled reconstructed luma sample recAftDownLumaR by the same down-sampling method on the luma sample in S231, and performing mapping processing in the same sample range as that in S232.

Assuming that the predicted value of the template of the current block is predSamplesR, then the variable cIdx in predSamplesR [cIdx] [x] [y] represents the color component index of the current block, and the following prediction method is adopted:
deriving the predicted value using the discrete mapping model established at S232 by referring to luma value Yc corresponding to the same position of the chroma component.

If Yc is not found in the input luma set in the discrete mapping model established in S232, the following processing methods include, but are not limited to: checking in the order of {Yc+1, Yc−1, Yc+2, Yc−2, Yc+3, Yc−3}, and if the model cannot match all the above values, setting the prediction to an average value of the reconstructed chroma sample recBvChroma at the corresponding BV.

Cost calculation is performed on the template of the current block and the template predicted value of each LUT: for template selection when calculating the cost, please refer to step (1) in the BV decision-making in S5 to perform template selection.

The usage of the template has the following situations when calculating cost:
the first type: both the upper template and the left template of the current block exist, and both the upper template and the left template are available;
the second type: only the upper template exists in the current block, and only the upper template is available;
the third type: only the left template exists in the current block, and only the left template is available; and
the fourth type: neither the upper template nor the left template of the current block exists, in which case, the final selected LUT is a first established LUT or a LUT at a specified position.

Assuming that the reconstructed value of the template of the current block is recSamplesR, there are a plurality of optional cost functions for calculating the template region cost, for example, such evaluation criteria as sum of absolute differences (SAD), sum of absolute transformed differences (SATD), sum of squared errors (SSE), mean absolute difference (MAD), mean absolute error (MAE), mean square error (MSE), and rate-distortion function (RDO) may be selected. One of the evaluation criteria mentioned in the embodiments of the present disclosure may be selected from the above criteria for cost calculation.

The final LUT is selected using the template of the current block: except for the case where the cost cannot be calculated, the cost of each established LUT candidate may be calculated and sorted in other cases. The sorting method includes but is not limited to bubble sorting, selection sorting, insertion sorting, hill sorting, merger sorting, quick sorting, cardinality sorting, heap sorting, count sorting, bucket sorting and other sorting methods. The LUT candidate having the lowest cost is selected as the finally used LUT, and prediction is performed in S233 of S6.

Further, in the embodiments of the present disclosure, a LUT may be established after upsampling chroma to align with luma. In step (1) of obtaining a luma sample of luma and chroma samples at the BV in S231 of S6: obtaining luma samples: only obtaining the reconstructed luma sample recBvBefDownLuma of the corresponding luma region, and not performing downsampling.

In step (2) of obtaining a chroma sample of luma and chroma samples at the BV in S231 of S6: after obtaining the reconstructed chroma sample recBvChroma at the BV corresponding to the current block, performing upsampling, including but not limited to linear interpolation, etc., to obtain the reconstructed chroma sample recBvChromaUp having the same size as the reconstructed luma sample at the BV.

The reconstructed luma sample recBvBefDownLuma and the reconstructed chroma sample recBvChromaUp at the BV may pass through S232 to establish a luma-to-chroma mapping table LUT at the BV.

A luma-to-chroma prediction is performed for the current block through S233 based on the reconstructed luma sample recBefDownLuma and LUT of the current block, and then the predicted value is downsampled to obtain the final chroma predicted value of the current block. The downsampling method includes but is not limited to average downsampling and the like.

Further, in the embodiments of the present disclosure, other modes may be used simultaneously in the embodiments. Under DM, in addition to this mode, the mode may compete with other modes. The final used mode is determined based on the template cost. For example, instead of directly using the BV obtained from the luma, it is possible to directly use the BV copy or use the mode defined in this disclosure. After both modes are applied to the template of the current block, the one with the lower template cost is selected as the prediction mode of the current block.

In the embodiments of the present disclosure, the specific implementation of the foregoing embodiments is described in detail above, from which it can be seen that the embodiments of the present disclosure are to propose a new chroma prediction method: on one hand, the advantages of the related art are fully utilized, the singularity of chroma prediction is improved, the information of a co-located luma region is fully utilized, and the accuracy of chroma prediction is effectively improved; on the other hand, a mapping table established for luma and chroma at a BV can effectively be used for pixel-level prediction, thus further improving the coding efficiency. That is, in the embodiments of the present disclosure, available information such as reconstructed luma and BV are fully considered, and prediction can be performed for chroma based on these information, thereby improving the singularity of chroma prediction; after a luma BV is obtained, a mapping table can be established for luma and chroma at the BV, which can effectively perform a pixel-level prediction, thus effectively performing accurate prediction of a chroma block, and further improving the coding efficiency.

In still another embodiment of the present disclosure, based on the same inventive concept as the above-described embodiments, see FIG. 24, which shows a schematic structure diagram of the composition of a coder provided by an embodiment of the present disclosure. As shown in FIG. 24, the coder 240 may include a first determination unit 2401, a first establishment unit 2402, and a first prediction unit 2403.

The first determination unit 2401 is configured to determine a first BV parameter of a current block.

The first establishment unit 2402 is configured to determine a first color-component reference sample and a second color-component reference sample corresponding to the current block based on the first BV parameter, and establish a mapping relationship between a first color component and a second color component based on the first color-component reference sample and the second color-component reference sample.

The first prediction unit 2403 is configured to determine a predicted value of the second color component of the current block based on the mapping relationship and a sample value of the first color component of the current block.

In some embodiments, the first determination unit 2401 is further configured to determine a first color component block of the current block; determine a second BV parameter of the first color component block when the prediction mode of the first color component block satisfies the first condition; and determine the first BV parameter of the current block based on the second BV parameter of the first color component block.

In some embodiments, the first determination unit 2401 is further configured to determine a first color component region at the same position as the current block; and determine the first color component block of the current block from a plurality of blocks divided from the first color component region.

In some embodiments, the first determination unit 2401 is further configured to determine at least one candidate block at a preset position from the plurality of blocks divided from the first color component region; and determine the first color component block of the current block from the at least one candidate block.

In some embodiments, the first determination unit 2401 is further configured to determine whether the current block uses a target prediction mode when the first color component block performs prediction based on a BV; and determine that the prediction mode of the first color component block satisfies the first condition in response to the current block using the target prediction mode.

In some embodiments, the first establishment unit 2402 is further configured to construct a BV parameter candidate list of the second color component of the current block based on the second BV parameter.

The first determination unit 2401 is further configured to determine the first BV parameter of the current block based on the BV parameter candidate list.

In some embodiments, the first establishment unit 2402 is further configured to adjust the second BV parameter to determine a candidate BV parameter of the second color component of the current block; and add the candidate BV parameters to the BV parameter candidate list.

In some embodiments, the first establishment unit 2402 is further configured to determine a preset sampling format of the current block; and scale the second BV parameter according to the preset sampling format to determine the candidate BV parameter of the second color component of the current block.

In some embodiments, the first establishment unit 2402 is further configured to determine a preset sampling format of the current block; scaling the second BV parameter according to the preset sampling format to determine a first initial BV parameter of the second color component of the current block; and perform an offset calculation on the first initial BV parameter based on one or more offset values to determine the candidate BV parameter of the second color component of the current block.

In some embodiments, the first establishment unit 2402 is further configured to determine one or more second initial BV parameters by performing an offset calculation on the second BV parameter based on one or more offset values; and determine a preset sampling format of the current block and scale the one or more second initial BV parameters according to the preset sampling format to determine the candidate BV parameter of the second color component of the current block.

In some embodiments, the first establishment unit 2402 is further configured to determine whether one or more candidate BV parameters satisfying the first available condition exist in the BV parameter candidate list; and in response to there being one or more candidate BV parameters satisfying the first available condition in the BV parameter candidate list, determine the first BV parameter of the current block based on the one or more candidate BV parameters.

In some embodiments, the first establishment unit 2402 is further configured to adjust at least one candidate BV parameter in the BV parameter candidate list until the at least one candidate BV parameter satisfies the first available condition in response to all candidate BVs in the BV parameter candidate list not satisfying the first available condition.

In some embodiments, the case of one or more candidate BV parameters satisfying the first available condition may at least include:
an offset position indicated based on the one or more candidate BV parameters does not exceed a picture boundary;
an offset position indicated based on the one or more candidate BV parameters does not exceed a slice boundary;
an offset position indicated based on the one or more candidate BV parameters does not cover the current block;
an offset position indicated based on the one or more candidate BV parameters does not exceed a preset available region; and
an offset position indicated based on the one or more candidate BV parameters has been reconstructed.

In some embodiments, the first establishment unit 2402 is further configured to: n response to there being one candidate BV parameter satisfying the first available condition in the BV parameter candidate list, determining the one candidate BV parameter satisfying the first available condition as the first BV parameter; and in response to there being a plurality of candidate BV parameters satisfying the first available condition in the BV parameter candidate list, make a decision on the plurality of candidate BV parameters satisfying the first available condition to determine the first BV parameter.

In some embodiments, the first determination unit 2401 is further configured to: determine a first template of the current block; determine a first matching template of each of the plurality of candidate BV parameters based on the first template and the plurality of candidate BV parameters; when the first template and the first matching template satisfy a second condition, calculate a matching error between the first template and the first matching template of the current block according to a preset error criterion to determine a first cost value for each of the plurality of candidate BV parameters; and determine a minimum cost value from the first cost values of the plurality of candidate BV parameters, and determine a candidate BV parameter corresponding to the minimum cost value as the first BV parameter.

In some embodiments, the first template may include at least one of following types: an upper template, an upper right template, a left template, a lower left template, or an upper left template. The upper template is located in a decoded region adjacent to and above the current block, the upper right template is located in a decoded region adjacent to and upper-right of the current block, the left template is located in a decoded region adjacent to and to left of the current block, the lower left template is located in a decoded region adjacent to and lower-left of the current block, and the upper left template is located in a decoded region adjacent to and upper-left of the current block.

In some embodiments, the first determination unit 2401 is further configured to: when the first template and the first matching template do not satisfy a second condition, determine a first candidate BV parameter that satisfies the first available condition in the BV parameter candidate list as the first BV parameter; alternatively, when the first template and the first matching template do not satisfy a second condition, determine a candidate BV parameter that satisfies the first available condition at a preset position in the BV parameter candidate list as the first BV parameter.

In some embodiments, the first determination unit 2401 is further configured to: determine a position of the current block; scale the position of the current block to determine a position of a first color component region at the same position of the current block; and scale the first BV parameter to determine a third BV parameter of the first color component region at the same position as the current block; determine a reference block of the first color component based on the position of the first color component region and the third BV parameter, and determine the first color-component reference sample corresponding to the current block based on the reference block of the first color component; and determine a reference block of the second color component based on the position of the current block and the first BV parameter, and determine the second color-component reference sample corresponding to the current block based on the reference block of the second color component.

In some embodiments, the first determination unit 2401 is further configured to: perform down-sampling processing on the reference block of the first color component, and determine the first color-component reference sample corresponding to the current block to make a resolution of the first color-component reference sample as same as a resolution of the second color-component reference sample.

In some embodiments, the first determination unit 2401 is further configured to perform upsampling processing on the reference block of the second color component, and determine the second color-component reference sample corresponding to the current block to make a resolution of the first color-component reference sample as same as a resolution of the second color-component reference sample.

Accordingly, the first prediction unit 2403 is further configured to downsample the predicted value of the second color component of the current block.

In some embodiments, the first determination unit 2401 is further configured to determine a first template of the current block; and determine the first color-component reference sample and the second color-component reference sample corresponding to the current block based on the first template.

In some embodiments, the first determination unit 2401 is further configured to determine a first template of the current block; determine a second matching template of the current block based on the first BV parameter and the first template; and determine the first color-component reference sample and the second color-component reference sample corresponding to the current block based on the second matching template.

In some embodiments, the first establishment unit 2402 is further configured to determine a first look-up table based on the first color-component reference sample and the second color-component reference sample, wherein the first look-up table is used to record a value of the second color component when an index key is the first color component.

In some embodiments, the first establishment unit 2402 is further configured to determine a first discrete model based on the first color-component reference sample and the second color-component reference sample, wherein the first discrete model is used to indicate the mapping relationship between the first color component and the second color component.

In some embodiments, the first establishment unit 2402 is further configured to perform mapping processing on the first color-component reference sample to make the first color-component reference sample locate in a preset sample range.

In some embodiments, when the first reference sample values in the first color-component reference samples are the same and correspond to a plurality of different second reference sample values in the second color-component reference samples, the first establishment unit 2402 is further configured to perform overwrite processing in sample order, and using a last second reference sample value as a value having a mapping relationship with the first reference sample values.

In some embodiments, when the first reference sample values in the first color-component reference sample are the same and correspond to a plurality of different second reference sample values in the second color-component reference sample, the first establishment unit 2402 is further configured to calculate an average value of the plurality of different second reference sample values, and use the obtained average value as a value having a mapping relationship with the first reference sample values.

In some embodiments, the first determination unit 2401 is further configured to determine a reconstructed pixel sample of the first color component region at the same position as the current block; and determine the sample value of the first color component of the current block based on the reconstructed pixel sample of the first color component region.

In some embodiments, the first prediction unit 2403 is further configured to: in response to finding a value of the first color component equal to the sample value of the first color component in the mapping relationship, determining a value of the second color component corresponding to the value of the first color component as the predicted value of the second color component of the current block.

In some embodiments, the first prediction unit 2403 is further configured to: in response to failing to find the value of the first color component equal to the sample value of the first color component in the mapping relationship, perform correction processing on the sample value of the first color component to determine a corrected value of the first color component, and continue to search whether there is a value of the first color component equal to the corrected value of the first color component in the mapping relationship.

In some embodiments, the first prediction unit 2403 is further configured to perform an offset calculation on the sample value of the first color component based on one or more preset offset values, and determine the corrected value of the first color component.

In some embodiments, the first prediction unit 2403 is further configured to: in response to failing to find the value of the first color component equal to the corrected value of the first color component in the mapping relationship, calculate an average value for the second color-component reference sample, and determine the average value as the predicted value of the second color component of the current block.

In some embodiments, the first prediction unit 2403 is further configured to determine a first initial predicted value of the second color component of the current block based on the mapping relationship and the sample value of the first color component of the current block; and perform a correction operation on the first initial predicted value to determine the predicted value of the second color component of the current block.

In some embodiments, the first prediction unit 2403 is further configured to: perform prediction processing on the second color component of the current block based on the first preset mode to determine a second initial predicted value of the second color component of the current block, wherein the first preset mode includes at least one of the following: a PLANAR mode, a DM mode, a DC mode, or a CCLM mode; and perform a weighting calculation on the first initial predicted value and the second initial predicted value to determine the predicted value of the second color component of the current block.

In some embodiments, the first prediction unit 2403 is further configured to: determine a plurality of third initial predicted values of the second color component of the current block when the number of the first BV parameters is more than one; and perform a weighting calculation on the plurality of third initial predicted values to determine the predicted value of the second color component of the current block.

In some embodiments, the first prediction unit 2403 is further configured to: determine a second BV parameter for each of the plurality of candidate blocks when the first color component block of the current block includes a plurality of candidate blocks; construct a plurality of BV parameter candidate lists of the second color component of the current block based on the second BV parameters of the plurality of candidate blocks, and determine a plurality of first BV parameters of the second color component of the current block based on the plurality of BV parameter candidate lists; establish the mapping relationship between the first color component and the second color component based on the plurality of first BV parameters; and determine the predicted value of the second color component of the current block based on the mapping relationship and the sample value of the first color component of the current block.

In some embodiments, the first prediction unit 2403 is further configured to determine a plurality of sets of first color-component reference samples and second color-component reference samples corresponding to the current block based on the plurality of first BV parameters; establish a plurality of candidate mapping relationships between the first color component and the second color component based on the plurality of sets of the first color-component reference samples and the second color-component reference samples corresponding to the current block; determine a target mapping relationship from the plurality of candidate mapping relationships; and determining the predicted value of the second color component of the current block according to the target mapping relationship and the sample value of the first color component of the current block.

In some embodiments, the first determination unit 2401 is further configured to: perform cost calculations on the plurality of candidate mapping relationships based on a rate-distortion cost method, and determine a plurality of rate-distortion cost results; and determining a minimum rate-distortion cost result from the plurality of rate-distortion cost results, and determine a candidate mapping relationship corresponding to the minimum rate-distortion cost result as the target mapping relationship.

In some embodiments, referring to FIG. 24, the coder 240 may further include a coding unit 2404.

The first determination unit 2401 is further configured to determine mapping relationship index values, wherein the mapping relationship index value is used to indicate the candidate mapping relationship corresponding to the minimum rate-distortion cost result among the plurality of rate-distortion cost results;

The coding unit 2404 is configured to code the mapping relationship index values and write the obtained coded bits into a bitstream.

In some embodiments, the first prediction unit 2403 is further configured to determine a plurality of sets of first color-component reference samples and second color-component reference samples corresponding to the current block based on the plurality of first BV parameters; establish a plurality of candidate mapping relationships between the first color component and the second color component based on the plurality of sets of the first color-component reference samples and the second color-component reference samples corresponding to the current block; perform a matching error calculation on the plurality of candidate mapping relationships based on the template matching method to determine a second cost value of each of the plurality of candidate mapping relationships; and determine a minimum cost value from the second cost values of the plurality of candidate mapping relationships, and determine a candidate mapping relationship corresponding to the minimum cost value as a target mapping relationship; and determine the predicted value of the second color component of the current block according to the target mapping relationship and the sample value of the first color component of the current block.

In some embodiments, the first determination unit 2401 is further configured to: determine a first template of the current block; determine reconstructed pixel sample values of a first color-component-region template at a same position as the first template; determine predicted values of respective second color components of the first template under the plurality of mapping relationships based on the plurality of candidate mapping relationships and the reconstructed pixel sample values of the first color-component-region template; and perform cost calculations based on reconstructed values of the second color components of the first template and the predicted values of the respective second color components of the first template under the plurality of candidate mapping relationships, and determine respective second cost values of the plurality of candidate mapping relationships.

In some embodiments, the first determination unit 2401 is further configured to: determine a prediction mode of the current block; and perform the action of determining the first BV parameter of the current block when the prediction mode indicates that the second color component of the current block uses the target prediction mode.

In some embodiments, the first determination unit 2401 is further configured to: determine a plurality of candidate modes, the plurality of candidate modes including at least the target prediction mode; perform cost calculations on a plurality of candidate modes respectively based on a preset cost mode to determine a plurality of third cost values; and determine a minimum cost value from the plurality of third cost values, and determine a candidate mode corresponding to the minimum cost value as the prediction mode of the current block, wherein the preset cost mode includes at least one of the following: a rate-distortion cost mode or a template matching mode.

In some embodiments, the first determination unit 2401 is further configured to: determine a first color component region at the same position of the current block; and determine that the second color component of the current block uses the target prediction mode in response to the current block using a DM mode and the first color component region being predicted based on the BV.

In some embodiments, the first determination unit 2401 is further configured to determine a value of first syntax element identification information, wherein the first syntax element identification information is used to indicate whether the second color component of the current block uses the target prediction mode.

The coding unit 2404 is further configured to code the value of the first syntax element identification information, and write the obtained coded bits into the bitstream.

In some embodiments, the first determination unit 2401 is further configured to determine a value of second syntax element identification information, wherein the second syntax element identification information is used to indicate whether the second color component of the current block is allowed to use the target prediction mode.

The coding unit 2404 is further configured to code the value of the second syntax element identification information and write the obtained coded bits into the bitstream.

It can be understood that in the embodiments of the present disclosure, the “unit” may be a part of a circuit, a part of a processor, a part of a program or software, etc., and of course, it may also be a module, or may be non-modular. Moreover, in the present embodiments, each component may be integrated in one processing unit, each unit may physically exist separately, or two or more units may be integrated in one unit. The above-described integrated unit may be implemented in the form of hardware or software functional modules.

Based on the understanding that the integrated unit may be stored in a computer-readable storage medium if it is implemented in the form of a software functional module and not sold or used as an independent product. The technical solution of the embodiments essentially or contributes to the prior art or all or part of the technical solution may be embodied in the form of a software product stored in a storage medium and comprises several instructions for causing a computer device (which may be a personal computer, a server, a network device, etc.) or a processor to perform all or part of the steps of the methods described in the embodiments. The storage medium includes a USB disk, a removable hard disk, a Read Only Memory (ROM), a Random Access Memory (RAM), a magnetic disk, an optical disk, and various media capable of storing program codes.

Accordingly, an embodiment of the present disclosure provides a computer-readable storage medium applied to the coder 240, and the computer-readable storage medium stores a computer program that, when executed by a first processor, implements the method of any one of the preceding embodiments.

Based on the composition of the coder 240 and the computer-readable storage medium, see FIG. 25, which shows a schematic diagram of a specific hardware structure of the coder 240 provided by an embodiment of the present disclosure. As shown in FIG. 25, the coder 240 may include: a first communication interface 2501, a first memory 2502, and a first processor 2503. The various components are coupled together by a first bus system 2504. It will be appreciated that the first bus system 2504 is used to enable connected communication between these components. The first bus system 2504 includes a power bus, a control bus, and a status signal bus in addition to a data bus. However, for the sake of clarity of illustration, various buses are designated as first bus system 2504 in FIG. 25.

The first communication interface 2501 is configured to receive and transmit signals in the process of transmitting and receiving information with other external network elements.

A first memory 2502 is configured to store a computer program that can be executed in the first processor 2503.

A first processor 2503 is configured to, when running the computer program, perform actions of:
determining a first BV parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
determining a predicted value of the second color component of the current block based on the mapping relationship and a sample value of the first color component of the current block.

It is understood that the first memory 2502 in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), and Direct Rambus RAM (DRRAM). The first memory 2502 of the systems and methods described herein is intended to include, but is not limited to, these and any other suitable type of memory.

The first processor 2503 may be an integrated circuit chip having signal processing capabilities. In implementation, the steps of the above-described method may be accomplished by integrated logic circuitry of hardware in the first processor 2503 or instructions in the form of software. The above-described first processor 2503 may be a general-purpose processor, a Digital Signal Processor (DSP), an Application Specific Integrated Circuit (ASIC), an off-the-shelf Field Programmable Gate Array (FPGA) or other programmable logic device, a discrete gate or transistor logic device, or a discrete hardware component. The methods, steps, and logical block diagrams described in the embodiments of the present disclosure may be implemented or executed. The general purpose processor may be a microprocessor or the processor may be any conventional processor or the like. The steps of the method described in connection with the embodiments of the present disclosure may be directly embodied as execution by the hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the first memory 2502, and the first processor 2503 is configured to read the information in the first memory 2502, and complete the steps of the above method in combination with its hardware.

It will be appreciated that the embodiments described herein may be implemented in hardware, software, firmware, middleware, microcode, or a combination thereof. For hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general purpose processors, controllers, microcontrollers, microprocessors, other electronic units for performing the functions described herein, or combinations thereof. For software implementations, the techniques described herein may be implemented by modules (e.g., procedures, functions, etc.) that perform the functions described herein. The software code may be stored in a memory and executed by a processor. The memory may be implemented in the processor or external to the processor.

Optionally, as another embodiment, the first processor 2503 is further configured to execute the method of any one of the preceding embodiments when running the computer program.

The present embodiment provides a coder, in which the singularity of chroma prediction can be improved, the related information of a column luma block can be fully utilized, and the accuracy of chroma prediction can be improved. Furthermore, according to the established mapping relationship, pixel-level prediction can be effectively carried out, thus further reducing the bit rate, improving the codec efficiency, and then improving the codec performance.

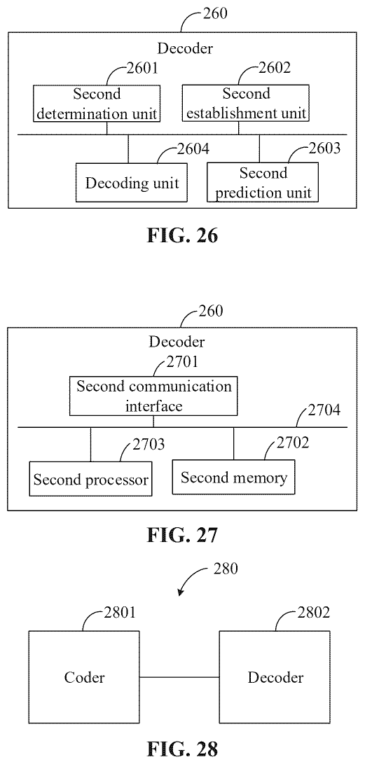

In still another embodiment of the present disclosure, based on the same inventive concept as the above-described embodiments, see FIG. 26, which shows a schematic structure diagram of a decoder provided by an embodiment of the present disclosure. As shown in FIG. 26, the decoder 260 may include a second determination unit 2601, a second establishment unit 2602, and a second prediction unit 2603.

The second determination unit 2601 is configured to determine a first BV parameter of a current block.

The second establishment unit 2602 is configured to determine a first color-component reference sample and a second color-component reference sample corresponding to the current block based on the first BV parameter, and establish a mapping relationship between a first color component and a second color component based on the first color-component reference sample and the second color-component reference sample.

The second prediction unit 2603 is configured to determine a predicted value of the second color component of the current block based on the mapping relationship and a sample value of the first color component of the current block.

In some embodiments, the second determination unit 2601 is further configured to determine a first color component block of the current block; determine a second BV parameter of the first color component block when the prediction mode of the first color component block satisfies the first condition; and determine the first BV parameter of the current block based on the second BV parameter of the first color component block.

In some embodiments, the second determination unit 2601 is further configured to: determine a first color component region at the same position as the current block; and determining the first color component block of the current block from a plurality of blocks divided from the first color component region.

In some embodiments, the second determination unit 2601 is further configured to: determine at least one candidate block at a preset position from the plurality of blocks divided from the first color component region; and determine, from the at least one candidate block, the first color component block of the current block.

In some embodiments, the second determination unit 2601 is further configured to: when the first color component block performs prediction based on a BV, determining whether the current block uses a target prediction mode; and in response to the current block using the target prediction mode, determining that the prediction mode of the first color component block satisfies the first condition.

In some embodiments, the second establishment unit 2602 is further configured to construct a BV parameter candidate list of the second color component of the current block based on the second BV parameter.

The second determination unit 2601 is further configured to determine the first BV parameter of the current block based on the BV parameter candidate list.

In some embodiments, the second establishment unit 2602 is further configured to: adjust the second BV parameter to determine a candidate BV parameter of the second color component of the current block; and add the candidate BV parameter to the BV parameter candidate list.

In some embodiments, the second establishment unit 2602 is further configured to: determine a preset sampling format of the current block; and scale the second BV parameter according to the preset sampling format to determine the candidate BV parameter of the second color component of the current block.

In some embodiments, the second establishment unit 2602 is further configured to: determine a preset sampling format of the current block; scale the second BV parameter according to the preset sampling format to determine a first initial BV parameter of the second color component of the current block; and perform an offset calculation on the first initial BV parameter based on one or more offset values to determine the candidate BV parameters for the second color component of the current block.

In some embodiments, the second establishment unit 2602 is further configured to: perform an offset calculation on the second BV parameter based on one or more offset values to determine one or more second initial BV parameters; and determine a preset sampling format of the current block and scale the one or more second initial BV parameters according to the preset sampling format to determine candidate BV parameter of the second color component of the current block.

In some embodiments, the second establishment unit 2602 is further configured to: determine whether one or more candidate BV parameters satisfying the first available condition exist in the BV parameter candidate list; and in response to there being one or more candidate BV parameters satisfying the first available condition in the BV parameter candidate list, determine the first BV parameter of the current block based on the one or more candidate BV parameters.

In some embodiments, the second establishment unit 2602 is further configured to adjust at least one candidate BV parameter in the BV parameter candidate list until the at least one candidate BV parameter satisfies the first available condition in response to all candidate BVs in the BV parameter candidate list not satisfying the first available condition.

In some embodiments, the case of one or more candidate BV parameters satisfying the first available condition may at least include:
an offset position indicated based on the one or more candidate BV parameters does not exceed a picture boundary;
an offset position indicated based on the one or more candidate BV parameters does not exceed a slice boundary;
an offset position indicated based on the one or more candidate BV parameters does not cover the current block;
an offset position indicated based on the one or more candidate BV parameters does not exceed a preset available region; and
an offset position indicated based on the one or more candidate BV parameters has been reconstructed.

In some embodiments, the second establishment unit 2602 is further configured to: in response to there being one candidate BV parameter satisfying the first available condition in the BV parameter candidate list, determining the one candidate BV parameter satisfying the first available condition as the first BV parameter; and in response to there being a plurality of candidate BV parameters satisfying the first available condition in the BV parameter candidate list, make a decision on the plurality of candidate BV parameters satisfying the first available condition to determine the first BV parameter.

In some embodiments, the second determination unit 2601 is further configured to: determine a first template of the current block; determine a first matching template for each of the plurality of candidate BV parameters based on the first template and the plurality of candidate BV parameters; when the first template and the first matching template satisfy the second condition, calculate a matching error between the first template and the first matching template of the current block according to a preset error criterion to determine a first cost value of each of the plurality of candidate BV parameters; and determine a minimum cost value from the first cost values of the plurality of candidate BV parameters, and determine the candidate BV parameter corresponding to the minimum cost value as the first BV parameter.

In some embodiments, the first template may include at least one of following types: an upper template, an upper right template, a left template, a lower left template, or an upper left template. The upper template is located in a coded region adjacent to and above the current block, the upper right template is located in a coded region adjacent to and upper-right of the current block, the left template is located in a coded region adjacent to and to left of the current block, the lower left template is located in a coded region adjacent to and lower-left of the current block, and the upper left template is located in a coded region adjacent to and upper-left of the current block.

In some embodiments, the second determination unit 2601 is further configured to: when the first template and the first matching template do not satisfy a second condition, determining a first candidate BV parameter that satisfies the first available condition in the BV parameter candidate list as the first BV parameter; alternatively, when the first template and the first matching template do not satisfy a second condition, determining a candidate BV parameter that satisfies the first available condition at a preset position in the BV parameter candidate list as the first BV parameter.

In some embodiments, the second determination unit 2601 is further configured to: determine a position of the current block; scale the position of the current block to determine a position of a first color component region at the same position of the current block, and scale the first BV parameter to determine a third BV parameter of the first color component region at the same position of the current block; determine a reference block of the first color component based on the position of the first color component region and the third BV parameter, and determine the first color-component reference sample corresponding to the current block based on the reference block of the first color component; and determine a reference block of the second color component based on the position of the current block and the first BV parameter, and determine the second color-component reference sample corresponding to the current block based on the reference block of the second color component.

In some embodiments, the second determination unit 2601 is further configured to: perform down-sampling processing on the reference block of the first color component, and determine the first color-component reference sample corresponding to the current block to make a resolution of the first color-component reference sample as same as a resolution of the second color-component reference sample.

In some embodiments, the second determination unit 2601 is further configured to perform upsampling processing on the reference block of the second color component, and determine the second color-component reference sample corresponding to the current block to make a resolution of the first color-component reference sample as same as a resolution of the second color-component reference sample.

Accordingly, the second prediction unit 2603 is further configured to downsampling the predicted value of the second color component of the current block.

In some embodiments, the second determination unit 2601 is further configured to determine a first template of the current block, and determine the first color-component reference sample and the second color-component reference sample corresponding to the current block based on the first template.

In some embodiments, the second determination unit 2601 is further configured to: determine a first template of the current block; determine a second matching template of the current block based on the first BV parameter and the first template; and determine the first color-component reference sample and the second color-component reference sample corresponding to the current block based on the second matching template.

In some embodiments, the second establishment unit 2602 is further configured to determine a first look-up table based on the first color-component reference sample and the second color-component reference sample, wherein the first look-up table is used to record a value of the second color component when an index key is the first color component.

In some embodiments, the second establishment unit 2602 is further configured to determine a first discrete model based on the first color-component reference sample and the second color-component reference sample, wherein the first discrete model is used to indicate the mapping relationship between the first color component and the second color component.

In some embodiments, the second establishment unit 2602 is further configured to perform mapping processing on the first color-component reference sample to make the first color-component reference sample locate in a preset sample range.

In some embodiments, the second establishment unit 2602 is further configured to: when the first reference sample values in the first color-component reference samples are the same and correspond to a plurality of different second reference sample values in the second color-component reference samples, perform overwrite processing in sample order, and using a last second reference sample value as a value having a mapping relationship with the first reference sample values.

In some embodiments, the second establishment unit 2602 is further configured to: when first reference sample values in the first color-component reference sample are the same and correspond to a plurality of different second reference sample values in the second color-component reference sample, calculate an average value of the plurality of different second reference sample values, and use the average value as a value having a mapping relationship with the first reference sample values.

In some embodiments, the second determination unit 2601 is further configured to: determine a reconstructed pixel sample of the first color component region at the same position as the current block; and determine the sample value of the first color component of the current block based on the reconstructed pixel sample of the first color component region.

In some embodiments, the second prediction unit 2603 is further configured to: in response to finding a value of the first color component equal to the sample value of the first color component in the mapping relationship, determine a value of the second color component corresponding to the value of the first color component as the predicted value of the second color component of the current block.

In some embodiments, the second prediction unit 2603 is further configured to, in response to failing to find the value of the first color component equal to the sample value of the first color component in the mapping relationship, perform correction processing on the sample value of the first color component to determine a corrected value of the first color component, and continue to search whether a value of the first color component equal to the corrected value of the first color component exists in the mapping relationship.

In some embodiments, the second prediction unit 2603 is further configured to perform an offset calculation on the sample value of the first color component based on one or more preset offset values, and determine the corrected value of the first color component.

In some embodiments, the second prediction unit 2603 is further configured to: in response to failing to find the value of the first color component equal to the corrected value of the first color component in the mapping relationship, calculate an average value for the second color-component reference sample, and determine the average value as the predicted value of the second color component of the current block.

In some embodiments, the second prediction unit 2603 is further configured to: determine a first initial predicted value of the second color component of the current block based on the mapping relationship and the sample value of the first color component of the current block; and perform a correction operation on the first initial predicted value to determine a predicted value of the second color component of the current block.

In some embodiments, the second prediction unit 2603 is further configured to: perform prediction processing on the second color component of the current block based on the first preset mode, and determine a second initial predicted value of the second color component of the current block, wherein the first preset mode includes at least one of the following: a PLANAR mode, a DM mode, a DC mode, or a CCLM mode; and perform a weighting calculation on the first initial predicted value and the second initial predicted value to determine the predicted value of the second color component of the current block.

In some embodiments, the second prediction unit 2603 is further configured to: determine a plurality of third initial predicted values of the second color component of the current block when the number of the first BV parameters is more than one; and perform a weighting calculation on the plurality of third initial predicted values to determine the predicted value of the second color component of the current block.

In some embodiments, the second prediction unit 2603 is further configured to: determine a second BV parameter for each of the plurality of candidate blocks when the first color component block of the current block includes a plurality of candidate blocks; construct a plurality of BV parameter candidate lists of the second color component of the current block based on the second BV parameters of the plurality of candidate blocks, and determine a plurality of first BV parameters of the second color component of the current block based on the plurality of BV parameter candidate lists; establish the mapping relationship between the first color component and the second color component based on the plurality of first BV parameters, and determine the predicted value of the second color component of the current block based on the mapping relationship and the sample value of the first color component of the current block.

In some embodiments, referring to FIG. 26, decoder 260 may further include a decoding unit 2604.

The second determination unit 2601 is further configured to determine a plurality of sets of first color-component reference samples and second color-component reference samples corresponding to the current block based on the plurality of first BV parameters; and establish a plurality of candidate mapping relationships between the first color component and the second color component based on the plurality of sets of the first color-component reference samples and the second color-component reference samples corresponding to the current block.

A decoding unit 2604 configured to decode a bitstream and determine mapping relationship index values;

A second prediction unit 2603 further configured to: determine a target mapping relationship based on the mapping relationship index values and the plurality of candidate mapping relationships; and determine the predicted value of the second color component of the current block according to the target mapping relationship and the sample value of the first color component of the current block.

In some embodiments, the second prediction unit 2603 is further configured to: determining a plurality of sets of first color-component reference samples and second color-component reference samples corresponding to the current block based on the plurality of first BV parameters; establish a plurality of candidate mapping relationships between the first color component and the second color component based on the plurality of sets of the first color-component reference samples and the second color-component reference samples corresponding to the current block; perform a matching error calculation on the plurality of candidate mapping relationships based on a template matching method to determine a second cost value of each of the plurality of candidate mapping relationships; determine a minimum cost value from the second cost values of the plurality of candidate mapping relationships, and determine a candidate mapping relationship corresponding to the minimum cost value as a target mapping relationship; and determine the predicted value of the second color component of the current block according to the target mapping relationship and the sample value of the first color component of the current block.

In some embodiments, the second determination unit 2601 is further configured to: determine a first template of the current block; determine reconstructed pixel sample values of a first color-component-region template at a same position as the first template; determine predicted values of respective second color components of the first template under the plurality of candidate mapping relationships based on the plurality of candidate mapping relationships and the reconstructed pixel sample values of the first color-component-region template; and perform cost calculations based on reconstructed values of the second color components of the first template and the predicted values of the respective second color components of the first template under the plurality of candidate mapping relationships to determine respective second cost values of the plurality of candidate mapping relationships.

In some embodiments, the decoding unit 2604 is further configured to decode a bitstream and determine a value of first syntax element identification information.

The second determination unit 2601 is further configured to perform the action of determining the first BV parameter of the current block when the first syntax element identification information indicates that the second color component of the current block uses the target prediction mode.

In some embodiments, the second determination unit 2601 is further configured to determine a first color component region at the same position as the current block, and determine that the second color component of the current block uses the target prediction mode in response to the current block using a DM mode and the first color component region being predicted based on a BV.

In some embodiments, the decoding unit 2604 is further configured to decode the bitstream and determine a value of second syntax element identification information.

The second determination unit 2601 is further configured to perform the action of decoding the bitstream and determining the value of first syntax element identification information in response to the second syntax element identification information indicating that the second color component of the current block is allowed to use the target prediction mode.

It can be understood that in the present embodiment, the “unit” may be a partial circuit, a partial processor, a partial program or software, or the like, and may of course be a module, or may be non-modular. Moreover, in this embodiment, each component may be integrated in one processing unit, each unit may physically exist separately, or two or more units may be integrated in one unit. The above-described integrated unit may be implemented in the form of hardware or software functional modules.

The integrated unit may be stored in a computer-readable storage medium if implemented in the form of software functional modules and not marketed or used as a stand-alone product. Based on this understanding, the present embodiment provides a computer-readable storage medium for application to the decoder 260, the computer-readable storage medium storing a computer program that, when executed by a second processor, implements the method of any of the preceding embodiments.

Based on the composition of the decoder 260 and the computer-readable storage medium, see FIG. 27, which shows a schematic diagram of a specific hardware structure of the decoder 260 provided by an embodiment of the present disclosure. As shown in FIG. 27, the decoder 260 may include: a second communication interface 2701, a second memory 2702, and a second processor 2703. The various components are coupled together by a second bus system 2704. It will be appreciated that the second bus system 2704 is used to enable connected communication between these components. The second bus system 2704 includes a power bus, a control bus, and a status signal bus in addition to a data bus. However, for the sake of clarity of illustration, various buses are designated as second bus system 2704 in FIG. 27. Wherein,

The second communication interface 2701 is configured to receive and transmit signals in the process of transmitting and receiving information with other external network elements.

The second memory 2702 is configured to store a computer program capable of running on the second processor 2703.

The second processor 2703 is configured to, when running the computer program, perform actions of:
determining a first BV parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
based on the mapping relationship and a sample value of the first color component of the current block, determining a predicted value of the second color component of the current block.

Optionally, as another embodiment, the second processor 2703 is further configured to execute the method of any one of the preceding embodiments when running the computer program.

It can be understood that the second memory 2702 has a hardware function similar to that of the first memory 2502, and that the second processor 2703 has a hardware function similar to that of the first processor 2503. It is not detailed here.

The present embodiment provides the decoder, in which the singularity of chroma prediction can be improved, the related information of a column luma block can be fully utilized, and the accuracy of chroma prediction can be improved. Furthermore, according to the established mapping relationship, pixel-level prediction can be effectively carried out, thus further reducing the bit rate, improving the codec efficiency, and then improving the codec performance.

In still another embodiment of the present disclosure, see FIG. 28, which shows a schematic structure diagram of a codec system provided by an embodiment of the present disclosure. As shown in FIG. 28, the codec system 280 may include a coder 2801 and a decoder 2802.

In the embodiment of the present disclosure, the coder 2801 may be the coder described in any one of the preceding embodiments, and the decoder 2802 may be the decoder described in any one of the preceding embodiments.

It should be noted that, in the present disclosure, the terms “comprising,” “including,” or any other variation thereof are intended to encompass a non-exclusive inclusion such that a process, method, article, or apparatus including a series of elements have not only those elements but also other elements which are not explicitly listed, or elements inherent to such a process, method, article, or apparatus. Without further limitation, an element defined by the statement “comprising a” does not preclude the presence of additional identical elements in a process, method, article, or apparatus that includes the element.

The above-described serial numbers of the embodiments of the present disclosure are for description only, and do not represent the advantages and disadvantages of the embodiments.

The methods described in several method embodiments provided in the present disclosure can be arbitrarily combined without conflict to obtain new method embodiments.

The features described in several product embodiments provided herein can be arbitrarily combined without conflict to give new product embodiments.

The features described in several method or device embodiments provided in the present disclosure can be arbitrarily combined without conflict to obtain new method or device embodiments.

The above are merely specific embodiments of the present disclosure, but the scope of protection of the present disclosure is not limited thereto, and any person skilled in the art can easily think of changes or substitutions within the technical scope disclosed in the present disclosure, and should be covered within the scope of protection of the present disclosure. Therefore, the scope of protection of the present disclosure should be based on the scope of protection of the claims.

### INDUSTRIAL PRACTICALITY

In the embodiments of the present disclosure, the coding end or the decoding end first determines a first BV parameter of a current block, then determines a first color-component reference sample and a second color-component reference sample corresponding to the current block based on the first BV parameter, and establishes a mapping relationship between a first color component and a second color component based on the first color-component reference sample and the second color-component reference sample; then, based on the mapping relationship and the sample value of the first color component of the current block, determines a predicted value of the second color component of the current block. In this way, if prediction for the luma block corresponding to the current block is performed based on a BV, the first BV parameter to which the chroma component is applied may be determined based on the BV parameter of the luma block, and a mapping relationship between the luma component and the chroma component may be established according to the luma component reference sample and the chroma component reference sample at the first BV parameter, and then prediction for the chroma component may be performed using the mapping relationship. That is, the coding and decoding methods proposed in the embodiments of the present disclosure improve the singularity of chroma prediction, make full use of relevant information of a co-located luma block, and can improve the accuracy of chroma prediction. Moreover, according to the established mapping relationship, pixel-level prediction can be effectively carried out, thus further reducing the bit rate, improving the codec efficiency, and then improving the codec performance.

1. A decoding method, applied to a decoder, comprising:
determining a first block vector (BV) parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
determining a predicted value of the second color component of the current block based on the mapping relationship and a sample value of the first color component of the current block.

2. The method of claim 1, wherein the determining a first BV parameter of a current block comprises:
determining a first color component block of the current block;
determining a second BV parameter of the first color component block when a prediction mode of the first color component block satisfies a first condition; and
determining the first BV parameter of the current block based on the second BV parameter of the first color component block.

3. The method of claim 2, wherein the determining a first color component block of the current block comprises:
determining a first color component region at a same position as the current block; and
determining the first color component block of the current block from a plurality of blocks divided from the first color component region.

4. The method of claim 3, wherein the determining the first color component block of the current block from a plurality of blocks divided from the first color component region comprises:
determining at least one candidate block at a preset position from the plurality of blocks divided from the first color component region; and
determining the first color component block of the current block from the at least one candidate block.

5. The method of claim 2, further comprising:
when the first color component block performs prediction based on a BV, determining whether the current block uses a target prediction mode; and
in response to the current block using the target prediction mode, determining that the prediction mode of the first color component block satisfies the first condition.

6. The method of claim 2, wherein the determining the first BV parameter of the current block based on the second BV parameter of the first color component block comprises:
constructing a BV parameter candidate list of the second color component of the current block based on the second BV parameter; and
determining the first BV parameter of the current block based on the BV parameter candidate list.

7. The method of claim 6, wherein the constructing a BV parameter candidate list of the second color component of the current block based on the second BV parameter comprises:
adjusting the second BV parameter to determine a candidate BV parameter of the second color component of the current block; and
adding the candidate BV parameter to the BV parameter candidate list.

8. The method of claim 7, wherein the adjusting the second BV parameter to determine a candidate BV parameter of the second color component of the current block comprises:
determining a preset sampling format for the current block; and
scaling the second BV parameter according to the preset sampling format to determine the candidate BV parameter of the second color component of the current block.

9. The method of claim 6, wherein the determining the first BV parameter of the current block based on the BV parameter candidate list comprises:
determining whether the BV parameter candidate list has one or more candidate BV parameters satisfying the first available condition; and
in response to there being one or more candidate BV parameters satisfying the first available condition in the BV parameter candidate list, determining the first BV parameter of the current block based on the one or more candidate BV parameters.

10. The method of claim 9, wherein the determining the first BV parameter of the current block from the one or more candidate BV parameters comprises:
in response to there being one candidate BV parameter satisfying the first available condition in the BV parameter candidate list, determining the one candidate BV parameter satisfying the first available condition as the first BV parameter; and
in response to there being a plurality of candidate BV parameters satisfying the first available condition in the BV parameter candidate list, making a decision on the plurality of candidate BV parameters satisfying the first available condition to determine the first BV parameter.

11. The method of claim 10, wherein the making a decision on the plurality of candidate BV parameters satisfying the first available condition to determine the first BV parameter comprises:
determining a first template for the current block;
determining a first matching template for each of the plurality of candidate BV parameters based on the first template and the plurality of candidate BV parameters;
when the first template and the first matching template satisfy a second condition, calculating a matching error between the first template of the current block and the first matching template according to a preset error criterion to determine a first cost value for each of the plurality of candidate BV parameters; and
determining a minimum cost value from the first cost values of the plurality of candidate BV parameters, and determining a candidate BV parameter corresponding to the minimum cost value as the first BV parameter.

12. The method of claim 1, wherein the determining a first color-component reference sample and a second color-component reference sample corresponding to the current block based on the first BV parameter comprises:
determining a position of the current block;
scaling the position of the current block to determine a position of a first color component region at a same position of the current block, and scaling the first BV parameter to determine a third BV parameter of the first color component region at the same position as the current block;
determining a reference block of the first color component based on the position of the first color component region and the third BV parameter, and determining the first color-component reference sample corresponding to the current block based on the reference block of the first color component; and
determining a reference block of the second color component based on the position of the current block and the first BV parameter, and determining the second color-component reference sample corresponding to the current block based on the reference block of the second color component.

13. The method of claim 1, wherein the establishing a mapping relationship between a first color component and a second color component based on the first color-component reference sample and the second color-component reference sample comprises:
determining a first look-up table based on the first color-component reference sample and the second color-component reference sample, wherein the first look-up table is used for recording a value of the second color component when an index key is the first color component.

14. The method of claim 1, wherein the establishing a mapping relationship between a first color component and a second color component based on the first color-component reference sample and the second color-component reference sample comprises:
determining a first discrete model based on the first color-component reference sample and the second color-component reference sample, wherein the first discrete model is used to indicate the mapping relationship between the first color component and the second color component.

15. The method of claim 1, further comprising:
determining a reconstructed pixel sample of a first color component region at a same position as the current block; and
determining the sample value of the first color component of the current block based on the reconstructed pixel sample of the first color component region.

16. The method of claim 1, wherein the determining a predicted value of the second color component of the current block based on the mapping relationship and a sample value of the first color component of the current block comprises:
in response to finding a value of the first color component equal to the sample value of the first color component in the mapping relationship, determining a value of the second color component corresponding to the value of the first color component as the predicted value of the second color component of the current block.

17. The method of claim 1, wherein the determining a predicted value of the second color component of the current block based on the mapping relationship and a sample value of the first color component of the current block comprises:
determining a first initial predicted value of the second color component of the current block based on the mapping relationship and the sample value of the first color component of the current block; and
performing a correction operation on the first initial predicted value to determine the predicted value of the second color component of the current block.

18. The method of claim 1, further comprising:
determining a plurality of third initial predicted values of the second color component of the current block when the number of the first BV parameters is more than one; and
performing a weighting calculation on the plurality of third initial predicted values to determine the predicted value of the second color component of the current block.

19. The method of claim 4, further comprising:
when the first color component block of the current block comprises a plurality of candidate blocks, determining a second BV parameter for each of the plurality of candidate blocks;
constructing a plurality of BV parameter candidate lists of the second color component of the current block based on the second BV parameters of the plurality of candidate blocks, and determining a plurality of first BV parameters of the second color component of the current block based on the plurality of BV parameter candidate lists; and
establishing the mapping relationship between the first color component and the second color component based on the plurality of first BV parameters, and determining the predicted value of the second color component of the current block based on the mapping relationship and the sample value of the first color component of the current block.

20. A coding method, applied to a coder, comprising:
determining a first block vector (BV) parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
determining a predicted value of the second color component of the current block based on the mapping relationship and a sample value of the first color component of the current block.

21. A non-transitory computer-readable storage medium, having a computer program and a bitstream stored, wherein the computer program, when executed by a processor, enables the processor to perform a coding method to generate the bitstream, wherein the coding method comprises:
determining a first block vector (BV) parameter of a current block;
determining a first color-component reference sample and a second color-component reference sample corresponding to the current block based on the first BV parameter, and establishing a mapping relationship between a first color component and a second color component based on the first color-component reference sample and the second color-component reference sample; and
determining a predicted value of the second color component of the current block based on the mapping relationship and a sample value of the first color component of the current block.
